(19) United States
(12) Patent Application Publication
(10) Pub. No.: US 2024/0362735 A1
(43) Pub. Date: Oct. 31, 2024

(54) APPARATUS AND A METHOD FOR AUTOMATICALLY GENERATING A PROFILE EVALUATION

(71) Applicant: Peppercorn AI Technology Limited, Cardiff (GB)

(72) Inventors: Nigel Lombard, Bridgend (GB); Paul Cassidy, Crewe (GB); Atul Thakor, Bury (GB); Robert Rushton, Swansea (GB); Ian Law, Newport (GB); Christopher Hill, Ordnance Wharf (GI); Jonathan Byford, Cardiff (GB); Jonathan Wilshire, Surrey (GB); Andrew Snuggs, London (GB)

(73) Assignee: Peppercorn AI Technology Limited, Cardiff (GB)

(21) Appl. No.: 18/141,171

(22) Filed: Apr. 28, 2023

(51) Int. Cl. G06Q 50/26

(52) U.S. Cl. CPC G06Q 50/265

(57) ABSTRACT

An apparatus for automatically generating a profile evaluation is disclosed. The apparatus comprises at least a processor and a memory communicatively connected to the at least a processor. The memory instructs the processor to extract a user profile from a user. The memory then instructs the processor to generate a verified user profile as a function of the user profile. The memory instructs the processor to identify at least one evaluation factor associated with the verified user profile. The memory additionally instructs the processor to generate a profile evaluation as a function of the at least one evaluation factor. The memory instructs the processor to display the profile evaluation using a display device.

### FIELD OF THE INVENTION

The present invention generally relates to the field of machine learning. In particular, the present invention is directed to an apparatus and method for automatically generating a profile evaluation.

### BACKGROUND

Customers expect increasingly seamless and convenient service from companies they interact with, but frequently dislike needing to wait for customer support or learn how to use a form or website just to fill out information. In particular, customers and users have an ever-increasing number of communications channels through which they communicate with friends, family, businesses, and organizations, but frequently do not have the option of getting assistance for certain matters through the communications channels they use most often.

### SUMMARY OF THE DISCLOSURE

In an aspect, an apparatus for automatically generating a profile evaluation is disclosed. The apparatus comprises at least a processor and a memory communicatively connected to the at least a processor. The memory instructs the processor to extract a user profile from a user. The memory then instructs the processor to generate a verified user profile as a function of the user profile. The memory instructs the processor to identify at least one evaluation factor associated with the verified user profile using a factor machine learning model. The memory additionally instructs the processor to generate a profile evaluation as a function of the at least one evaluation factor. The memory instructs the processor to display the profile evaluation using a display device.

In another aspect, a method for automatically generating a profile evaluation is disclosed. The method includes extracting, using at least a processor, a user profile from a user. The method includes generating, using the at least a processor, a verified user profile using a verification process. The method includes identifying, using the at least a processor, at least one evaluation factor associated with the verified user profile using a factor machine learning model. The method includes determining, using the at least a processor, a profile evaluation as a function of the at least one evaluation factors. The method includes displaying, using the at least a processor, the profile evaluation using a display device.

These and other aspects and features of non-limiting embodiments of the present invention will become apparent to those skilled in the art upon review of the following description of specific non-limiting embodiments of the invention in conjunction with the accompanying drawings.

### BRIEF DESCRIPTION OF THE DRAWINGS

For the purpose of illustrating the invention, the drawings show aspects of one or more embodiments of the invention. However, it should be understood that the present invention is not limited to the precise arrangements and instrumentalities shown in the drawings, wherein:

FIG. 1 is a block diagram of an exemplary embodiment of an apparatus for automatically generating a profile evaluation;

FIG. 2 is a block diagram of an exemplary machine-learning process;

FIG. 3 is a block diagram of an exemplary embodiment of a user profile database;

FIG. 4 is a diagram of an exemplary embodiment of a neural network;

FIG. 5 is a diagram of an exemplary embodiment of a node of a neural network;

FIG. 6 an illustration exemplary embodiment of fuzzy set comparison;

FIG. 7 is an illustration of an exemplary embodiment of a chatbot;

FIG. 8 is an illustration of an exemplary cryptographic accumulator;

FIG. 9 is an illustration of an exemplary embodiment of an immutable sequential listing;

FIG. 10 is a flow diagram of an exemplary method for automatically generating a profile evaluation; and

FIG. 11 is a block diagram of a computing system that can be used to implement any one or more of the methodologies disclosed herein and any one or more portions thereof.

The drawings are not necessarily to scale and may be illustrated by phantom lines, diagrammatic representations, and fragmentary views. In certain instances, details that are not necessary for an understanding of the embodiments or that render other details difficult to perceive may have been omitted.

### DETAILED DESCRIPTION

At a high level, aspects of the present disclosure are directed to an apparatus, and methods for automatically generating a profile evaluation is disclosed. The apparatus comprises at least a processor and a memory communicatively connected to the at least a processor. The memory instructs the processor to extract a user profile from a user. The memory then instructs the processor to generate a verified user profile as a function of the user profile. The memory instructs the processor to identify at least one evaluation factor associated with the verified user profile. The memory additionally instructs the processor to generate a profile evaluation as a function of the at least one evaluation factor. The memory instructs the processor to display the profile evaluation using a display device. Exemplary embodiments illustrating aspects of the present disclosure are described below in the context of several specific examples.

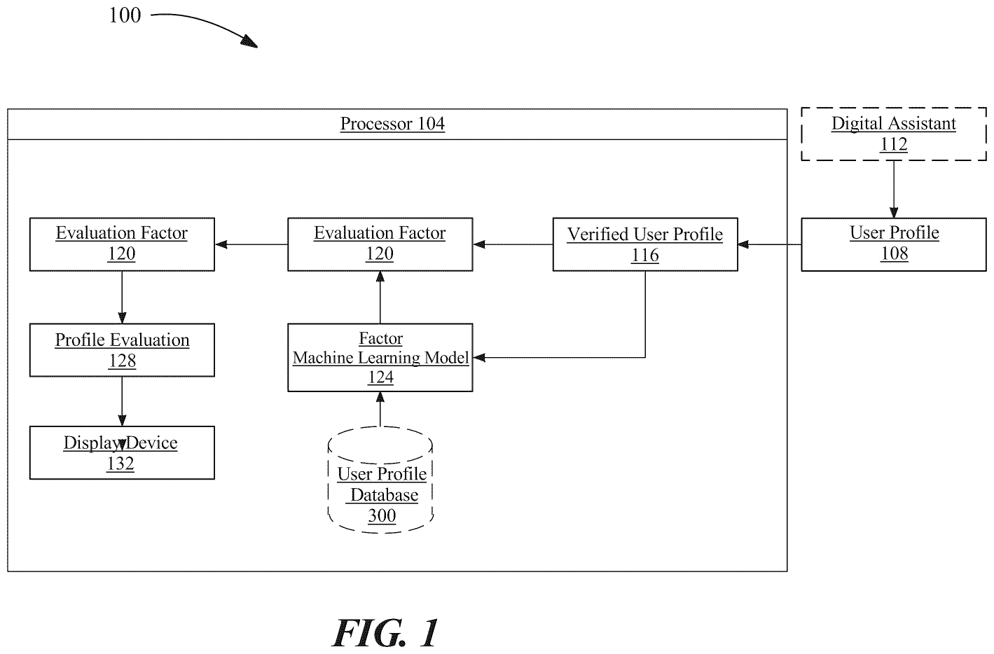

Referring now to FIG. 1, an exemplary embodiment of an apparatus for automatically generating a profile evaluation is illustrated. Apparatus 100 includes a processor 104. Processor 104 may include any computing device as described in this disclosure, including without limitation a microcontroller, microprocessor, digital signal processor (DSP), and/or system on a chip (SoC) as described in this disclosure. Computing device may include, be included in, and/or communicate with a mobile device such as a mobile telephone or smartphone. Processor 104 may include a single computing device operating independently, or may include two or more computing devices operating in concert, in parallel, sequentially or the like; two or more computing devices may be included together in a single computing device or in two or more computing devices. Processor 104 may interface or communicate with one or more additional devices as described below in further detail via a network interface device. Network interface device may be utilized for connecting processor 104 to one or more of a variety of networks, and one or more devices. Examples of a network interface device include, but are not limited to, a network interface card (e.g., a mobile network interface card, a LAN card), a modem, and any combination thereof. Examples of a network include, but are not limited to, a wide area network (e.g., the Internet, an enterprise network), a local area network (e.g., a network associated with an office, a building, a campus or other relatively small geographic space), a telephone network, a data network associated with a telephone/voice provider (e.g., a mobile communications provider data and/or voice network), a direct connection between two computing devices, and any combinations thereof. A network may employ a wired and/or a wireless mode of communication. In general, any network topology may be used. Information (e.g., data, software etc.) may be communicated to and/or from a computer and/or a computing device. Processor 104 may include but is not limited to, for example, a computing device or cluster of computing devices in a first location and a second computing device or cluster of computing devices in a second location. Processor 104 may include one or more computing devices dedicated to data storage, security, distribution of traffic for load balancing, and the like. Processor 104 may distribute one or more computing tasks as described below across a plurality of computing devices of computing device, which may operate in parallel, in series, redundantly, or in any other manner used for distribution of tasks or memory between computing devices. Processor 104 may be implemented using a “shared nothing” architecture in which data is cached at the worker, in an embodiment, this may enable scalability of apparatus 100 and/or computing device.

With continued reference to FIG. 1, processor 104 may be designed and/or configured to perform any method, method step, or sequence of method steps in any embodiment described in this disclosure, in any order and with any degree of repetition. For instance, processor 104 may be configured to perform a single step or sequence repeatedly until a desired or commanded outcome is achieved; repetition of a step or a sequence of steps may be performed iteratively and/or recursively using outputs of previous repetitions as inputs to subsequent repetitions, aggregating inputs and/or outputs of repetitions to produce an aggregate result, reduction or decrement of one or more variables such as global variables, and/or division of a larger processing task into a set of iteratively addressed smaller processing tasks. Processor 104 may perform any step or sequence of steps as described in this disclosure in parallel, such as simultaneously and/or substantially simultaneously performing a step two or more times using two or more parallel threads, processor cores, or the like; division of tasks between parallel threads and/or processes may be performed according to any protocol suitable for division of tasks between iterations. Persons skilled in the art, upon reviewing the entirety of this disclosure, will be aware of various ways in which steps, sequences of steps, processing tasks, and/or data may be subdivided, shared, or otherwise dealt with using iteration, recursion, and/or parallel processing.

With continued reference to FIG. 1, as used in this disclosure, “communicatively connected” means connected by way of a connection, attachment, or linkage between two or more relata which allows for reception and/or transmittance of information therebetween. For example, and without limitation, this connection may be wired or wireless, direct, or indirect, and between two or more components, circuits, devices, systems, apparatus, and the like, which allows for reception and/or transmittance of data and/or signal(s) therebetween. Data and/or signals therebetween may include, without limitation, electrical, electromagnetic, magnetic, video, audio, radio, and microwave data and/or signals, combinations thereof, and the like, among others. A communicative connection may be achieved, for example, and without limitation, through wired or wireless electronic, digital, or analog, communication, either directly or by way of one or more intervening devices or components. Further, communicative connection may include electrically coupling or connecting at least an output of one device, component, or circuit to at least an input of another device, component, or circuit. For example, without limitation, via a bus or other facility for intercommunication between elements of a computing device. Communicative connecting may also include indirect connections via, for example, and without limitation, wireless connection, radio communication, low power wide area network, optical communication, magnetic, capacitive, or optical coupling, and the like. In some instances, the terminology “communicatively coupled” may be used in place of communicatively connected in this disclosure.

With continued reference to FIG. 1, apparatus 100 and/or computing device may perform determinations, classification, and/or analysis steps, methods, processes, or the like as described in this disclosure using machine learning processes. A “machine learning process,” as used in this disclosure, is a process that automatedly uses a body of data known as “training data” and/or a “training set” (described further below) to generate an algorithm that will be performed by a computing device/module to produce outputs given data provided as inputs; this is in contrast to a non-machine learning software program where the commands to be executed are determined in advance by a user and written in a programming language. Machine-learning process may utilize supervised, unsupervised, lazy-learning processes and/or neural networks, described further below.

With continued reference to FIG. 1, processor 104 may be configured to extract a user profile 108 from a user. For the purposes of this disclosure, a “user profile” is a representation of information and/or data describing information associated with a user. User profiles may be associated with an individual or may be created by a processor 104, a user, or a third party. A user profile may be part of a single user view for the user. A “single user view” as used herein is defined as a collection of information about a user gathered from different sources. For example, a single user view may include banking information about a user from a bank (for example recent purchases, number of accounts, net worth, overdraft fees, loans including vehicle loans, etc.), social media information about a user from a public social media profile, (e.g. social media posts, pictures (such as a picture of a fender bender the user was in recently), videos (such as a video of a user speeding or driving carelessly), comments, and the like), credit score and related credit information from a credit bureau, legal information from public or background check records (e.g. an arrest record, outstanding warrants, convictions for particular crimes such as fraud, and the like) and agglomerate the user information into a single source. Such a centralized collection of information can help make a more accurate or faster determination about whether or not a user is trustworthy, what an appropriate insurance policy or insurance rate might be for a user, how to reduce risk related to a user, and the like. A single user view may include information about a user gathered from the same source over time, for example a checking account balance determined at the start of every month and received from the same bank. User profile 108 may include at least any of the following personal information: age, height, gender, credit, geographical location, marital status, how often the user drives, criminal history, medical history, driving history, accident history, vehicle profile, and the like. As used in the current disclosure, a “driving history” is the driving record of the user. Driving history may include any driving records including criminal and civil driving offenses for which the user was either found guilty or responsible, plus discretionary driver's license suspensions, and administrative driver's license suspensions. This may include traffic tickets, reckless driving tickets, speeding tickets, driving under the influence charges, wrecks involving the user, active lawsuits against car insurance companies, and the like. A user profile 108 may additionally include the coverage history of the user. As used in the current disclosure, a “coverage history” is information regarding the previous insurers of the user. Coverage history may include the insurer's name, policy number, policy type, coverage amount, and the like. A user profile 108 may be received by process 104 via user input. For example, and without limitation, the user or a third party may manually input user profile 108 using a graphical user interface of processor 104 or a remote device, such as for example, a smartphone or laptop. User profile 108 may additionally be generated via the answer to a series of questions. The series of questions may be implemented using a chatbot, as described herein below. A chatbot may be configured to generate questions regarding any element of the user profile 108. In a non-limiting embodiment, a user may be prompted to input specific information or may fill out a questionnaire. In an embodiment, a graphical user interface may display a series of questions to prompt a user for information pertaining to user profile 108. In another example, and without limitation, a digital assistant may extract the user profile 108 from the users. User profile 108 may be transmitted to processor 104, such as via a wired or wireless communication, as previously discussed in this disclosure. User profile 108 can be retrieved from multiple sources including driving records, criminal records, insurance databases, driver's license databases, news articles, social media profiles and/or posts, and the like. A user profile may be placed through an encryption process for security purposes. This may additionally include storing a user profile 108 on an immutable sequential listing or blockchain as described herein below. In some embodiments, a user profile 108 or any other data mentioned throughout the entirety of this disclosure may be collected using a cryptographic accumulator.

Still referring to FIG. 1, a user profile 108 may include a vehicle profile. As used in the current disclosure, a “vehicle profile” is a representation of information and/or data describing information associated with a user's vehicle. A vehicle profile may include the make, model, VIN number, registration information, car color, mileage, car condition, and the like. A vehicle profile may include driving information associated with the user. In some embodiments, a diving sensor may be inserted within the vehicle. A driving sensor may be configured to detect the average speed of the driver, the number of miles driven, the frequency with which the user drives, and the like. This information may be taken over a given period of time. This information may also be tracked continuously by the driving sensor. This information may be used to update a vehicle profile.

With continued reference to FIG. 1, in an embodiment, apparatus 100 and methods described herein may perform or implement one or more aspects of a cryptographic system. In one embodiment, a cryptographic system is a system that converts data from a first form, known as “plaintext,” which is intelligible when viewed in its intended format, into a second form, known as “ciphertext,” which is not intelligible when viewed in the same way. Ciphertext may be unintelligible in any format unless first converted back to plaintext. In one embodiment, a process of converting plaintext into ciphertext is known as “encryption.” Encryption process may involve the use of a datum, known as an “encryption key,” to alter plaintext. Cryptographic system may also convert ciphertext back into plaintext, which is a process known as “decryption.” Decryption process may involve the use of a datum, known as a “decryption key,” to return the ciphertext to its original plaintext form. In embodiments of cryptographic systems that are “symmetric,” decryption key is essentially the same as encryption key: possession of either key makes it possible to deduce the other key quickly without further secret knowledge. Encryption and decryption keys in symmetric cryptographic systems may be kept secret and shared only with persons or entities that the user of the cryptographic system wishes to be able to decrypt the ciphertext. One example of a symmetric cryptographic system is the Advanced Encryption Standard (“AES”), which arranges plaintext into matrices and then modifies the matrices through repeated permutations and arithmetic operations with an encryption key.

Still referring to FIG. 1, in embodiments of cryptographic systems that are “asymmetric,” either encryption or decryption key cannot be readily deduced without additional secret knowledge, even given the possession of a corresponding decryption or encryption key, respectively; a common example is a “public key cryptographic system,” in which possession of the encryption key does not make it practically feasible to deduce the decryption key, so that the encryption key may safely be made available to the public. An example of a public key cryptographic system is RSA, in which an encryption key involves the use of numbers that are products of very large prime numbers, but a decryption key involves the use of those very large prime numbers, such that deducing the decryption key from the encryption key requires the practically infeasible task of computing the prime factors of a number which is the product of two very large prime numbers. Another example is elliptic curve cryptography, which relies on the fact that given two points P and Q on an elliptic curve over a finite field, and a definition for addition where A+B=−R, the point where a line connecting point A and point B intersects the elliptic curve, where “0,” the identity, is a point at infinity in a projective plane containing the elliptic curve, finding a number k such that adding P to itself k times results in Q is computationally impractical, given correctly selected elliptic curve, finite field, and P and Q.

With continued reference to FIG. 1, in some embodiments, apparatus 100 and methods described herein produce cryptographic hashes, also referred to by the equivalent shorthand term “hashes.” A cryptographic hash, as used herein, is a mathematical representation of a lot of data, such as files or blocks in a block chain as described in further detail below; the mathematical representation is produced by a lossy “one-way” algorithm known as a “hashing algorithm.” Hashing algorithm may be a repeatable process; that is, identical lots of data may produce identical hashes each time they are subjected to a particular hashing algorithm. Because hashing algorithm is a one-way function, it may be impossible to reconstruct a lot of data from a hash produced from the lot of data using the hashing algorithm. In the case of some hashing algorithms, reconstructing the full lot of data from the corresponding hash using a partial set of data from the full lot of data may be possible only by repeatedly guessing at the remaining data and repeating the hashing algorithm; it is thus computationally difficult if not infeasible for a single computer to produce the lot of data, as the statistical likelihood of correctly guessing the missing data may be extremely low. However, the statistical likelihood of a computer of a set of computers simultaneously attempting to guess the missing data within a useful timeframe may be higher, permitting mining protocols as described in further detail below.

Still referring to FIG. 1, in an embodiment, hashing algorithm may demonstrate an “avalanche effect,” whereby even extremely small changes to lot of data produce drastically different hashes. This may thwart attempts to avoid the computational work necessary to recreate a hash by simply inserting a fraudulent datum in data lot, enabling the use of hashing algorithms for “tamper-proofing” data such as data contained in an immutable ledger as described in further detail below. This avalanche or “cascade” effect may be evinced by various hashing processes; persons skilled in the art, upon reading the entirety of this disclosure, will be aware of various suitable hashing algorithms for purposes described herein. Verification of a hash corresponding to a lot of data may be performed by running the lot of data through a hashing algorithm used to produce the hash. Such verification may be computationally expensive, albeit feasible, potentially adding up to significant processing delays where repeated hashing, or hashing of large quantities of data, is required, for instance as described in further detail below. Examples of hashing programs include, without limitation, SHA256, a NIST standard; further current and past hashing algorithms include Winternitz hashing algorithms, various generations of Secure Hash Algorithm (including “SHA-1,” “SHA-2,” and “SHA-3”), “Message Digest” family hashes such as “MD4,” “MD5,” “MD6,” and “RIPEMD,” Keccak, “BLAKE” hashes and progeny (e.g., “BLAKE2,” “BLAKE-256,” “BLAKE-512,” and the like), Message Authentication Code (“MAC”)-family hash functions such as PMAC, OMAC, VMAC, HMAC, and UMAC, Poly 1305-AES, Elliptic Curve Only Hash (“ECOH”) and similar hash functions, Fast-Syndrome-based (FSB) hash functions, GOST hash functions, the Grøstl hash function, the HAS-160 hash function, the JH hash function, the RadioGatun hash function, the Skein hash function, the Streebog hash function, the SWIFFT hash function, the Tiger hash function, the Whirlpool hash function, or any hash function that satisfies, at the time of implementation, the requirements that a cryptographic hash be deterministic, infeasible to reverse-hash, infeasible to find collisions, and have the property that small changes to an original message to be hashed will change the resulting hash so extensively that the original hash and the new hash appear uncorrelated to each other. A degree of security of a hash function in practice may depend both on the hash function itself and on characteristics of the message and/or digest used in the hash function. For example, where a message is random, for a hash function that fulfills collision-resistance requirements, a brute-force or “birthday attack” may to detect collision may be on the order of O(2^{n/2}) for n output bits; thus, it may take on the order of 2²⁵⁶ operations to locate a collision in a 512 bit output “Dictionary” attacks on hashes likely to have been generated from a non-random original text can have a lower computational complexity, because the space of entries they are guessing is far smaller than the space containing all random permutations of bits. However, the space of possible messages may be augmented by increasing the length or potential length of a possible message, or by implementing a protocol whereby one or more randomly selected strings or sets of data are added to the message, rendering a dictionary attack significantly less effective.

With continued reference to FIG. 1, embodiments described in this disclosure may perform secure proofs. A “secure proof,” as used in this disclosure, is a protocol whereby an output is generated that demonstrates possession of a secret, such as device-specific secret, without demonstrating the entirety of the device-specific secret; in other words, a secure proof by itself, is insufficient to reconstruct the entire device-specific secret, enabling the production of at least another secure proof using at least a device-specific secret. A secure proof may be referred to as a “proof of possession” or “proof of knowledge” of a secret. Where at least a device-specific secret is a plurality of secrets, such as a plurality of challenge-response pairs, a secure proof may include an output that reveals the entirety of one of the plurality of secrets, but not all of the plurality of secrets; for instance, secure proof may be a response contained in one challenge-response pair. In an embodiment, proof may not be secure; in other words, proof may include a one-time revelation of at least a device-specific secret, for instance as used in a single challenge-response exchange.

Still referring to FIG. 1, secure proof may include a zero-knowledge proof, which may provide an output demonstrating possession of a secret while revealing none of the secret to a recipient of the output; zero-knowledge proof may be information-theoretically secure, meaning that an entity with infinite computing power would be unable to determine secret from output. Alternatively, zero-knowledge proof may be computationally secure, meaning that determination of secret from output is computationally infeasible, for instance to the same extent that determination of a private key from a public key in a public key cryptographic system is computationally infeasible. Zero-knowledge proof algorithms may generally include a set of two algorithms, a prover algorithm, or “P,” which is used to prove computational integrity and/or possession of a secret, and a verifier algorithm, or “V” whereby a party may check the validity of P. Zero-knowledge proof may include an interactive zero-knowledge proof, wherein a party verifying the proof must directly interact with the proving party; for instance, the verifying and proving parties may be required to be online, or connected to the same network as each other, at the same time. Interactive zero-knowledge proof may include a “proof of knowledge” proof, such as a Schnorr algorithm for proof on knowledge of a discrete logarithm. in a Schnorr algorithm, a prover commits to a randomness r, generates a message based on r, and generates a message adding r to a challenge c multiplied by a discrete logarithm that the prover is able to calculate; verification is performed by the verifier who produced c by exponentiation, thus checking the validity of the discrete logarithm. Interactive zero-knowledge proofs may alternatively or additionally include sigma protocols. Persons skilled in the art, upon reviewing the entirety of this disclosure, will be aware of various alternative interactive zero-knowledge proofs that may be implemented consistently with this disclosure.

Alternatively, and continuing to refer to FIG. 1, zero-knowledge proof may include a non-interactive zero-knowledge, proof, or a proof wherein neither party to the proof interacts with the other party to the proof; for instance, each of a party receiving the proof and a party providing the proof may receive a reference datum which the party providing the proof may modify or otherwise use to perform the proof. As a non-limiting example, zero-knowledge proof may include a succinct non-interactive arguments of knowledge (ZK-SNARKS) proof, wherein a “trusted setup” process creates proof and verification keys using secret (and subsequently discarded) information encoded using a public key cryptographic system, a prover runs a proving algorithm using the proving key and secret information available to the prover, and a verifier checks the proof using the verification key; public key cryptographic system may include RSA, elliptic curve cryptography, ElGamal, or any other suitable public key cryptographic system. Generation of trusted setup may be performed using a secure multiparty computation so that no one party has control of the totality of the secret information used in the trusted setup; as a result, if any one party generating the trusted setup is trustworthy, the secret information may be unrecoverable by malicious parties. As another non-limiting example, non-interactive zero-knowledge proof may include a Succinct Transparent Arguments of Knowledge (ZK-STARKS) zero-knowledge proof. In an embodiment, a ZK-STARKS proof includes a Merkle root of a Merkle tree representing evaluation of a secret computation at some number of points, which may be 1 billion points, plus Merkle branches representing evaluations at a set of randomly selected points of the number of points; verification may include determining that Merkle branches provided match the Merkle root, and that point verifications at those branches represent valid values, where validity is shown by demonstrating that all values belong to the same polynomial created by transforming the secret computation. In an embodiment, ZK-STARKS does not require a trusted setup.

Further referring to FIG. 1, zero-knowledge proof may include any other suitable zero-knowledge proof. Zero-knowledge proof may include, without limitation, bulletproofs. Zero-knowledge proof may include a homomorphic public-key cryptography (hPKC)-based proof. Zero-knowledge proof may include a discrete logarithmic problem (DLP) proof. Zero-knowledge proof may include a secure multi-party computation (MPC) proof. Zero-knowledge proof may include, without limitation, an incrementally verifiable computation (IVC). Zero-knowledge proof may include an interactive oracle proof (IOP). Zero-knowledge proof may include a proof based on the probabilistically checkable proof (PCP) theorem, including a linear PCP (LPCP) proof. Persons skilled in the art, upon reviewing the entirety of this disclosure, will be aware of various forms of zero-knowledge proofs that may be used, singly or in combination, consistently with this disclosure.

With continued reference to FIG. 1, in an embodiment, secure proof is implemented using a challenge-response protocol. In an embodiment, this may function as a one-time pad implementation; for instance, a manufacturer or other trusted party may record a series of outputs (“responses”) produced by a device possessing secret information, given a series of corresponding inputs (“challenges”), and store them securely. In an embodiment, a challenge-response protocol may be combined with key generation. A single key may be used in one or more digital signatures as described in further detail below, such as signatures used to receive and/or transfer possession of crypto-currency assets; the key may be discarded for future use after a set period of time. In an embodiment, varied inputs include variations in local blockchains, such as fluctuations in local electromagnetic fields, radiation, temperature, and the like, such that an almost limitless variety of private keys may be so generated. Secure proof may include encryption of a challenge to produce the response, indicating possession of a secret key. Encryption may be performed using a private key of a public key cryptographic system or using a private key of a symmetric cryptographic system; for instance, trusted party may verify response by decrypting an encryption of challenge or of another datum using either a symmetric or public-key cryptographic system, verifying that a stored key matches the key used for encryption as a function of at least a device-specific secret. Keys may be generated by random variation in selection of prime numbers, for instance for the purposes of a cryptographic system such as RSA that relies prime factoring difficulty. Keys may be generated by randomized selection of parameters for a seed in a cryptographic system, such as elliptic curve cryptography, which is generated from a seed. Keys may be used to generate exponents for a cryptographic system such as Diffie-Helman or ElGamal that are based on the discrete logarithm problem.

With continued reference to FIG. 1, embodiments described in this disclosure may utilize, evaluate, and/or generate digital signatures. A “digital signature,” as used herein, includes a secure proof of possession of a secret by a signing device, as performed on provided element of data, known as a “message.” A message may include an encrypted mathematical representation of a file or other set of data using the private key of a public key cryptographic system. Secure proof may include any form of secure proof as described above, including without limitation encryption using a private key of a public key cryptographic system as described above. Signature may be verified using a verification datum suitable for verification of a secure proof; for instance, where secure proof is enacted by encrypting message using a private key of a public key cryptographic system, verification may include decrypting the encrypted message using the corresponding public key and comparing the decrypted representation to a purported match that was not encrypted; if the signature protocol is well-designed and implemented correctly, this means the ability to create the digital signature is equivalent to possession of the private decryption key and/or device-specific secret. Likewise, if a message making up a mathematical representation of file is well-designed and implemented correctly, any alteration of the file may result in a mismatch with the digital signature; the mathematical representation may be produced using an alteration-sensitive, reliably reproducible algorithm, such as a hashing algorithm as described above. A mathematical representation to which the signature may be compared may be included with signature, for verification purposes; in other embodiments, the algorithm used to produce the mathematical representation may be publicly available, permitting the easy reproduction of the mathematical representation corresponding to any file.

With continued reference to FIG. 1, in some embodiments, digital signatures may be combined with or incorporated in digital certificates. In one embodiment, a digital certificate is a file that conveys information and links the conveyed information to a “certificate authority” that is the issuer of a public key in a public key cryptographic system. Certificate authority in some embodiments contains data conveying the certificate authority's authorization for the recipient to perform a task. The authorization may be the authorization to access a given datum. The authorization may be the authorization to access a given process. In some embodiments, the certificate may identify the certificate authority. The digital certificate may include a digital signature.

With continued reference to FIG. 1, in some embodiments, a third party such as a certificate authority (CA) is available to verify that the possessor of the private key is a particular entity; thus, if the certificate authority may be trusted, and the private key has not been stolen, the ability of an entity to produce a digital signature confirms the identity of the entity and links the file to the entity in a verifiable way. Digital signature may be incorporated in a digital certificate, which is a document authenticating the entity possessing the private key by authority of the issuing certificate authority and signed with a digital signature created with that private key and a mathematical representation of the remainder of the certificate. In other embodiments, digital signature is verified by comparing the digital signature to one known to have been created by the entity that purportedly signed the digital signature; for instance, if the public key that decrypts the known signature also decrypts the digital signature, the digital signature may be considered verified. Digital signature may also be used to verify that the file has not been altered since the formation of the digital signature.

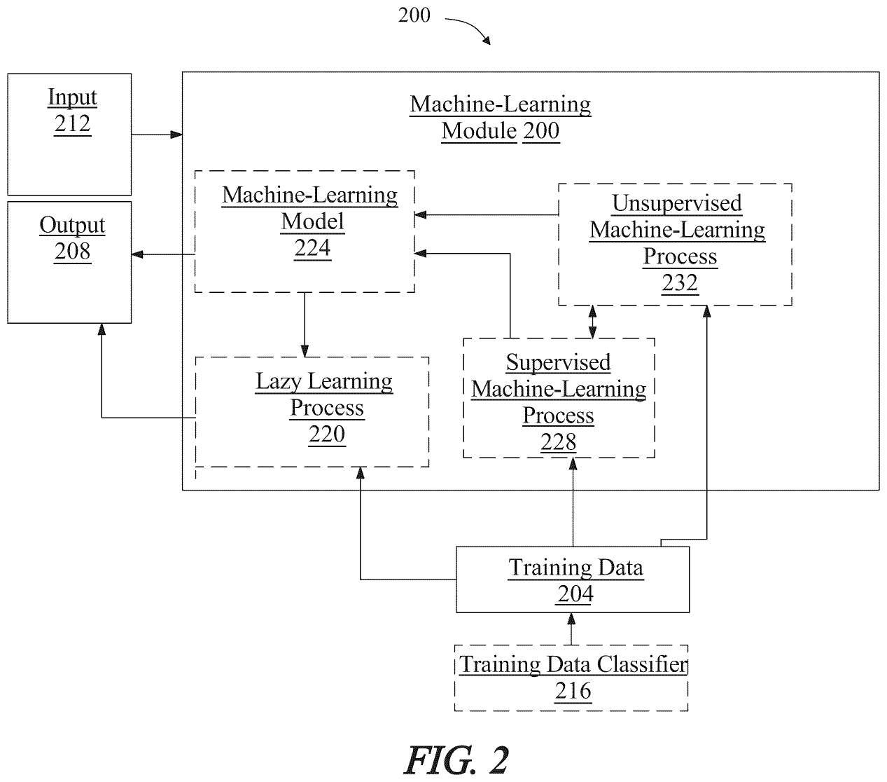

Still referring to FIG. 1, in some embodiments, user profile 108 may be extracted using a digital assistant 112. As used herein, a “digital assistant” is a computer program configured to simulate a conversation with a user. A digital assistant 112 may utilize machine learning, as described further herein. A digital assistant 112 or machine learning model may include a language processing module. As used herein, a “language model” is a program capable of interpreting natural language, generating natural language, or both. A system for collecting user data 116, such as a digital assistant, may include a system capable of generating audio speech, such as via a text-to-speech function. A system for collecting user profile 108, such as a digital assistant, may include a system capable of recognizing or interpreting audio speech. A language model may include a neural network. A language model may be trained using a dataset that includes natural language. A language model may be trained using a dataset that includes historical user data. A language model may include a dynamic response machine learning model. A language model may include a language processing model. In a non-limiting example, the digital assistant may be the same or substantially the same as the digital assistant described in U.S. patent application Ser. No. 18/141,101, filed on Apr. 28, 2023, titled “METHODS AND APPARATUSES FOR AI DIGITAL ASSISTANTS,” which is incorporated by reference herein in its entirety. The digital assistant 112 may be represented visually or in text. In some embodiments, a digital assistant 112 may comprise a chatbot. The digital assistant 112 may include one or more animation files and/or video clips. Digital assistant 112 may include one or more files and/or video clips. The digital assistant 112 may be configured to respond to an inquiry from a user. The digital assistant 112 may be any form of video or visuals that portray the user profile 108. The digital assistant 112 may comprise a “plurality of video elements”, which are, as used in this disclosure, diverse types of features from a digital assistant 112 such as image features, frame features, sound features, graphical features, and the like. Processor 104 may generate a digital assistant 112 using a machine-learning training algorithm and user profile training data, for instance by training a machine-learning model using verification training data and a machine-learning algorithm as described in further detail below. Machine learning algorithms may include unsupervised machine learning algorithms such as clustering models, k-means clustering, hierarchical clustering, anomaly detection, local outlier factor, neural networks and the like. Machine-learning may include supervised machine learning algorithms using user profile training data. Machine-learning algorithms may train one or more neural networks such as convolutional and/or deep learning networks and are discussed more herein with reference to FIG. 2. In some embodiments, a digital assistant 112 may include a digital avatar.

Still referring to FIG. 1, processor 104 may be configured to generate digital assistant 112. Apparatus 100 may generate digital assistant 112. through one or more modeling software's, such as, but not limited to, Sketchup, Blender, ZBrus h, AutoCAD, SolidWorks, 3Ds Max, Maya, Rhino3d, CATIA, and the like. In some embodiments, digital assistant 112. may include one or more formats, such as, but not limited to, “dwg,” “dxf,” “3ds”, “dae”, “dem”, “def”, “ifc”, “kmz”, “stl”, “3dxml”, “3dm”, “3ds”, “cd”, “vda”, “vrml”, and the like.

Still referring to FIG. 1, in some embodiments, a digital assistant 112 may be generated using an operational model. An “operational model” as used in this disclosure is a computer process that dictates animations and/or interactions of one or more virtual entities and a user. An operational model may be programmed to configure digital assistant 112 to perform one or more tasks, movements, conversations, and the like. In some embodiments, operational model may comprise behavioral parameters corresponding to animations of a digital assistant 112. “Behavioral parameters” as used in this disclosure are metrics associated with interactions of a virtual entity. Behavioral parameters may include, but are not limited to, facial animations, responsiveness, interaction with an environment, and the like. Facial animations may include, but are not limited to, grinding teeth, smirking, crying, laughing, clenching, grinding teeth, showing surprise, and the like. In some embodiments, behavioral parameters may be tuned as a function of an avatar body of digital assistant 112. In other embodiments, behavioral parameters may be consistent throughout multiple varying avatar models. In some embodiments, facial animations of behavioral parameters may be tuned to an avatar body.

Still referring to FIG. 1, the operational model may include one or more animations and/or triggers of animations of the digital assistant 112. Animations may include, but are not limited to, walking, running, jumping, hiding, celebrating, nodding, and the like. Triggers of animations may include but are not limited to, geographical positions, user input, engagement with virtual objects, and the like. For instance and without limitation, the digital assistant 112 may include an animation of the digital assistant 112 giving an animated tutorial on how to input user profile 108. Animations and triggers of animations of the operational model may be based on user inquiries, user profile 108, and/or other factors. In some embodiments, apparatus 100 may include a behavioral machine-learning model. In some embodiments, the operational model may include the behavioral machine learning model. A behavioral machine learning model may be trained with training data correlating user data to behavioral parameters. In some embodiments, the processor may be configured to train the behavioral machine learning model. Training data may be received through user input, external computing devices, and/or through previous iterations of processing. In some embodiments, training data may be received from database 300, such as a training data database. In some embodiments, the behavioral machine learning model may be configured to receive user data as input and output one or more behavioral parameters. The operational model may use the behavioral machine learning model to determine behavioral parameters of the digital assistant 112 based on the user profile 108.

In some embodiments, an animation may be generated using stored rules for the representation and/or modification of static images. Stored rules may include, without limitation, rules associating an event as detected by sensing devices with an image and/or sound representing a reaction thereto by an animated character. For instance, a given event and/or input may be associated with an endpoint image, such as a “congratulatory” event with an image of an avatar with a congratulating the user for a job well done. Similar associations may be made between expressions and/or poses indicating simulated reactions to pleasing events, exciting events, annoying events, and humorous events. Animated sequences may be stored transitioning from a first pose representing a first simulated emotional state and/or response and a second pose representing a second simulated emotional state and/or response. Alternatively or additionally, stored rules may indicate modifications to images and/or for creation of transitional images that can be used to generate an animated sequence of images from one simulated emotional state and/or response. Emotional states and/or responses may be regulated, without limitation, using a finite state machine directing transition from one emotional state and/or response to another.

Still referring to FIG. 1, stored rules, modified images, and/or modifications to images may be entered and/or defined manually; alternatively or additionally, modified images, and/or modifications to images may be generated using a machine-learning process that may be trained using manually generated images, modifications thereto, and/or sequences of such images and/or modifications, and/or manually identified examples of such training examples in existing animated and/or live-action stills and/or sequences. Machine-learning models may include models trained to recognize features in a picture of a character, models trained to modify identified features and/or entire images, models trained to identify and/or generate transitional images traversing from one static image to another static image in a sequence, or the like. Static images and/or modifications may be associated with responses to particular inputs by additional models.

Still referring to FIG. 1, digital assistant 112 may be able to speak using a language processing model. Language processing model may include a program automatically generated by computing device and/or language processing module to produce associations between one or more words extracted from at least a document and detect associations, including without limitation mathematical associations, between such words. Associations between language elements, where language elements include for purposes herein extracted words, relationships of such categories to other such term may include, without limitation, mathematical associations, including without limitation statistical correlations between any language element and any other language element and/or language elements. Statistical correlations and/or mathematical associations may include probabilistic formulas or relationships indicating, for instance, a likelihood that a given extracted word indicates a given category of semantic meaning. As a further example, statistical correlations and/or mathematical associations may include probabilistic formulas or relationships indicating a positive and/or negative association between at least an extracted word and/or a given semantic meaning; positive or negative indication may include an indication that a given document is or is not indicating a category semantic meaning. Whether a phrase, sentence, word, or other textual element in a document or corpus of documents constitutes a positive or negative indicator may be determined, in an embodiment, by mathematical associations between detected words, comparisons to phrases and/or words indicating positive and/or negative indicators that are stored in memory at computing device, or the like.

Still referring to FIG. 1, the language processing module and/or diagnostic engine may generate the language processing model by any suitable method, including without limitation a natural language processing classification algorithm; language processing model may include a natural language process classification model that enumerates and/or derives statistical relationships between input terms and output terms. Algorithm to generate language processing model may include a stochastic gradient descent algorithm, which may include a method that iteratively optimizes an objective function, such as an objective function representing a statistical estimation of relationships between terms, including relationships between input terms and output terms, in the form of a sum of relationships to be estimated. In an alternative or additional approach, sequential tokens may be modeled as chains, serving as the observations in a Hidden Markov Model (HMM). HMMs as used herein are statistical models with inference algorithms that that may be applied to the models. In such models, a hidden state to be estimated may include an association between extracted words, phrases, and/or other semantic units. There may be a finite number of categories to which an extracted word may pertain; an HMM inference algorithm, such as the forward-backward algorithm or the Viterbi algorithm, may be used to estimate the most likely discrete state given a word or sequence of words. Language processing module may combine two or more approaches. For instance, and without limitation, a machine-learning program may use a combination of Naive-Bayes (NB), Stochastic Gradient Descent (SGD), and parameter grid-searching classification techniques; the result may include a classification algorithm that returns ranked associations.

Continuing to refer to FIG. 1, generating language processing model may include generating a vector space, which may be a collection of vectors, defined as a set of mathematical objects that can be added together under an operation of addition following properties of associativity, commutativity, existence of an identity element, and existence of an inverse element for each vector, and can be multiplied by scalar values under an operation of scalar multiplication compatible with field multiplication, and that has an identity element is distributive with respect to vector addition, and is distributive with respect to field addition. Each vector in an n-dimensional vector space may be represented by an n-tuple of numerical values. Each unique extracted word and/or language element as described above may be represented by a vector of the vector space. In an embodiment, each unique extracted and/or other language element may be represented by a dimension of vector space; as a non-limiting example, each element of a vector may include a number representing an enumeration of co-occurrences of the word and/or language element represented by the vector with another word and/or language element. Vectors may be normalized, scaled according to relative frequencies of appearance and/or file sizes. In an embodiment associating language elements to one another as described above may include computing a degree of vector similarity between a vector representing each language element and a vector representing another language element; vector similarity may be measured according to any norm for proximity and/or similarity of two vectors, including without limitation cosine similarity, which measures the similarity of two vectors by evaluating the cosine of the angle between the vectors, which can be computed using a dot product of the two vectors divided by the lengths of the two vectors. Degree of similarity may include any other geometric measure of distance between vectors.

Still referring to FIG. 1, language processing module may use a corpus of documents to generate associations between language elements and diagnostic engine may then use such associations to analyze words extracted from one or more documents and determine that the one or more documents indicate significance of a category. In embodiments, corpus documents may include any element of data disclosed herein, including within the user profile 108. Corpus documents may additionally include questions and answers from a chatbot, user input. In an embodiment, language module and/or apparatus 100 may perform this analysis using a selected set of significant documents, such as documents identified by one or more experts as representing good information; experts may identify or enter such documents via graphical user interface, or may communicate identities of significant documents according to any other suitable method of electronic communication, or by providing such identity to other persons who may enter such identifications into apparatus 100. Documents may be entered into a computing device by being uploaded by an expert or other persons using, without limitation, file transfer protocol (FTP) or other suitable methods for transmission and/or upload of documents; alternatively or additionally, where a document is identified by a citation, a uniform resource identifier (URI), uniform resource locator (URL) or other datum permitting unambiguous identification of the document, diagnostic engine may automatically obtain the document using such an identifier, for instance by submitting a request to a database or compendium of documents such as JSTOR as provided by Ithaka Harbors, Inc. of New York.

Still referring to FIG. 1, in some embodiments, processor 104 may be configured to extract user profile 108 from a user using automatic speech recognition. Automatic speech recognition may require training (i.e., enrollment). In some cases, training an automatic speech recognition model may require an individual speaker to read text or isolated vocabulary. In some cases, a solicitation video may include an audio component having an audible verbal content, the contents of which are known a priority by processor 104. Processor 104 may then train an automatic speech recognition model according to training data which includes audible verbal content correlated to known content. In this way, processor 104 may analyze a person's specific voice and train an automatic speech recognition model to the person's speech, resulting in increased accuracy. Alternatively or additionally, in some cases, processor 104 may include an automatic speech recognition model that is speaker-independent. As used in this disclosure, a “speaker independent” automatic speech recognition process does not require training for each individual speaker. Conversely, as used in this disclosure, automatic speech recognition processes that employ individual speaker specific training are “speaker dependent.”

Still referring to FIG. 1, in some embodiments, an automatic speech recognition process may perform voice recognition or speaker identification. As used in this disclosure, “voice recognition” refers to identifying a speaker, from audio content, rather than what the speaker is saying. In some cases, processor 104 may first recognize a speaker of verbal audio content and then automatically recognize speech of the speaker, for example by way of a speaker dependent automatic speech recognition model or process. In some embodiments, an automatic speech recognition process can be used to authenticate or verify an identity of a speaker. In some cases, a speaker may or may not include subject. For example, subject may speak within solicitation video, but others may speak as well.

Still referring to FIG. 1, in some embodiments, an automatic speech recognition process may include one or all of acoustic modeling, language modeling, and statistically-based speech recognition algorithms. In some cases, an automatic speech recognition process may employ hidden Markov models (HMMs). As discussed in greater detail below, language modeling such as that employed in natural language processing applications like document classification or statistical machine translation, may also be employed by an automatic speech recognition process.

Still referring to FIG. 1, an exemplary algorithm employed in automatic speech recognition may include or even be based on hidden Markov models. Hidden Markov models (HMMs) may include statistical models that output a sequence of symbols or quantities. HMMs can be used in speech recognition because a speech signal can be viewed as a piecewise stationary signal or a short-time stationary signal. For example, over a short time scale (e.g., 10 milliseconds), speech can be approximated as a stationary process. Speech (i.e., audible verbal content) can be understood as a Markov model for many stochastic purposes.

Still referring to FIG. 1, in some embodiments HMMs can be trained automatically and may be relatively simple and computationally feasible to use. In an exemplary automatic speech recognition process, a hidden Markov model may output a sequence of n-dimensional real-valued vectors (with n being a small integer, such as 10), at a rate of about one vector every 10 milliseconds. Vectors may consist of cepstral coefficients. A cepstral coefficient requires using a spectral domain. Cepstral coefficients may be obtained by taking a Fourier transform of a short time window of speech yielding a spectrum, decorrelating the spectrum using a cosine transform, and taking first (i.e., most significant) coefficients. In some cases, an HMM may have in each state a statistical distribution that is a mixture of diagonal covariance Gaussians, yielding a likelihood for each observed vector. In some cases, each word, or phoneme, may have a different output distribution; an HMM for a sequence of words or phonemes may be made by concatenating an HMMs for separate words and phonemes.

Still referring to FIG. 1, in some embodiments, an automatic speech recognition process may use various combinations of a number of techniques in order to improve results. In some cases, a large-vocabulary automatic speech recognition process may include context dependency for phonemes. For example, in some cases, phonemes with different left and right context may have different realizations as HMM states. In some cases, an automatic speech recognition process may use cepstral normalization to normalize for different speakers and recording conditions. In some cases, an automatic speech recognition process may use vocal tract length normalization (VTLN) for male-female normalization and maximum likelihood linear regression (MLLR) for more general speaker adaptation. In some cases, an automatic speech recognition process may determine so-called delta and delta-delta coefficients to capture speech dynamics and might use heteroscedastic linear discriminant analysis (HLDA). In some cases, an automatic speech recognition process may use splicing and an linear discriminate analysis (LDA)-based projection, which may include heteroscedastic linear discriminant analysis or a global semi-tied covariance transform (also known as maximum likelihood linear transform [MLLT]). In some cases, an automatic speech recognition process may use discriminative training techniques, which may dispense with a purely statistical approach to HMM parameter estimation and instead optimize some classification-related measure of training data; examples may include maximum mutual information (MMI), minimum classification error (MCE), and minimum phone error (MPE).

Still referring to FIG. 1, in some embodiments, an automatic speech recognition process may be said to decode speech (i.e., audible verbal content). Decoding of speech may occur when an automatic speech recognition system is presented with a new utterance and must compute a most likely sentence. In some cases, speech decoding may include a Viterbi algorithm. A Viterbi algorithm may include a dynamic programming algorithm for obtaining a maximum a posteriori probability estimate of a most likely sequence of hidden states (i.e., Viterbi path) that results in a sequence of observed events. Viterbi algorithms may be employed in context of Markov information sources and hidden Markov models. A Viterbi algorithm may be used to find a best path, for example using a dynamically created combination hidden Markov model, having both acoustic and language model information, using a statically created combination hidden Markov model (e.g., finite state transducer [FST] approach).

Still referring to FIG. 1, in some embodiments, an automatic speech recognition process may employ dynamic time warping (DTW)-based approaches. Dynamic time warping may include algorithms for measuring similarity between two sequences, which may vary in time or speed. For instance, similarities in walking patterns would be detected, even if in one video the person was walking slowly and if in another he or she were walking more quickly, or even if there were accelerations and deceleration during the course of one observation. DTW has been applied to video, audio, and graphics-indeed, any data that can be turned into a linear representation can be analyzed with DTW. In some cases, DTW may be used by an automatic speech recognition process to cope with different speaking (i.e., audible verbal content) speeds. In some cases, DTW may allow processor 104 to find an optimal match between two given sequences (e.g., time series) with certain restrictions. That is, in some cases, sequences can be “warped” non-linearly to match each other. In some cases, a DTW-based sequence alignment method may be used in context of hidden Markov models.

Still referring to FIG. 1, in some embodiments, an automatic speech recognition process may include a neural network. Neural network may include any neural network, for example those disclosed with reference to FIGS. 2 and 4-5. In some cases, neural networks may be used for automatic speech recognition, including phoneme classification, phoneme classification through multi-objective evolutionary algorithms, isolated word recognition, audiovisual speech recognition, audiovisual speaker recognition and speaker adaptation. In some cases. neural networks employed in automatic speech recognition may make fewer explicit assumptions about feature statistical properties than HMMs and therefore may have several qualities making them attractive recognition models for speech recognition. When used to estimate the probabilities of a speech feature segment, neural networks may allow discriminative training in a natural and efficient manner. In some cases, neural networks may be used to effectively classify audible verbal content over short-time interval, for instance such as individual phonemes and isolated words. In some embodiments, a neural network may be employed by automatic speech recognition processes for pre-processing, feature transformation and/or dimensionality reduction, for example prior to HMM-based recognition. In some embodiments, long short-term memory (LSTM) and related recurrent neural networks (RNNs) and Time Delay Neural Networks (TDNN's) may be used for automatic speech recognition, for example over longer time intervals for continuous speech recognition.

With continued reference to FIG. 1, a user profile 108 may be generated using a web crawler. A web crawler may be configured to automatically search and collect information related to the user profile 108. A “web crawler,” as used herein, is a program that systematically browses the internet for the purpose of web indexing. The web crawler may be seeded with platform URLs, wherein the crawler may then visit the next related URL, retrieve the content, index the content, and/or measures the relevance of the content to the topic of interest. In one embodiment, the web crawler may be configured to scrape information related to the user profile 108 from user related social media and networking platforms. The web crawler may be trained with information received from user through a user interface. As a non-limiting example, a user may input into a user interface, social media platforms they have accounts on and would like to retrieve information related to the user profile 108. A user interface may include a graphical user interface (GUI), command line interface (CLI), menu-driven user interface, touch user interface, voice user interface (VUI), form-based user interface, and the like. Processor 104 may receive information related to the user profile 108 including information such as user name, user's profile, platform handles, platforms associated with the user, whether the user's account is verified by a “blue check” mark, evidence of vehicle accidents associated with the user, evidence of criminal activity associated with the user, evidence of gambling associated with user, data which may be used to verify data input by a user, and the like. In some embodiments, a web crawler may be configured to generate a web query. A web query may include search criteria. Search criteria may include photos, videos, audio, user account handles, web page addresses, and the like received from the user. A web crawler function may be configured to search for and/or detect one or more data patterns. A “data pattern” as used in this disclosure is any repeating forms of information. A data pattern may include, but is not limited to, features, phrases, and the like as described further below in this disclosure. The web crawler may work in tandem with a machine-learning model, digital processing technique utilized by a processor, and the like as described in this disclosure. In some embodiments, a web crawler may be configured to determine the relevancy of a data pattern. Relevancy may be determined by a relevancy score. A relevancy score may be automatically generated by processor 104, received from a machine learning model, and/or received from user. In some embodiments, processor 104 may assign a relevancy score to a data pattern based on how relevant the data pattern is to user. In some embodiments, processor 104 may assign a relevancy score to a data pattern based on how relevant the data pattern is to information related to a user profile 108. In a non-limiting example, a data pattern may include several references to driving under the influence databases associated with previous insurers and processor 104 may determine that the data pattern is highly relevant to user profile 108 associated with driving under the influence history. In some embodiments, a relevancy score may include a range of numerical values that may correspond to a relevancy strength of data received from a web crawler function. As a non-limiting example, a web crawler function may search the internet for data related to vehicle accidents or criminal activity associated with the user. In some embodiments, computing device may determine a relevancy score of information associated with the user profile 108 retrieved by a web crawler.

With continued reference to FIG. 1, processor 104 is configured to generate a verified user profile 116 as a function of the user profile 108. As used in the current disclosure, a “verified user profile” is a user profile 108 comprised of verified information. Information associated with a user profile 108 may be verified using a verification process. As used in the current disclosure, a “verification process” is a process wherein the information associated with a user profile 108 is verified using a secondary source. A secondary source may include a third-party database, criminal database, insurer's database, accident report, criminal records, driving records, social media posts, department of transportation records, and the like. A verification process may include comparing information provided by a user to the secondary source for the purpose of ensuring the truthfulness of the user's submission. Identification of a secondary source may be done using a web crawler as mentioned herein above. A web crawler may be configured to identify databases that could potentially contain information related to a user profile 108. In a non-liming example, the user profile 108 may indicate that the user has no record of any traffic violations. A web crawler may be configured to locate the user's driving record by searching the department of transportation website for each state that the user has lived in over the past 10 years. Once the secondary source of the user's driving records has been obtained processor 104 may search the records for any traffic violations associated with the user. If the information provided by the user and the secondary source match then the information is verified. A verification process may additionally be done using a verification machine learning model. In some embodiments, a user profile 108 may be verified using cryptographic systems as mentioned herein above. A verified user profile 116 may additionally be generated by verifying the user profile 108 membership in a cryptographic accumulator, as mentioned in greater detail herein below.

Still referring to FIG. 1, a verified user profile 116 may generated using digital signatures. A “Device fingerprint,” as used in this disclosure, is data used to determine a probable identity of a device as a function of at least a field parameter a communication from the device. At least a field parameter may be any specific value set by user device or user profile 108 and/or user thereof for any field regulating exchange of data according to protocols for electronic communication. As a non-limiting example, at least a field may include a “settings” parameter such as SETTINGS_HEADER_TABLE_SIZE, SETTINGS_ENABLE_PUSH, SETTINGS_MAX_CONCURRENT_STREAMS, SETTINGS_INITIAL_WINDOW_SIZE, SETTINGS_MAX FRAME_SIZE, SETTINGS_MAX_HEADER_LIST_SIZE, WINDOW_UPDATE, WINDOW_UPDATE, WINDOW_UPDATE, SETTINGS_INITIAL_WINDOW_SIZE, PRIORITY, and/or similar frames or fields in HTTP/2 or other versions of HTTP or other communication protocols. Additional fields that may be used may include browser settings such as “user-agent” header of browser, “accept-language” header, “session_age” representing a number of seconds from time of creation of session to time of a current transaction or communication, “session_id,” ‘transaction_id,” and the like. Determining the identity of the first user device or user profile 108 may include fingerprinting the first user device or user profile 108 as a function of at least a machine operation parameter described a communication received from the user device or user profile 108. At least a machine operation parameter, as used herein, may include a parameter describing one or more metrics or parameters of performance for a device and/or incorporated or attached components; at least a machine operation parameter may include, without limitation, clock speed, monitor refresh rate, hardware or software versions of, for instance, components of user device or user profile 108, a browser running on user device or user profile 108, or the like, or any other parameters of machine control or action available in at least a communication. In an embodiment, a plurality of such values may be assembled to generate a verified user profile 116 and distinguish it from other devices. As a non-limiting example, processor 104 may use a device capable of fingerprinting a user device. Verified user profile 116 may include a digital fingerprint from one or more user devices. In some embodiments, digital fingerprint may be a digital scan of the user's fingerprint, eyes, face, tattoos, or any identifying feature. In some embodiments, a digital fingerprint may be associated with a user device, such as a smartphone, laptop, tablet, smartwatch, and the like. Digital fingerprint may be stored in a database and retrieved upon processor 104 receiving a verifiable user profile 108. Digital fingerprint received from user device may be compared to a stored fingerprint associated with the user or user device using methods described above. In some instances, digital fingerprint may be an image of an identifying feature. A certainty percentage threshold may be lower for an image of identifying feature in comparison to a digital fingerprint to account for confounding variables including but not limited to camera quality, formatting, transmission packet loss, or the like. A digital fingerprint may be stored on an immutable sequential listing or a blockchain. A digital fingerprint may be used as an query or input for a web crawler or machine learning model.

With continued reference to FIG. 1, a verification process may include a verification of the user profile 108. As used in this disclosure, “verification” is a process of ensuring that which is being “verified” complies with certain constraints, for example without limitation system requirements, regulations, and the like. In some cases, verification may include comparing data, such as without limitation user profile 108, against one or more acceptance criteria. For example, in some cases, user profile 108 may be required to be verified by at least one secondary source. Ensuring that user profile 108 is in compliance with acceptance criteria may, in some cases, constitute verification. In some cases, verification may include ensuring that data is complete, for example that all required data types are present, readable, uncorrupted, and/or otherwise useful for processor 104. In some cases, some or all verification processes may be performed by processor 104. In some cases, at least a machine-learning process, for example a machine-learning model, may be used to verify. Processor 104 may use any machine-learning process described in this disclosure for this or any other function. In some embodiments, at least one of validation and/or verification includes without limitation one or more of supervisory validation, machine-learning processes, graph-based validation, geometry-based validation, and rules-based validation.

With continued reference to FIG. 1, processor 104 may be configured to generate a verified user profile 116 using a verification machine learning model. As used in the current disclosure, a “verification machine learning model” is a type of machine learning model that is configured to generate a digital avatar using a mathematical and/or algorithmic representation of a relationship between inputs and outputs. In some embodiments, a verification machine learning model may comprise a classifier. A verification machine learning model may be consistent with the machine learning model described herein below in FIG. 2. Inputs to the machine learning model may include user profile 108, vehicle profiles, secondary sources, examples of verified user profiles 116, digital fingerprint, and the like. The outputs of the verification machine learning model may include a verified user profile 116. This data may be received from a database, such as a user profile database 300. Examples of verified user profiles 116 may come from past iterations of verified user profiles 116. A verification machine learning model may be trained using verification training data. Verification training data is a plurality of data entries containing a plurality of inputs that are correlated to a plurality of outputs for training a processor 104 by a machine-learning process. Verification training data may include a correlation between information associated with a user profile 108 and the secondary source. In embodiments, Verification training data may be updated iteratively as a function of the input and output of the verification machine learning model on a feedback loop. Verification training data may include user profile 108, vehicle profiles, secondary sources, examples of verified user profiles 116, digital fingerprint, and the like. Verification training data may be stored in a database, such as a training data database, remote data storage device, user input, or user device.

Still referring to FIG. 1, a verified user profile 116 may include a trustworthiness score. As used herein, a “trustworthiness score” is a value associated with a user's trustworthiness. In some embodiments, a trustworthiness score may include an estimate of the degree to which a user is trustworthy. A trustworthiness score may be evaluated on a numerical scale. In some embodiments, a trustworthiness score may include an estimate of the degree to which user data is fraudulent while entering user profile 108. In some embodiments, a trustworthiness score may include an estimate of the degree to which a response is fraudulent. A machine learning model is configured to analyze user profile 108 concerning whether the user is truthful. A verification machine learning model may be configured to determine the trustworthiness score. A machine learning model may be configured to analyze speech may be trained using speech samples labeled with whether the speaker is truthful with respect to certain statements in the speech samples. In some embodiments, a machine learning model configured to analyze speech may be trained using training data including speech samples correlated to trustworthiness scores. The machine learning model may additionally be configured to evaluate the user profile 108 against a secondary source to determine if the user is being truthful.

With continued reference to FIG. 1, processor 104 may be configured to identify at least one evaluation factor 120 associated with the user profile 108. As used in the current disclosure, an “evaluation factor” is a factor that is used to determine the level of risk associated with a user. As used in the current disclosure, “risk” refers to the chance of occurrence of something harmful happening to the user, property, or third parties. This might include loss or damage of the valuable assets of the person or injury or death of the person or third parties. The risk may specifically refer to the risk of damage associated with vehicles. This may include car-related accidents such as car crashes. The level of risk associated with the user may include the likelihood that a user will be in an accident that will cause injuries to the user, property, and/or third parties. Evaluation factors 120 may include the geographical location, user demographics, age, marital status, gender, vehicle type, previous insurance coverage, vehicle usage and/or driving behavior (e.g. vehicle telematics data such as speed, acceleration [e.g. linear acceleration and deceleration, centripetal acceleration during cornering, or a combination of the two], routes, throttle and/or brake position [e.g. does a driver press the pedal all the way during acceleration and/or braking] during various driving maneuvers), driving behavior (e.g. average speed, average difference between posted speed limit and driven speed, stopping or not stopping at red lights and/or stop signs, and the like), criminal record, driving record, previous insurance claims, credit score, and the like. An evaluation factor 120 may be represented as a score used to reflect the likelihood that an incident resulting in injuries or damage to persons or property. An evaluation factor 120 may be calculated using a numerical scale. A non-limiting example, of a numerical scale may include a scale from 1-10, 1-100, 1-1000, and the like, wherein a rating of 1 may represent a low level of risk associated with the factor, whereas a rating of 10 may represent a high-level of risk associated with the factor. An evaluation factor 120 may be generated from the user profile 108. In a non-limiting example, a user profile 108 may provide that a user is 16 years old and living in Atlanta, GA. Processor 104 may generate an evaluation factor of 7 due to the user's age and 5 for the user's geographic location. Each potential evaluation factor 120 listed above may be assigned a different score. In some embodiments, a first evaluation factor may influence the score of a second evaluation factor. In a non-limiting example, a user profile 108 may provide that the user has a driving record littered with speeding tickets and that the user's vehicle is a high-performance sports car. Independent of each other processor 104 may identify an evaluation factor 120 of 8 for the user's driving record and 7.5 for the user's vehicle. However, when these evaluation factors 120 are evaluated concurrently they may both be given a score of 9, respectively. An evaluation factor 120 may be generated using a machine-learning model. The machine learning model may be configured to be trained using risk training data. Risk training data is a plurality of data entries containing a plurality of inputs that are correlated to a plurality of outputs for training a processor by a machine-learning process to classify data associated with a user profile 108 to a score associated with the evaluation factor 120. Risk training data may comprise data entries correlating user profile 108 to an evaluation factor 120. Risk training data may be received from database 300. Risk training data may contain information about user profile 108, examples of evaluation factors 120, and the like. Risk training data may additionally be generated from any historical versions of any data described herein.

With continued reference to FIG. 1, evaluation factors 120 may be represented using linguistic terms, which may be associated with linguistic variables. As used in the current disclosure, a “linguistic term” is one or more words that are associated with the level of risk associated with one or more evaluation factors 120. A non-limiting example of linguistic terms, which may represent potential values for a linguistic variable, may include “No Risk,” “Low Risk,” “Moderate Risk,” “High Risk,” “Extremely High Risk,” and the like. A linguistic term may be associated with a score associated with an evaluation factor 120. In some embodiments, a numerical score range may be represented by a linguistic value. As used in the current disclosure, a “numerical score range” is a range of scores that are associated with a linguistic value. For example, “No risk” maybe represented by 0-2, “Low Risk” may be represented by 2-4, “Moderate Risk” may be represented as 4-6, “High Risk” may be represented 6-8, and “Extremely High Risk” may be represented as 8-10. Such linguistic terms may be represented, without limitation, using one or more fuzzy sets defined on ranges associated therewith, for instance and without limitation as described below.

With continued reference to FIG. 1, a numerical score range representing evaluation factors may be adjusted using linguistic values. Processor 104 may adjust the numerical score range according to the level of risk associated with the user. Alternatively, processor 104 may adjust the numerical score range to indicate the level of risk a user has according to the current evaluation factor 120. A numerical score range may be determined by comparing the evaluation factors 120 associated with the user to previous iterations of the numerical score ranges. Previous iterations' numerical score ranges may be taken from users who are similarly situated to the current user by vehicle profile, location, driving history, gender, nationality, lifestyle choices, age, and the like. Previous iterations of a numerical score range may be received from database 300. A numerical score range may be generated using a range machine learning model. As used in the current disclosure, a “range machine-learning model” is a machine-learning model that sorts inputs into categories or bins of data, outputting the categories or bins of data and/or labels associated therewith. The range machine-learning model may be consistent with the classifier described below in FIG. 2. Inputs to the range machine-learning model may include a user profile 108, user data, verified user profile 116, examples of numerical score ranges, and the like. Outputs to the range machine-learning model may include a numerical score range. Range training data is a plurality of data entries containing a plurality of inputs that are correlated to a plurality of outputs for training a processor by a machine-learning process to correlate verified user profiles 116 to examples of numerical score ranges. Range training data may be received from database 300. Range training data may contain information about user profile 108, user data, verified user profiles 116, examples of numerical score ranges, and the like. Range training data may be configured to correlate physiological data to examples of numerical score ranges. Classification may be performed using, without limitation, linear classifiers such as without limitation logistic regression and/or naive Bayes classifiers, nearest neighbor classifiers such as k-nearest neighbors classifiers, support vector machines, least squares support vector machines, fisher's linear discriminant, quadratic classifiers, decision trees, boosted trees, random forest classifiers, learning vector quantization, and/or neural network-based classifiers.

With continued reference to FIG. 1, processor 104 may identify an evaluation factor 120 using a factor machine-learning model 128. As used in the current disclosure, a “factor machine-learning model” is a machine-learning model that sorts inputs into categories or bins of data, outputting the categories or bins of data and/or labels associated therewith. Factor machine-learning model 124 may be consistent with the classifier described below in FIG. 2. Inputs to the factor machine-learning model 124 may include user profile 108, vehicle profile, verified user profile 116, examples of evaluation factors 120, and the like. Outputs to the factor machine-learning model 124 may include an evaluation factor 120. Factor content training data is a plurality of data entries containing a plurality of inputs that are correlated to a plurality of outputs for training a processor by a machine-learning process to correlate examples of verified user profiles 116 to examples of evaluation factors 120. Factor content training data may be received from database 300. Factor content training data may contain information about user profile 108, vehicle profile, verified user profile 116, examples of evaluation factors 120, and the like. Factor content training data may correlate a verified user profile 116 to examples of evaluation factors 120. Classification may be performed using, without limitation, linear classifiers such as without limitation logistic regression and/or naive Bayes classifiers, nearest neighbor classifiers such as k-nearest neighbors classifiers, support vector machines, least squares support vector machines, fisher's linear discriminant, quadratic classifiers, decision trees, boosted trees, random forest classifiers, learning vector quantization, and/or neural network-based classifiers.

With continued reference to FIG. 1, a machine-leaning model, such as factor machine-learning model 124, may be implemented as a fuzzy inferencing system. As used in the current disclosure, a “fuzzy inference” is a method that interprets the values in the input vector (i.e., verified user profile 116, and examples of evaluation factors 120) and, based on a set of rules, assigns values to the output vector. A set of fuzzy rules may include a collection of linguistic variables that describe how the system should make a decision regarding classifying an input or controlling an output. An example of linguistic variables may include variables that represent one or more evaluation factors 120. Examples of linguistic variables associated with evaluation factors may be the same or substantially similar to the examples of linguistic terms, as mentioned herein above. The evaluation factor 120 may be determined by the degree of match between a first fuzzy set and a second fuzzy set, and/or single values therein with each other or with either set, which is sufficient for purposes of the matching process. Both a verified use profile 116 and an example of an evaluation factor 120 may be represented by a fuzzy set.

Still referring to FIG. 1, the evaluation factors 120 may be determined as a function of the intersection between two fuzzy sets. Ranking the evaluation factors 120 may include utilizing a fuzzy set inference system as described herein below, or any scoring methods as described throughout this disclosure. For example, without limitation processor 104 may use a fuzzy logic model to determine an evaluation factor 120 as a function of fuzzy set comparison techniques as described in this disclosure. In some embodiments, each piece of information associated with a verified user profile 116 may be compared to one or more examples of an evaluation factor 120, wherein an evaluation factor 120 may be represented using a linguistic variable on a range of potential numerical values, where values for the linguistic variable may be represented as fuzzy sets on that range; a “good” or “ideal” fuzzy set may correspond to a range of values that can be characterized as ideal, while other fuzzy sets may correspond to ranges that can be characterized as mediocre, bad, or other less-than-ideal ranges and/or values. A fuzzy inferencing system may combine such linguistic variable values according to one or more fuzzy inferencing rules, including any type of fuzzy inferencing system and/or rules as described in this disclosure, to determine a degree of membership in one or more output linguistic variables having values representing ideal overall performance, mediocre or middling overall performance, and/or low or poor overall performance; such mappings may, in turn, be “defuzzified” as described in further detail below to provide an overall output and/or assessment. In a non-limiting example, regarding the verified user profile 108, a first linguistic variable representing the user's driving record in a collection of fuzzy sets covering the range of potential values from “poor” (representing a fuzzy set ranging from 10+ traffic violations or two or more vehicle accidents), “satisfactory” (representing a fuzzy set ranging from 5-10 traffic violations or one vehicle accident), and “good” (representing a fuzzy set from 0-5 traffic violations or no vehicle accident). A second linguistic variable representing examples of evaluation factors 120 as potential values in a collection of fuzzy sets covering the range of potential values from “High Risk” (representing a fuzzy set including 10+ traffic violations, two or more automobile accidents, two or more traffic violation related to DUI), “Moderate Risk” (representing a fuzzy set including 5-10, traffic violations, one automobile accident, or 1 traffic violation related to DUI), and “Low Risk” (representing a fuzzy set including 0-5, traffic violations, No automobile accident, and No traffic violations related to DUI). Processor 104 may be implemented to output a third linguistic variable, an evaluation factor 120, that may represent, without limitation, a score value based on the comparison of the first and second linguistic variables. Processor 104 may combine rules, such as: “if the user's driving record is ‘poor’ and the example of evaluation factors 120 reflects ‘High Risk, the evaluation factor 120 for the user's driving record is “High Risk” Processor 104 may use the fuzzy set inference system to score a plurality of segment datum using linguistic variables as described above. Processor 104 may transmit the evaluation factor 120 to a remote device or graphical user interface, for example, as a document, text email, and the like.

Still referring to FIG. 1, the processor may be configured to generate a machine-learning model, such as factor machine-learning model 124, using a Naïve Bayes classification algorithm. Naïve Bayes classification algorithm generates classifiers by assigning class labels to problem instances, represented as vectors of element values. Class labels are drawn from a finite set. Naïve Bayes classification algorithm may include generating a family of algorithms that assume that the value of a particular element is independent of the value of any other element, given a class variable. Naïve Bayes classification algorithm may be based on Bayes Theorem expressed as P(A/B)=P(B/A) P(A)=P(B), where P(A/B) is the probability of hypothesis A given data B also known as posterior probability; P(B/A) is the probability of data B given that the hypothesis A was true; P(A) is the probability of hypothesis A being true regardless of data also known as prior probability of A; and P(B) is the probability of the data regardless of the hypothesis. A naïve Bayes algorithm may be generated by first transforming training data into a frequency table. processor 104 may then calculate a likelihood table by calculating probabilities of different data entries and classification labels. processor 104 may utilize a naïve Bayes equation to calculate a posterior probability for each class. A class containing the highest posterior probability is the outcome of prediction. Naïve Bayes classification algorithm may include a gaussian model that follows a normal distribution. Naïve Bayes classification algorithm may include a multinomial model that is used for discrete counts. Naïve Bayes classification algorithm may include a Bernoulli model that may be utilized when vectors are binary.

Still referring to FIG. 1, processor 104 may be configured to generate a machine-learning model, such as factor machine-learning model 124, using a K-nearest neighbors (KNN) algorithm. A “K-nearest neighbors algorithm” as used in this disclosure, includes a classification method that utilizes feature similarity to analyze how closely out-of-sample-features resemble training data to classify input data to one or more clusters and/or categories of features as represented in training data; this may be performed by representing both training data and input data in vector forms, and using one or more measures of vector similarity to identify classifications within training data, and to determine a classification of input data. K-nearest neighbors algorithm may include specifying a K-value, or a number directing the classifier to select the k most similar entries training data to a given sample, determining the most common classifier of the entries in the database, and classifying the known sample; this may be performed recursively and/or iteratively to generate a classifier that may be used to classify input data as further samples. For instance, an initial set of samples may be performed to cover an initial heuristic and/or “first guess” at an output and/or relationship, which may be seeded, without limitation, using expert input received according to any process as described herein. As a non-limiting example, an initial heuristic may include a ranking of associations between inputs and elements of training data. Heuristic may include selecting some number of highest-ranking associations and/or training data elements.

With continued reference to FIG. 1, generating k-nearest neighbors algorithm may generate a first vector output containing a data entry cluster, generating a second vector output containing an input data, and calculate the distance between the first vector output and the second vector output using any suitable norm such as cosine similarity, Euclidean distance measurement, or the like. Each vector output may be represented, without limitation, as an n-tuple of values, where n is at least two values. Each value of n-tuple of values may represent a measurement or other quantitative value associated with a given category of data, or attribute, examples of which are provided in further detail below; a vector may be represented, without limitation, in n-dimensional space using an axis per category of value represented in n-tuple of values, such that a vector has a geometric direction characterizing the relative quantities of attributes in the n-tuple as compared to each other. Two vectors may be considered equivalent where their directions, and/or the relative quantities of values within each vector as compared to each other, are the same; thus, as a non-limiting example, a vector represented as [5, 10, 15] may be treated as equivalent, for purposes of this disclosure, as a vector represented as [1, 2, 3]. Vectors may be more similar where their directions are more similar, and more different where their directions are more divergent; however, vector similarity may alternatively or additionally be determined using averages of similarities between like attributes, or any other measure of similarity suitable for any n-tuple of values, or aggregation of numerical similarity measures for the purposes of loss functions as described in further detail below. Any vectors as described herein may be scaled, such that each vector represents each attribute along an equivalent scale of values. Each vector may be “normalized,” or divided by a “length” attribute, such as a length attribute l as derived using a Pythagorean norm:

$$l = \sqrt{\begin{matrix}{\sum }_{i = 0}^{n} & {a}_{{i}^{2}}\end{matrix}} ,$$

where aᵢ is attribute number experience of the vector. Scaling and/or normalization may function to make vector comparison independent of absolute quantities of attributes, while preserving any dependency on the similarity of attributes; this may, for instance, be advantageous where cases represented in training data are represented by different quantities of samples, which may result in proportionally equivalent vectors with divergent values.

With continued reference to FIG. 1, processor 104 is configured to generate a profile evaluation 128 as a function of at least one evaluation factor 120. As used in the current disclosure, a “profile evaluation” is a data structure representing an evaluation of the level of risk associated with the user profile 108. A profile evaluation may include data regarding risk categories, types of risks, driving records, risks associated with driving records, a factor score, criteria for risk evaluation, data associated with a driving record or user profile 108 associated to a level of risk, and the like. A profile valuation 128 may additionally be reflected as a score or linguistic term. A profile evaluation 128 may demonstrate the risk associated with the user or the user's vehicle. A profile evaluation 128 may be calculated as a function of an aggregation of evaluation factors 120. This may include averaging the evaluation factors 120. In some embodiments, as a part of generating a profile evaluation 128 the evaluation factor 120 may be weighted, meaning certain evaluation factors 120 may weigh more in the total profile evaluation 128. In a non-limiting example, the evaluation factor regarding the users driving record may be given 50% more weight compared to the other evaluation factors 120. In another embodiment, a profile evaluation 128 may be generated as a function of the verified user profile 116. In a non-limiting example, a user receives an evaluation factor score of 4 for their driving record, 6 for their age, 4 for their vehicle, 8 for their criminal record, and 7 for their demographics. In one embodiment, processor 104 may average these scores to generate the profile evaluation score of 5.8. A profile evaluation 128 may additionally reference the user's previous evaluation factors 120 and profile evaluations 128 to determine the current profile evaluation 128. In a non-limiting example, if the user's profile evaluation has improved over the past 3 years from “High Risk” to “No Risk.” Processor 104 may still reduce the current user profile evaluation to a “Moderate Risk” to account for any relapse in the user's recent improvements.

With continued reference to FIG. 1, if a verification process has shown that the user was untruthful while entering the user profile 108 the profile evaluation 128 may be impacted negatively. Processor 104 weigh the severity of the untruthfulness of the user when generating the profile evaluation 128 using a trustworthiness score. As used herein, a “trustworthiness score” is a value associated with a user's trustworthiness. A trust worthiness score may be a numerical score, wherein a higher number represent a trustworthy user and a lower score represents an untrustworthy user. In some embodiments, a trustworthiness score may include an estimate of the degree to which a user is trustworthy. In some embodiments, a trustworthiness score may include an estimate of the degree to which user profile 108 is fraudulent. In some embodiments, a trustworthiness score may include an estimate of the degree to which a response is fraudulent. In a non-limiting example, if a user omitted the fact that they have several DUI convictions the profile evaluation 128 automatically deem the user as extremely high risk and at trustworthiness score of 0 out of 10. However, if the user falsely reported the color of the vehicle the profile evaluation 128 may be only slightly negatively impacted and award the user a trustworthiness score of 4 out of 10. In some embodiments, the user trustworthiness may be represented using a linguistic variables, examples of these linguistic variables may include “Trustworthy,” “Slightly Untrustworthy,” “Extremely Untrustworthy,” and the like.

With continued reference to FIG. 1, a processor 104 may generate a profile evaluation 128 using a lookup table. A “lookup table,” for the purposes of this disclosure, is a data structure, such as without limitation an array of data, that maps input values to output values. A lookup table may be used to replace a runtime computation with an indexing operation or the like, such as an array indexing operation. A look-up table may be configured to pre-calculate and store data in a static program storage, calculated as part of a program's initialization phase, or even stored in hardware in application-specific platforms. Data within the lookup table may include previous examples of profile evaluations 128 compared to evaluation factors 120. Data within the lookup table may be received from database 300. Lookup tables may also be used to identify a profile evaluation 128 by matching an input value to an output value by matching the input against a list of valid (or invalid) items in an array. In a non-limiting example, the evaluation factor 120 may provide that a user has 5 relevant evaluation factor scores of 7, 5, 4, 7, and 1, respectively. Examples profile evaluation 128 may show users with two evaluation factor scores over 6 cannot be classified as “low risk.” Examples of profile evaluations 128 may additionally show users with an average evaluation factor score above 4 will be considered “moderate risk.” Thus, the look-up table will output a profile evaluation 128 of a “moderate risk.” Processor 104 may be configured to “lookup” or input one or more evaluation factors 120 and the like. Whereas the output of the lookup table may comprise a profile evaluation 128 tailored to the current evaluation factors 120. Data from the lookup table may be compared to the examples of profile evaluations 128, for instance, and without limitation using string comparisons, numerical comparisons such as subtraction operations, or the like; discrepancies may indicate data faults. Alternatively or additionally, a query representing elements of remittance data may be submitted to the lookup table and/or a database, and an associated data fault identifier stored in a data record within lookup table and/or database may be retrieved using the query.

With continued reference to FIG. 1, processor 104 may be configured to generate a profile evaluations 128 using an evaluation machine learning model. As used in the current disclosure, a “evaluation machine learning model” is a type of machine learning model that is configured to generate a digital avatar using a mathematical and/or algorithmic representation of a relationship between inputs and outputs. In some embodiments, an evaluation machine learning model may comprise a classifier. A evaluation machine learning model may be consistent with the machine learning model described herein below in FIG. 2. Inputs to the machine learning model may include user profile 108, vehicle profiles, verified user profiles 116, evaluation factors 120, examples of profile evaluations 128, and the like. The outputs of evaluation machine learning model may include profile evaluations 128. This data may be received from a database, such as a user profile database 300. Examples of profile evaluations 128 may come from past iterations of profile evaluations 128. A evaluation machine learning model may be trained using evaluation training data. Evaluation training data is a plurality of data entries containing a plurality of inputs that are correlated to a plurality of outputs for training a processor 104 by a machine-learning process. Evaluation training data may include a correlation between information associated with evaluation factors 120 and examples of profile evaluations 128. In embodiments, Evaluation training data may be updated iteratively as a function of the input and output of the evaluation machine learning model on a feedback loop. Evaluation training data may include user profile 108, vehicle profiles, verified user profiles 116, evaluation factors 120, examples of profile evaluations 128, and the like. Evaluation training data may be stored in a database, such as a training data database, remote data storage device, user input, or user device.

Still referring to FIG. 1, a fuzzy inferencing system may be used to generate a profile evaluation 128. The current fuzzy inferencing system may be the same or substantially similar to any fuzzy inferencing system described herein. Input vectors into the fuzzy inferencing system may include an evaluation factor 120 and an example of a profile evaluation 128. The output to the fuzzy inferencing system may be a profile evaluation 128. In an embodiment, both an evaluation factors 120 and an example of a profile evaluation 128 may be represented as fuzzy sets. The profile evaluation 128 may be represented as the overlap between two fuzzy sets representing an example of a profile evaluation 128 and an evaluation factor 120. To determine the overlap between the two fuzzy sets a set of fuzzy rules may be applied. As used in the current disclosure, a “fuzzy rule” is a conditional statement regarding the input vectors. The form of fuzzy rules may include IF THEN statements. If y is B THEN x is A, where x and y are linguistic variables, and A and B are linguistic values determined by fuzzy sets. An example of fuzzy rules may include IF a user has an evaluation factor 120 indicating the level of risk regarding their driving record is extremely high risk THEN the user's profile evaluation 128 is extremely high risk. In another non-limiting example of fuzzy rules, IF a user has an evaluation factor 120 indicating that level of risk regarding the user demographics are low risk, THEN the user's profile evaluation 128 may be deemed as low risk IFF the user has less than 3 traffic citations. In some embodiments, a fuzzy rule may be implemented using decision trees and discussed in greater detail herein below. A Fuzzy inferencing rule may be used to evaluate a plurality of evaluation factors 120 simultaneously. This may include assigning weights to each evaluation factor 120 to determine the impact they will have on the overall profile evaluation 128. In some embodiments, a machine learning model may be used to generate the fuzzy rules. The machine learning model may input a examples of profile evaluations 128, evaluation factors 120, verified user profiles 116, and the like. The machine learning model may output a fuzzy rule that is tailored to the current user. The machine learning model may be trained using any training data found throughout the entirety of this disclosure.

Still referring to FIG. 1, a profile evaluation 128 may be used to generate a pecuniary datum. As used herein, a “pecuniary datum” is a cost to insure the user as a function of the profile evaluation 120. A pecuniary datum may also reflect the cost of taking on a risk associated with a user. As a non-limiting example, this may include the cost of taking on a risk of having to compensate the user in the case of an adverse event. In some embodiments, a pecuniary datum is determined as a function of user profile 108 or the profile evaluation 128. In some embodiments, a pecuniary datum is determined using a pecuniary datum machine learning model, fuzzy inference set, or lookup table. In some embodiments, a pecuniary datum machine learning model may include a machine learning model configured to analyze speech, and/or a machine learning model configured to determine a pecuniary datum. A pecuniary datum may be determined as a function of a trustworthiness score.

Still referring to FIG. 1, processor 104 may be configured to display the profile evaluation 128 using a display device 132. As used in the current disclosure, a “display device” is a device which is used to display a content processor 104. A display device 132 may include a user interface. A “user interface,” as used herein, is a means by which a user and a computer system interact; for example through the use of input devices and software. A user interface may include a graphical user interface (GUI), command line interface (CLI), menu-driven user interface, touch user interface, voice user interface (VUI), form-based user interface, any combination thereof and the like. A user interface may include a smartphone, smart tablet, desktop, or laptop operated by the user. In an embodiment, user interface may include a graphical user interface. A “graphical user interface (GUI),” as used herein, is a graphical form of user interface that allows users to interact with electronic devices. In some embodiments, GUI may include icons, menus, other visual indicators, or representations (graphics), audio indicators such as primary notation, and display information and related user controls. A menu may contain a list of choices and may allow users to select one from them. A menu bar may be displayed horizontally across the screen such as pull down menu. When any option is clicked in this menu, then the pull down menu may appear. A menu may include a context menu that appears only when the user performs a specific action. An example of this is pressing the right mouse button. When this is done, a menu may appear under the cursor. Files, programs, web pages and the like may be represented using a small picture in a graphical user interface. For example, links to decentralized platforms as described in this disclosure may be incorporated using icons. Using an icon may be a fast way to open documents, run programs etc. because clicking on them yields instant access. Information contained in user interface may be directly influenced using graphical control elements such as widgets. A “widget,” as used herein, is a user control element that allows a user to control and change the appearance of elements in the user interface. In this context a widget may refer to a generic GUI element such as a check box, button, or scroll bar to an instance of that element, or to a customized collection of such elements used for a specific function or application (such as a dialog box for users to customize their computer screen appearances). User interface controls may include software components that a user interacts with through direct manipulation to read or edit information displayed through user interface. Widgets may be used to display lists of related items, navigate the system using links, tabs, and manipulate data using check boxes, radio boxes, and the like.

With continued reference to FIG. 1, processor 104 may be further configured to utilize a digital assistant 112 to communicate with a user or other entity using processor 104. Digital assistant 112 may establish a communication channel with a user. A “communication channel,” as used herein, is defined as a medium for conveying or transmitting information. For example, information may include physical media, digital media, or both. An “entity” is defined as a person, user, business, organization, computer system, computer program, chatbot, AI construct, or the like. Further, any non-human entity referenced herein may include human entities that would be associated with said non-human entity by one of ordinary skill in the art. For example, a reference to a legal entity such as a municipal court should be understood to include any human entities that one of ordinary skill in the art would associate with a municipal court, such as a lawyer, a judge, a clerk, a bailiff, a police officer, a receptionist, a government official, and the like. In an embodiment, examples of communication channels utilized by a digital assistant 112 may include email, phone call, paper mail, package mail, a delivery courier or service, a shipping service, satellite call, text message, text chat, voice chat, web form, messaging app (e.g. WhatsApp, Signal, Facebook Messenger, etc.), smartphone app (e.g. Instagram, Snapchat, TikTok), computer program, web interface, web program, webpage, API, social media platform (e.g. tweeting on Twitter), social media platform internal messaging medium (e.g. Twitter direct message), or any suitable digital assistant 112 as would be known to one of ordinary skill in the art.

With continued reference to FIG. 1, processor 104 may utilize a third-party platform to communicate with the digital assistant 112. A “third-party platform” as used herein is defined as a system, computer program, or apparatus that is maintained or operated by a party other than the user. A third-party platform may be a social media network and related communication means. For example, apparatus 100 may interact with a user by being presented in a format according to a social media network. For example, apparatus 100 may be presented as a Facebook profile, a Twitter account or handle, a TikTok profile, and the like. Apparatus 100 may accordingly utilize communication functionality built into the social media network or associated apps, such as a direct messaging functionality built into a social media smartphone app.

With continued reference to FIG. 1, a user may be a user or may not be a user. For example, an entity may be an insurance company formerly used by a user, a bank, a government entity such as an agency, a business entity (such as an LLC, a corporation, a business partner, and the like), a legal or law enforcement entity (such as a court, a police station, a private investigator, a lawyer, a judge, and the like), a human associated with a user (e.g. a friend, a spouse, a parent, a child, an acquaintance, current or former coworker, a boss, and the like), a credit agency, a source of public records, a school attended by or associated with a user, an employer, or the like.

With continued reference to FIG. 1, the processor 104 may be further configured to utilize the digital assistant 112 to receive user profile 108 related to a user from the user. The processor 104 may be further configured to utilize the digital assistant 112 to exchange user profile 108 related to a user between the processor 104 and the user. In an embodiment, user profile 108 may include two portions: a first portion generated by processor 104 while the second portion of user profile 108 is generated by user. First information may include information related to a user (such as identifying information, information regarding a user insurance policy, information related to physical characteristics, employment information), information related to a communication channel utilized by digital assistant 112 (such as a customer support telephone number or email, a help website, a mailing address, etc.), information related to insurance (such as information indicating the initiation, modification, updating, or cancellation of insurance coverage for a user or associated person, filing a claim, a quote for insurance coverage, a user policy, and the like), information related to an event (such as a car accident involving the user's car, a tree falling on a user's house, the birth of a child for which user requires additional health insurance coverage), information related to the exchange (e.g. a greeting such as “Hello”, a question, parts of speech, components of language (e.g. phonology, morphology, syntax, semantics, pragmatics, vocabulary, grammar, lexicography, and the like), and the like. User profile 108 may include information related to a user if the entity is different from the user. In an embodiment, user profile 108 may indicate a subject indirectly or directly. For example, user profile 108 may include a direct indication that a user wishes to file a claim, such as the sentence “I want to file a claim”. In an alternative embodiment, user profile 108 may include an oblique or indirect indication that a user wishes to file a claim, such as the sentence “Some guy just ran into my car. How do I get his insurance to take care of this?”

With continued reference to FIG. 1, processor 104 may be further configured to extract at least one user datum from the user profile 108. “User datum,” as used herein, is defined as an element of information related to a user. User datum may include user identifying information (such as name, address, social security number, age, height, weight, health, and the like), information related to a communication involving a user (such as an email, a phone call, a text message, a website help chat message, a voicemail, information communicated through a form, information communicated through a webpage or the internet, information communicated in person, mailed information, faxed information, written information, and the like, where any of the foregoing may be from a user or from a different entity), insurance information relating to a user (such as current policy coverage, policy dates, policy costs, a deductible, a policy rate, claims filed, and the like), information related to a user's suitability for coverage (such as criminal record, credit score, employment information, instances of fraud or suspected fraud, employment history, trustworthiness, and the like), and the like. User datum may be any information used by apparatus 100 to initiate at least one action related to the user.

With continued reference to FIG. 1, processor 104 may extract at least one user datum from the user profile 108 by analyzing portions of user profile 108 generated by user. Analyzing portions of user profile 108 generated by user may include utilizing language processing methods to identify words in portions of user profile 108 generated by user. Processor 104 may retrieve a list of keywords from memory, user profile database 300, or another suitable source, and compare the identified words from portions of user profile 108 generated by user. For example, portions of user profile 108 generated by user may include the sentence “I need to file a claim.” Processor 104 may then parse the sentence and identify the individual syntactic elements “I” “need” “to” “file” “a” and “claim” and would additionally identify the “.” as indicating the end of the sentence. Processor 104 may then compare the individual words with the list of keywords and identify any matches. The keywords used by processor 104 may be linked to a defined function, for example by a person manually associating keywords with a defined function or by a computing device such as apparatus 100 programmed to create an association between a keyword and a defined function, for instance by extracting words contained in comments of computer code for a particular function. For example, a computing device such as apparatus 100 may receive instructions that a particular piece of software performs the process of filing a claim. Apparatus 100 may then extract all of the comments associated with the particular piece of software and use those as keywords for a defined function. In the above example, processor 104 may identify the keywords “file” and “claim” and initiate a predefined claim filing process based on the association between those keywords and the process. Processor 104 may extract at least one user datum by generating the following prompt: “Ok, I'll get that claim process started for you. What's your account number?” User may then generate an additional portion of user profile 108, such as: “My account number is 55375914.” Processor 104 may then analyze the replied portion of user profile 108 generated by user by parsing the reply and searching for a number consisting of a predetermined number of digits, such as eight. The processor 104 may then compare the account number to a database associating account numbers and user identifying information and determine that account number 55375914 belongs to user Bill Jones and is therefore a valid user datum. Processor 104 may then begin the process of filing a claim based on information contained in Bill Jones' stored user profile 108.

With continued reference to FIG. 1, the processor 104 may be configured to modify the informational contents of the user profile database 300 based on at least one of the user datum and the user profile 108. As used herein in relation to information or data, “modify” means creating, updating, modifying, annotating, marking, noting, notating, or deleting the information or data or a reference to the information or data. For example, processor 104 may store the entirety of user profile 108 on user profile database 300 as a record of the communication between user and apparatus 100. In an alternative embodiment, processor 104 may store user datum, a portion of user profile 108, all of user profile 108, additional information implied by user profile 108, determinations made by processor 104 based on user profile 108 and/or user datum, or any combination thereof. For example, processor 104 may modify the informational contents of user profile database 300 to reflect that a claim should be filed for user Bill Jones with account number 55375914 and store a task datum indicating that an insurance adjustor should be scheduled to travel to Bill Jones' residence to assess damages.

With continued reference to FIG. 1, modifying informational contents of user profile database 300 may include modifying user identifying information (for example updating a user weight, updating a user disability, creating a user profile when onboarding a new user, deleting a user profile for a user who leaves an insurance company operating apparatus 100, and the like), modifying policy coverage for a user (for example adding additional coverage for a new car, changing a policy rate for a user home following the construction of an addition, deleting coverage for a boat based on a user selling the boat, adding a new policy for a newborn child, and the like), modifying information pertaining to a user received from a non-user entity (for example receiving an updated user credit score from a credit bureau and modifying the contents of user profile database 300 to reflect the updated user credit score, updating user profile 108 to reflect an arrest record received from a federal court, deleting a user profile upon receiving an indication that a user has passed away, and the like), modifying insurance parameters for a user (for example an insurance rate, a deductible, a maximum payout, a maximum level of coverage, and the like).

With continued reference to FIG. 1, processor 104 may be further configured to initiate at least one action related to the user based on the user profile 108. An “action” as used herein, is a process or operation performed to achieve a goal, objective, or outcome. For example, a processor 104 may initiate at least one action related to the user based on the user profile 108 by scheduling the at least one action, updating data associated with a user to reflect the desired action, transmitting a communication regarding the action with one or more persons, computer programs, apparatuses, systems or the like, selecting a computer program, person, or other entity to execute the action, by performing the entirety of the specified action, and the like. Instructions contained on memory may configure processor 104 to initiate at least one action related to the user based on information contained in user profile 108. For example, user profile 108 may contain keywords that processor 104 may be configured to identify as explained in detail herein. Memory may contain instructions associating those keywords with one or more predefined actions that processor 104 may be configured to initiate. Upon identification of those keywords in user profile 108, processor 104 may initiate the corresponding at least one action.

With continued reference to FIG. 1, processor 104 may be further configured to create a single user view by agglomerating user information from one or more sources including the user profile 108. “User information,” as used herein, is defined as information related to a user. User profile 108 may be any information that processor 104 determines is related to a user. One or more sources may be any source of information listed herein, including insurance information, stored user information, banking information, legal information, occupational information, publicly available information, user profile 108, social media information, entity communication information, credit bureau information, and the like. Processor 104 may determine one or more elements of information is related to a user by parsing or otherwise analyzing the one or more elements and identifying information linked to a user. The one or more elements of information can be any source or type of information disclosed herein or that would be obvious to one of ordinary skill in the art. For example, processor 104 may parse one or more elements of information and determine that the one or more elements of information contain a key: value pair such as {“User name”: “Bill Jones”} and accordingly identify that the information is user information for Bill Jones. Alternatively or additionally, processor 104 may compare values or words in the one or more elements of information with keywords or existing information stored on user profile database 300, memory, or any other source that processor 104 may be communicatively coupled with. A “single user view” as used herein is defined as a collection of information about a user gathered from different sources. For example, a single user view may collect banking information about a user from a bank (for example recent purchases, number of accounts, net worth, overdraft fees, loans including vehicle loans, etc.), social media information about a user from a public social media profile, (e.g. social media posts, pictures (such as a picture of a fender bender the user was in recently), videos (such as a video of a user speeding or driving carelessly), comments, and the like), credit score and related credit information from a credit bureau, legal information from public or background check records (e.g. an arrest record, outstanding warrants, convictions for particular crimes such as fraud, and the like) and agglomerate the user profile 108 into a single source. Such a centralized collection of information can help make a more accurate or faster determination about whether or not a user is trustworthy, what an appropriate insurance policy or insurance rate might be for a user, how to reduce risk related to a user, and the like.

With continued reference to FIG. 1, processor 104 may agglomerate user profile 108 to create a single user view by storing information identified as user profile 108 in a single database, a single file, on a single data storage location such as user profile database 300, on multiple data storage locations but with a single index indicating what information is stored where, from multiple data sources but presented or displayed in a single interface, in a single physical record such as a piece of paper, plural proximal pieces of paper (e.g. paper stapled together, placed in the same folder, marked with the same identifying information, etc.), or otherwise presenting, storing, displaying, or accessing user profile 108 in a manner that associates information with a particular user. Processor 104 may store a single user view in a predetermined format such as a database, a dictionary, a list, a text file, an encrypted file, a blockchain, a ledger, a spreadsheet, a comma-separated values (CSV) file, a file separated by any other delineator, and the like.

With continued reference to FIG. 1, processor 104 may be further configured to modify the informational contents of user profile database 300 based on the single user view. For example, processor 104 may store a single user view on user profile database 300, modify an existing single user view stored on user profile database 300 with new information, modify informational contents 152 to incorporate previously missing information based on information received by processor 104 in user profile 108, user datum, or otherwise included in single user view, and the like.

With continued reference to FIG. 1, user profile 108 may be exchanged in a natural language format. A “natural language format” as used herein is defined as a format for communicating information corresponding to a style of speaking, writing, signing or otherwise using a language that naturally occurs or might naturally occur between a plurality of humans communicating in that language. For example, a natural language format may simulate a format that a user would utilize when speaking with another person such as a friend, a coworker, a spouse or partner, a child, a parent, or the like. Processor 104 may generate prompts, questions, responses, or related components included in user profile 108 in a natural language format. For example, an exchange of user profile 108 between processor 104 and user may take the following format:

| | |
|---|---|
| User | “Hey, can I update my policy?” |
| Digital Assistant | “Sure! What do you need to update?” |
| Apparatus via | |
| processor | |
| 104 (DAA) | |
| User | “I just moved to a new address.” |
| DAA | “I can help you with that. What's |
| | the new address? Congrats |
| | on the move btw!” |
| User | “1450 East Willow Drive, Pembroke |
| | Pines, FL, 33028” |

The natural language format may allow the exchange of user profile 108 to seem or feel more natural to user and reduce or eliminates the need for a user to be instructed or trained on how to input information into a digital assistant system or apparatus such as apparatus 100.

With continued reference to FIG. 1, processor 104 may exchange information from user profile 108 in a natural language format by determining one or more language elements from the user profile 108 or from any suitable information element disclosed herein. Processor 104 may determine one or more language elements from the user profile 108 using a language processing module. Processor 104 and/or language processing module may operate to generate a language processing model. Language processing module may include any hardware and/or software module. “Language elements” as used herein are defined as one or more components of a language. Language elements may include one or more phonological elements, morphological elements, syntactic elements, semantic elements, pragmatic elements, vocabulary elements, grammatical elements, lexicographical elements, and the like. One or more words may include, without limitation, strings of one or more characters, including without limitation any sequence or sequences of letters, numbers, punctuation, diacritic marks, engineering symbols, geometric dimensioning and tolerancing (GD&T) symbols, chemical symbols and formulas, spaces, whitespace, and other symbols, including any symbols usable as textual data as described above. Textual data may be parsed into tokens, which may include a simple word (sequence of letters separated by whitespace) or more generally a sequence of characters as described previously. The term “token,” as used herein, refers to any smaller, individual groupings of text from a larger source of text; tokens may be broken up by word, pair of words, sentence, or other delimiter. These tokens may in turn be parsed in various ways. Textual data may be parsed into words or sequences of words, which may be considered words as well. Textual data may be parsed into “n-grams”, where all sequences of n consecutive characters are considered. Any or all possible sequences of tokens or words may be stored as “chains”, for example for use as a Markov chain or Hidden Markov Model. Processor 104 and/or language processing module may receive one or more elements of user profile 108 and parse the one or more elements of user profile 108 into any language elements identified above.

With continued reference to FIG. 1, processor 104 may determine one or more language elements in user profile 108 by identifying and/or detecting associations between one or more language elements (including phonemes or phonological elements, morphemes or morphological elements, syntax or syntactic elements, semantics or semantic elements, and pragmatic elements) extracted from at least user profile 108, including without limitation mathematical associations, between such words. Associations between language elements and relationships of such categories to other such term may include, without limitation, mathematical associations, including without limitation statistical correlations between any language element and any other language element and/or Language elements. Processor 104 may compare an input such as a sentence from user profile 108 with a list of keywords or a dictionary to identify language elements. For example, processor 104 may identify whitespace and punctuation in a sentence and extract elements comprising a string of letters, numbers or characters occurring adjacent to the whitespace and punctuation. Processor 104 may then compare each of these with a list of keywords or a dictionary. Based on the determined keywords or meanings associated with each of the strings, processor 104 may determine an association between one or more of the extracted strings and a function of an organization that is operating apparatus 100, such as an association between a string containing the word “premium” and an insurance company that is operating apparatus 100. Associations may take the form of statistical correlations and/or mathematical associations, which may include probabilistic formulas or relationships indicating, for instance, a likelihood that a given extracted word indicates a given category of semantic meaning. As a further example, statistical correlations and/or mathematical associations may include probabilistic formulas or relationships indicating a positive and/or negative association between at least an extracted word and/or a given semantic meaning; positive or negative indication may include an indication that a given document is or is not indicating a category semantic meaning. Whether a phrase, sentence, word, or other textual element in a document or corpus of documents constitutes a positive or negative indicator may be determined, in an embodiment, by mathematical associations between detected words, comparisons to phrases and/or words indicating positive and/or negative indicators that are stored in memory at computing device, or the like.

With continued reference to FIG. 1, determining one or more language elements in user profile 108 by identifying and/or detecting associations between one or more language elements may allow for the interpretation of entity-generated portions of user profile 108 that may not follow traditional rules of grammar, spelling, punctuation, speaking, or other aspects of communication. For example, processor 104 may be able to interpret “bro cn u hlp me get car inchurins” as a request to initiate coverage for a vehicle. Processor 104 may accomplish this interpretation by determining associations between language elements. For example, processor 104 may associate the phoneme “u” with the syntactic element “you,” which processor 104 may be programmed to interpret as the insurance organization that owns apparatus 100. Processor 104 may further break down “inchurins” into component phonemes or syllables such as “in,” “chur” and “ins” and correlate each with the syllables of “insurance,” thereby identifying that the user is making an inquiry related to insurance.

With continued reference to FIG. 1, processor 104 may be configured to determine one or more language elements in the user profile 108 using machine learning by first creating or receiving language classification training data. Training data is described in further detail with reference to FIG. 2.

With continued reference to FIG. 1, language classification training data may be a training data set containing associations between language element inputs and associated language element outputs. Language element inputs and outputs may be categorized by communication form such as written language elements, spoken language elements, typed language elements, or language elements communicated in any suitable manner. Language elements may be categorized by component type, such as phonemes or phonological elements, morphemes or morphological elements, syntax or syntactic elements, semantics or semantic elements, and pragmatic elements. Associations may be made between similar communication types of language elements (e.g. associating one written language element with another written language element) or different language elements (e.g. associating a spoken language element with a written representation of the same language element). Associations may be identified between similar communication types of two different language elements, for example written input consisting of the syntactic element “that” may be associated with written phonemes /th/, /\check{a}/, and /t/. Associations may be identified between different communication forms of different language elements. For example, the spoken form of the syntactic element “that” and the associated written phonemes above. Language classification training data may be created using a classifier such as a language classifier. An exemplary classifier may be created, instantiated, and or run using processor 104, machine learning module 200, or another computing device. Language classification training data may create associations between any type of language element in any format and other type of language element in any format. Additionally or alternatively, language classification training data may associate language element input data to functionality related to an operator of apparatus 100. For example, language classification training data may associate occurrences of the syntactic elements “get,” “car,” and “insurance,” in a single sentence with the functionality of insuring a vehicle provided by an operator of apparatus 100, for instance a car insurance company.

With continued reference to FIG. 1, processor 104 may additionally create or receive operator functionality training data containing associations between language elements and one or more functionalities provided by an operator of apparatus 100, such as an insurance company. Operator functionality training data may associate language elements such as words, phrases, or other language elements with particular functions performed by an operator of apparatus 100. For example, operator functionality training data may contain associations between the phrase “new customer” and an onboarding process, between the word “claim” and a claims initiation process, between a phrase containing a social security number, a name, and the phrase “arrested for fraud” with a process for terminating coverage based on a user being arrested for fraud.

With continued reference to FIG. 1, processor 104 may additionally create or receive entity communication style training data containing associations between language elements and one or more entity communication styles. Entity communication style training data may correlate any aspect of groups (A) and (B), where (A) includes any one or more of associate average, median, mode, standard deviation, variance, and similar parameters for sentence length for an entity, sentence length for a representative population or entities, word length for an entity and/or representative population of entities, words used in a sentence by a user or representative population of entities, statistics for word choice, particular word frequency, number or statistical occurrence (e.g. mean, median, mode, standard deviation, and the like) of spelling errors in a sentence, in an entire communication, or an entire single user view, or any aspect of user datum, single user view, or the like, device metadata such as device type (e.g. smartphone, tablet, laptop computer, desktop computer, kiosk, etc.), software information (e.g. browser type, device operating system, email service, email address, phone carrier, phone number, screen name or social media handle, etc.), device identifier (e.g. IP address, MAC address, geofencing or geolocation data, device serial number, etc.), communication mode (e.g. written, spoken, email, text message, voice call, home digital assistant, social media platform, etc.), and (B) includes any one or more of a particular weight, probability, numerical descriptor, and/or verbal descriptor of mood, personality type, class of behaviors, or subsequent action for apparatus 100 or processor 104 to take or implement. For example, entity communication style training data may contain associations between statistical parameters of communications between entities and digital or other assistants based on word choice frequency (e.g. occurrence of one or more keywords in a communication) and a classification of user and/or appropriate action for processor 104 to take or implement.

With continued reference to FIG. 1, processor 104 may be configured to generate a classifier using a K-nearest neighbors (KNN) algorithm. Once language classification training data is created or received by processor 104, a dynamic response machine learning model may be trained using the language classification training data by processor 104, machine learning module 200, or another device. In a non-limiting embodiment, language classification training data is submitted to a machine-learning model, which generates a trained dynamic response machine learning model based on the correlated relationship or relationships between language elements. For instance, and without limitation, a linear regression model, generated using a linear regression algorithm, may use a linear combination of language input data using coefficients derived during machine-learning processes to calculate a language element output datum. As a further non-limiting example, a machine-learning model may be generated by creating an artificial neural network, such as a convolutional neural network comprising an input layer of nodes, one or more intermediate layers, and an output layer of nodes. Connections between nodes may be created via the process of “training” the network, in which elements from language classification training data set are applied to the input nodes, a suitable training algorithm (such as Levenberg-Marquardt, conjugate gradient, simulated annealing, or other algorithms) is then used to adjust the connections and weights between nodes in adjacent layers of the neural network to produce the desired natural language output values at the output nodes. This process is sometimes referred to as deep learning.

With continued reference to FIG. 1, once entity communication style training data is created or received by processor 104, a dynamic response machine learning model may be trained using the entity communication style training data by processor 104, machine learning module 200, or another device. In a non-limiting embodiment, entity communication style training data is submitted to a machine-learning model, which generates a trained dynamic response machine learning model based on the correlated relationship or relationships between entity communication styles. For instance, and without limitation, a linear regression model, generated using a linear regression algorithm, may use a linear combination of communication statistical parameter and/or device metadata input data using coefficients derived during machine-learning processes to calculate an entity communication style output datum and/or an optimal response output datum, such as a response having the highest probability of resolving a customer's need. As a further non-limiting example, a machine-learning model may be generated by creating an artificial neural network, such as a convolutional neural network comprising an input layer of nodes, one or more intermediate layers, and an output layer of nodes. Connections between nodes may be created via the process of “training” the network, in which elements from language classification training data set are applied to the input nodes, a suitable training algorithm (such as Levenberg-Marquardt, conjugate gradient, simulated annealing, or other algorithms) is then used to adjust the connections and weights between nodes in adjacent layers of the neural network to produce the desired entity communication style output values at the output nodes.

With continued reference to FIG. 1, processor 104 may be configured to utilize a trained dynamic response machine learning model to generate dynamic response information based on portions of user profile 108 generated by user. For example, a trained dynamic response machine learning model may receive a sentence or similar written communication from user as an input. The trained dynamic response machine learning model may then generate written output corresponding to the information and style of the input from user, such as a response to a question asked by user or an indication that a process would be started based on the user's input. Processor 104 may create dynamic response information in a particular communication style, such as a style identified by processor 104 as being associated with user. A “communication style,” as used herein, is defined as a pattern of language elements or manner of arranging language elements. For example, processor 104 may be trained with language classification training data associating particular words, phrases, or language elements with a particular style of communication such as a formal writing style, a short and/or clipped writing style, a verbose speaking style, a minimal speaking style, a particular accent for a speaking style, a gendered voice, and the like. For example, user may indicate via user profile 108 “Can you give me a quote for car insurance? Just tell me a deductible and monthly price.” Processor 104 may then generate a dynamic response of “Deductible: $500. Monthly price: $136.” Additionally or alternatively, user may indicate via user profile 108 “i dont understand why my monthly premium is so high my car is so old can you explain that to me in dtail?” to which the processor may generate a dynamic response of “While your vehicle is 15 years old, it only has 23,000 miles on it, which is ⅕ as many miles as the average for that make and model year. Your vehicle therefore has more than double the Kelly Blue Book value than the average vehicle of that make and model year and is accordingly more expensive to insure.”

With continued reference to FIG. 1, processor 104 may be further configured to adapt a natural language format based on one or more language elements according to a determined entity communication style in the user profile 108. For example, processor 104 may have a default communication style when exchanging information with a user. Processor 104 may receive direct or indirect feedback from a user indicating that the entity would prefer a different communication style. For example, a user may explicitly request via user profile 108 “Could you use smaller words please?” Processor 104 may then prioritize using words that were six characters in length or less. As an additional or alternative example, a user named Joseph may have a casual writing style and may say something like “y do u talk like a robot, bro?” Processor 104 may input this phrase into a dynamic response machine learning model and receive an output better reflecting Joseph's implied preference for a more casual writing style such as “my b broseph i aim 2 please” instead of “My apologies Joseph, I aim to please.” This can allow for a user to feel more comfortable with digital assistant apparatus 100 and may encourage a user to be more forthcoming with relevant information such as user datum related to insurance coverage, a credit score, any outstanding legal issues, and the like. Processor 104 may additionally or alternatively determine an entity communication style based on communication received from user over time, communication in single user view, entity communication style determined from user profile 108 by language classification machine learning model, communication style determined from other sources of data such as a social media profile associated with user, and the like.

With continued reference to FIG. 1, entity communication style may include, be indicative of, or be determined based on a variety of factors and characteristics. For example, entity communication style may be indicative of certain types of behaviors, moods, sentiments, and the like. Entity communication style may inform what the “next best action” for a user might be. For example, if processor 104 determines user is angry because of a car accident, what the most effective next action processor 104 should take to mitigate the issue that user is experiencing. Processor 104 may determine statistical parameters such as average, median, mode, standard deviation, variance, and similar parameters, for any aspect of user datum or entity communication. For example, processor 104 may determine average, median, mode, standard deviation, variance, and similar parameters for: sentence length for an entity, sentence length for a representative population or entities, word length for an entity and/or representative population of entities, sentence length for an entity or representative population of entities, words used in a sentence by a user or representative population of entities, “Representative population,” as used herein, is defined as a plurality of objects, people, or entities sharing at least one predetermined similarity with a corresponding object, person, or entity. A “predetermined similarity,” as used herein, is defined as a value for a characteristic within a threshold amount from a reference characteristic. For example, a user may have 15 years of academic education. A representative population for user may include entities with 15±2 years of academic education. In an embodiment, processor 104 may correlate a frequency of one or more words or one or more word types to a particular mood, personality type, or class of behaviors. For example, processor 104 may determine a mood, personality type, or class of behaviors based on a frequency of profanity. For example, processor 104 may be configured by instructions contained on memory to determine that an average sentence length for a representative population corresponding to user may be 17.3 words, with a standard deviation of 2.2 words and an average of 0.1 instances of profanity per sentence. Processor 104 may compare data from single user view for user to the representative population and classify an entity's mood as negative based on an increased occurrence of profanity in a communication from user. For example, processor 104 may count the occurrences of one or more words labeled by instructions contained on memory as profanity and additionally count the number of sentences in the communication from user. Processor 104 may then divide the number of instances of profanity by the number of sentences to determine the instances of profanity per sentence. Processor 104 may then subtract the average instances of profanity per sentence for a representative population from instances of profanity per sentence in a communication from user. If the resulting difference is a positive number above a threshold, for example 0.5 instances of profanity per sentence or higher, processor 104 may classify user as having a negative mood. Processor 104 may similarly determine probabilities of user being in one or more classes of moods based on an entity communication style. For example, processor 104 may assign a probability that user is happy, angry, frustrated, impatient, relaxed, and the like, based on any of the above statistics including, but not limited to, statistics for word choice, particular word frequency, sentence length, number or statistical occurrence (e.g. mean, median, mode, standard deviation, and the like) of spelling errors in a sentence, in an entire communication, or an entire single user view, or any aspect of user datum, single user view, or the like.

With continued reference to FIG. 1, processor 104 may be configured by instructions contained on memory to determine a descriptor, mood, classification, and/or entity communication style for a user based on communication characteristics such as spelling, typos, mistakes, instances of deleting characters or words, time taken to write or communicate, time required for an entire interaction, pauses between words, sentences, and or responses, and the like. Processor 104 may receive input from a display device 132 such as keystrokes, keystroke timing, voice recordings, facial or other visual recordings, phonemes, syllables, and other spoken or written characteristics of communication, and the like. Processor 104 may determine any of the statistics listed above (e.g. mean, median, mode etc.) for keystrokes, keystroke timing, voice recordings, facial or other visual recordings, phonemes, syllables, and other spoken or written characteristics of communication, and the like to determine an entity communication style. For example, processor 104 may be configured by instructions contained on memory to determine that when more than 15% of keystrokes input by a user into a keyboard are the “Backspace” key, used to delete words or characters, the user may be confused or unsure. Processor 104 may determine a classifier weight or percent probability that a user should be classified to a particular mood category, user description, entity communication style, or the like based on any of the above statistical parameters. For example, processor 104 may determine a classifier weight or percent probability that a user should be classified as “angry” based on a mathematical difference between a total number of typographical errors in user profile 108 and an average number of typographical errors in one or more examples of communications from a representative population of entities. In an additional or alternative embodiment, processor 104 may determine and utilize statistical and/or comparative parameters (e.g. statistics, mathematical differences, sums of values, weights of values, probabilities, etc.) of any communication characteristics such as spelling, typos, mistakes, instances of deleting characters or words, time taken to write or communicate, time required for an entire interaction, pauses between words, sentences, and or responses, and the like. Processor 104 may additionally or alternatively determine entity communication style and/or other aspects of user profile 108 and/or single user view based on device metadata such as device type (e.g. smartphone, tablet, laptop computer, desktop computer, kiosk, etc.), software information (e.g. browser type, device operating system, email service, email address, phone carrier, phone number, screen name or social media handle, etc.), device identifier (e.g. IP address, MAC address, geofencing or geolocation data, device serial number, etc.), communication mode (e.g. written, spoken, email, text message, voice call, home digital assistant, social media platform, etc.), and the like. For example, processor 104 may increase a probability from 70% to 75% that a user is a safe driver based on device location data from a smartphone repeatedly showing the user driving at or below the speed limit on a route.

With continued reference to FIG. 1, processor 104 may adapt the natural language format by receiving training data correlating exemplary language elements with exemplary communication styles, training a machine learning model using the received training data, and generating one or more natural language outputs corresponding to the determined entity communication style by inputting, to the trained machine learning model, at least one of the first information and the single user view and receiving the one or more natural language outputs from the trained machine learning model. For example, one or more natural language outputs may include an action for a user that processor 104 determines is the next best action for the user to take based on the information communicated to processor 104 from a user, single user view, or any suitable source. For example, processor 104 may receive or generate communication style training data correlating language elements with communication styles in accordance with training data creation methods disclosed herein. Communication style training data may then be used to train a communication style machine learning model which receives one or more language element inputs and outputs a determined communication style that processor 104 may use to place a higher weight on pre-programmed responses, outputs an adjusted weighting for combinations of language elements that may be used by dynamic response machine learning model, or a similar output. Alternatively, communication style training data may be used in conjunction with dynamic response training data and used to train a single dynamically styled communication response machine learning model. The trained dynamically styled communication response machine learning model may then receive one or more of user profile 108, single user view, and/or elements of informational contents 152 from user profile database 300 as an input and output not only an appropriate natural language response to the input but determine an appropriate natural language response style for the output as well.

With continued reference to FIG. 1, is some embodiments, dynamic response machine learning model may be trained as a function of a communication style. As a non-limiting example, if a communication style is “casual,” dynamic response machine learning model may be trained only on training data that is labeled “casual.” As another non-limiting example, if a communication style is “professional,” dynamic response machine learning model may be trained only on training data that is labeled “professional.” In some embodiments, a dynamic response machine learning model may be selected as a function of a communication style. As a non-limiting example, if a communication style is “casual,” processor 104 may select a dynamic response machine learning model that is trained only on training data that is labeled “casual.” As a non-limiting example, if a communication style is “professional,” processor 104 may select a dynamic response machine learning model that is trained only on training data that is labeled “professional.”

With continued reference to FIG. 1, processor 104 may utilize one or more trained machine learning models in combination to interpret communications from user and initiate or perform a corresponding action related to one or more functions of an operator of digital assistant apparatus 100. For example, processor 104 may first input user communication from user profile 108 into language classification machine learning model to parse and identify what a particular communication is directed to, feed the output from language classification machine learning model into dynamic response machine learning model to determine an appropriate natural language response to an entity communication, and feed the output from dynamic response machine learning model into operator functionality machine learning data to determine what operation or process (such as onboarding a user, filing a claim, adding coverage, etc.) was indicated to user and should potentially be initiated by an operator of apparatus 100.

With continued reference to FIG. 1, in one embodiment, processor 104, machine learning module 200, and/or another computing device may utilize machine learning methods like Hidden Markov Models (HHM), Support-Vector Machine SVM etc. HMMs as used herein are statistical models with inference algorithms that that may be applied to the models. In such models, a hidden state to be estimated may include an association between an extracted word, phrases, and/or other semantic units. There may be a finite number of categories to which an extracted word may pertain; an HMM inference algorithm, such as the forward-backward algorithm or the Viterbi algorithm, may be used to estimate the most likely discrete state given a word or sequence of words. Language processing module may combine two or more approaches. For instance, and without limitation, machine-learning program may use a combination of Naive-Bayes (NB), Stochastic Gradient Descent (SGD), and parameter grid-searching classification techniques; the result may include a classification algorithm that returns ranked associations.

With continued reference to FIG. 1, processor 104, machine learning module 200, and/or another computing device may utilize Optical Character Recognition or Optical Character Reader (OCR), Optical Word Recognition (OWR), Handwritten Text Recognition (HTR), Intelligent Character Recognition (ICR), or Intelligent Word Recognition (IWR) configured to automatically convert images of written (e.g., typed, handwritten or printed text) into machine-encoded text. In some cases, OCR may recognize written text, one glyph or character at a time. In some cases, OWR may recognize written text, one word at a time, for example, for languages that use a space as a word divider. In some cases, ICR may recognize written text one glyph or character at a time, for instance by employing machine learning processes. In some cases, IWR may recognize written text, one word at a time, for instance by employing machine learning processes as disclosed herein. For example, processor 104 may receive an image file as part of user profile 108, user datum, single user view, informational contents 152, and/or user profile 108. The image file may be a scanned copy of a handwritten arrest report indicating that a user was arrested recently for theft. Processor 104 may use OCR to determine the contents of the handwritten arrest report. For example, processor 104 may use OCR to analyze the handwriting in the report and extract a user's name and a reason for an arrest. Processor 104 may then determine if an adjustment to an insurance policy should be made. For example, using OCR techniques as described herein, processor 104 may determine that a user was arrested for speeding. Processor 104 may be configured by instructions contained on memory to initiate a predetermined process of increasing a user's monthly car insurance premium based on the arrest record.

With continued reference to FIG. 1, handwriting recognition techniques can be broadly classified into two types: online methods and offline methods. Online methods involve the utilization of digital stylus and have access to stroke information and pen location while text is being written by the first user. Online methods provide real-time information with regards to the flow of text being written by the first user which can be classified at a high accuracy rate and the demarcation between different characters in the text becomes much clearer. In many cases, handwriting movement can be used as input to various handwriting recognitions. As such, instead of merely using shapes of glyphs and words, motions, such as the order in which segments are drawn, the direction, and the pattern of putting the pen down and lifting it are captured. Online methods are also referred to as online character recognition, dynamic character recognition, and real-time character recognition. However, not all users are available to accommodate the online methods. In contrast, offline methods are more common as they involve recognizing text once it is written down. In one embodiment, the handwriting recognition techniques may be “offline” processes, which analyze a static document or image frame.

With continued reference to FIG. 1, in some cases, OCR processes may employ pre-processing of an image component. Pre-processing process may include without limitation de-skew, de-speckle, binarization, line removal, layout analysis or “zoning,” line and word detection, script recognition, character isolation or “segmentation,” and normalization. In some cases, a de-skew process may include applying a transform (e.g., homography or affine transform) to image component to align text. In some cases, a de-speckle process may include removing positive and negative spots and/or smoothing edges. In some cases, a binarization process may include converting an image from color or greyscale to black-and-white (i.e., a binary image). Binarization may be performed as a simple way of separating text (or any other desired image component) from a background of image component. In some cases, binarization may be required for example if an employed OCR algorithm only works on binary images. In some cases. a line removal process may include removal of non-glyph or non-character imagery (e.g., boxes and lines). In some cases, a layout analysis or “zoning” process may identify columns, paragraphs, captions, and the like as distinct blocks. In some cases, a line and word detection process may establish a baseline for word and character shapes and separate words, if necessary. In some cases, a script recognition process may, for example in multilingual documents, identify script allowing an appropriate OCR algorithm to be selected. In some cases, a character isolation or “segmentation” process may separate signal characters, for example character-based OCR algorithms. In some cases, a normalization process may normalize aspect ratio and/or scale of image component.

With continued reference to FIG. 1, in some embodiments an OCR process will include an OCR algorithm. Exemplary OCR algorithms include matrix matching process and/or feature extraction processes. Matrix matching may involve comparing an image to a stored glyph on a pixel-by-pixel basis. In some case, matrix matching may also be known as “pattern matching,” “pattern recognition,” and/or “image correlation.” Matrix matching may rely on an input glyph being correctly isolated from the rest of the image component. Matrix matching may also rely on a stored glyph being in a similar font and at a same scale as input glyph. Matrix matching may work best with typewritten text.

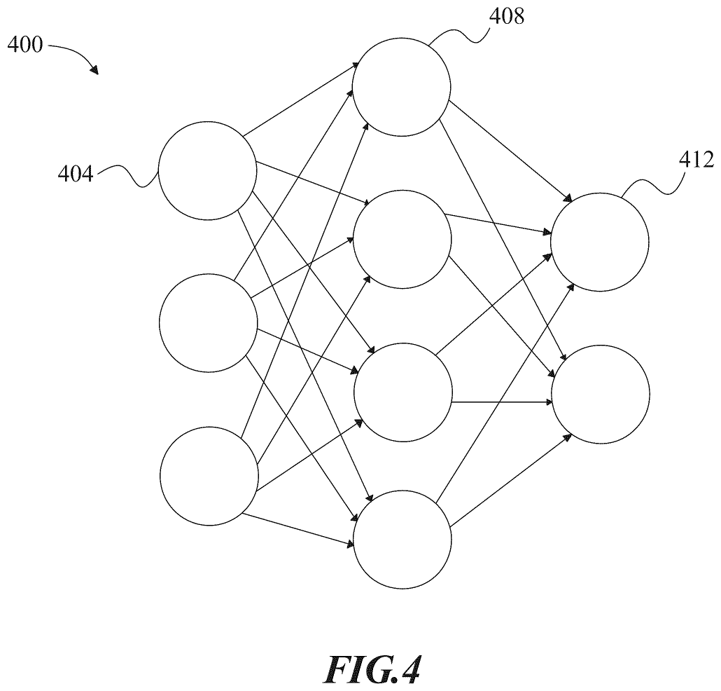

With continued reference to FIG. 1, in some embodiments, an OCR process may include a feature extraction process. In some cases, feature extraction may decompose a glyph into features. Exemplary non-limiting features may include corners, edges, lines, closed loops, line direction, line intersections, and the like. In some cases, feature extraction may reduce dimensionality of representation and may make the recognition process computationally more efficient. In some cases, extracted feature can be compared with an abstract vector-like representation of a character, which might reduce to one or more glyph prototypes. General techniques of feature detection in computer vision are applicable to this type of OCR. In some embodiments, machine-learning process like nearest neighbor classifiers (e.g., k-nearest neighbors algorithm) can be used to compare image features with stored glyph features and choose a nearest match. OCR may employ any machine-learning process described in this disclosure, for example machine-learning processes described with reference to FIG. 4. Exemplary non-limiting OCR software includes Cuneiform and Tesseract. Cuneiform is a multi-language, open-source optical character recognition system originally developed by Cognitive Technologies of Moscow, Russia. Tesseract is free OCR software originally developed by Hewlett-Packard of Palo Alto, California, United States.

With continued reference to FIG. 1, in some cases, OCR may employ a two-pass approach to character recognition. Second pass may include adaptive recognition and use letter shapes recognized with high confidence on a first pass to recognize better remaining letters on the second pass. In some cases, two-pass approach may be advantageous for unusual fonts or low-quality image components where visual verbal content may be distorted. Another exemplary OCR software tool include OCRopus. OCRopus development is led by German Research Centre for Artificial Intelligence in Kaiserslautern, Germany. In some cases, OCR software may employ neural networks, for example neural networks as taught in reference to FIGS. 4-6.

With continued reference to FIG. 1, in some cases, OCR may include post-processing. For example, OCR accuracy can be increased, in some cases, if output is constrained by a lexicon. A lexicon may include a list or set of words that are allowed to occur in a document. In some cases, a lexicon may include, for instance, all the words in the English language, or a more technical lexicon for a specific field. In some cases, an output stream may be a plain text stream or file of characters. In some cases, an OCR process may preserve an original layout of visual verbal content. In some cases, near-neighbor analysis can make use of co-occurrence frequencies to correct errors, by noting that certain words are often seen together. For example, “Washington, D.C.” is generally far more common representation of Washington, District of Columbia in English than “Washington DOC.” In some cases, an OCR process may make us of a priori knowledge of grammar for a language being recognized. For example, grammar rules may be used to help determine if a word is likely to be a verb or a noun. Distance conceptualization may be employed for recognition and classification. For example, a Levenshtein distance algorithm may be used in OCR post-processing to further optimize results.

With continued reference to FIG. 1, processor 104 may be further configured to determine an indemnity outlay based on the user datum. As used herein, “indemnity outlay” is defined as a currency value related to insurance. For example, processor 104 may determine that user profile 108 includes user datum indicating that a user's vehicle was totaled in an accident and will be written off as a total loss. Processor 104 may use this information to retrieve data related to a user's insured vehicle including value of the vehicle. Processor 104 may then determine an indemnity outlay to be paid out to a user corresponding to the value of the insured vehicle. An indemnity outlay may be a currency value corresponding to a claim amount, a deductible, a monthly insurance rate, a lawsuit settlement, and the like.

With continued reference to FIG. 1, the informational contents of user profile database 300 may contain an indemnity datum for the user. Processor 104 may be configured to identify a negative impact on the indemnity datum from the user profile 108. “Indemnity datum” as used herein is defined as one or more elements of information related to insurance or indemnity coverage for a user. “Negative impact,” as used herein, is defined as indicating lower favorability for a user. Examples of an indemnity datum include a credit score, a value indicating a user's trustworthiness (e.g. a rating, score, rank, weight, scale, value between a defined range, and the like), a bank account balance, and the like. For example, an indemnity datum may indicate an estimated percentage that a user will not file a claim within the next year, a ranking from 0-100 of a user based on consistency of monthly payments, and the like. A negative impact on the indemnity datum from the user profile 108 may include a risk that a user might default on an insurance payment (e.g. a credit bureau report that a user's credit score decreased by 50 points, a bank statement showing a negative checking account balance, information from a former employer indicating the user lost their job), a risk that a user may file a fraudulent claim (e.g. a social media post from the user stating “I am going to file a fraudulent insurance claim,” a legal record received from a municipal court indicating a prior arrest for insurance fraud, and the like), evidence of unethical conduct (e.g. an email mistakenly forwarded to an insurance company where the user meant to ask a friend how to stage a fire to receive a home insurance payment, and the like), and the like. For example, indemnity datum may contain information regarding a user's vehicle insurance coverage policy such as a 4% probability of a user causing the firm to need to pay out a settlement of $50,000 or more. Memory may contain instructions configuring processor 104 to determine that a record of an arrest for felony speeding corresponds to a 275% increase in the probability (e.g., from 4% to 15%) that an insurance firm will be required to pay out a settlement of $50,000 or more. This may cause processor 104 to determine that insurance coverage for a user should be terminated.

Referring now to FIG. 2, an exemplary embodiment of a machine-learning module 200 that may perform one or more machine-learning processes as described in this disclosure is illustrated. Machine-learning module may perform determinations, classification, and/or analysis steps, methods, processes, or the like as described in this disclosure using machine learning processes. A “machine learning process,” as used in this disclosure, is a process that automatedly uses training data 204 to generate an algorithm that will be performed by a computing device/module to produce outputs 208 given data provided as inputs 212; this is in contrast to a non-machine learning software program where the commands to be executed are determined in advance by a user and written in a programming language.

Still referring to FIG. 2, “training data,” as used herein, is data containing correlations that a machine-learning process may use to model relationships between two or more categories of data elements. For instance, and without limitation, training data 204 may include a plurality of data entries, each entry representing a set of data elements that were recorded, received, and/or generated together; data elements may be correlated by shared existence in a given data entry, by proximity in a given data entry, or the like. Multiple data entries in training data 204 may evince one or more trends in correlations between categories of data elements; for instance, and without limitation, a higher value of a first data element belonging to a first category of data element may tend to correlate to a higher value of a second data element belonging to a second category of data element, indicating a possible proportional or other mathematical relationship linking values belonging to the two categories. Multiple categories of data elements may be related in training data 204 according to various correlations; correlations may indicate causative and/or predictive links between categories of data elements, which may be modeled as relationships such as mathematical relationships by machine-learning processes as described in further detail below. Training data 204 may be formatted and/or organized by categories of data elements, for instance by associating data elements with one or more descriptors corresponding to categories of data elements. As a non-limiting example, training data 204 may include data entered in standardized forms by persons or processes, such that entry of a given data element in a given field in a form may be mapped to one or more descriptors of categories. Elements in training data 204 may be linked to descriptors of categories by tags, tokens, or other data elements; for instance, and without limitation, training data 204 may be provided in fixed-length formats, formats linking positions of data to categories such as comma-separated value (CSV) formats and/or self-describing formats such as extensible markup language (XML), JavaScript Object Notation (JSON), or the like, enabling processes or devices to detect categories of data.

Alternatively or additionally, and continuing to refer to FIG. 2, training data 204 may include one or more elements that are not categorized; that is, training data 204 may not be formatted or contain descriptors for some elements of data. Machine-learning algorithms and/or other processes may sort training data 204 according to one or more categorizations using, for instance, natural language processing algorithms, tokenization, detection of correlated values in raw data and the like; categories may be generated using correlation and/or other processing algorithms. As a non-limiting example, in a corpus of text, phrases making up a number “n” of compound words, such as nouns modified by other nouns, may be identified according to a statistically significant prevalence of n-grams containing such words in a particular order; such an n-gram may be categorized as an element of language such as a “word” to be tracked similarly to single words, generating a new category as a result of statistical analysis. Similarly, in a data entry including some textual data, a person's name may be identified by reference to a list, dictionary, or other compendium of terms, permitting ad-hoc categorization by machine-learning algorithms, and/or automated association of data in the data entry with descriptors or into a given format. The ability to categorize data entries automatedly may enable the same training data 204 to be made applicable for two or more distinct machine-learning algorithms as described in further detail below. Training data 204 used by machine-learning module 200 may correlate any input data as described in this disclosure to any output data as described in this disclosure.

Further referring to FIG. 2, training data may be filtered, sorted, and/or selected using one or more supervised and/or unsupervised machine-learning processes and/or models as described in further detail below; such models may include without limitation a training data classifier 216. Training data classifier 216 may include a “classifier,” which as used in this disclosure is a machine-learning model as defined below, such as a mathematical model, neural net, or program generated by a machine learning algorithm known as a “classification algorithm,” as described in further detail below, that sorts inputs into categories or bins of data, outputting the categories or bins of data and/or labels associated therewith. A classifier may be configured to output at least a datum that labels or otherwise identifies a set of data that are clustered together, found to be close under a distance metric as described below, or the like. Machine-learning module 200 may generate a classifier using a classification algorithm, defined as a processes whereby a computing device and/or any module and/or component operating thereon derives a classifier from training data 204. Classification may be performed using, without limitation, linear classifiers such as without limitation logistic regression and/or naive Bayes classifiers, nearest neighbor classifiers such as k-nearest neighbors classifiers, support vector machines, least squares support vector machines, fisher's linear discriminant, quadratic classifiers, decision trees, boosted trees, random forest classifiers, learning vector quantization, and/or neural network-based classifiers.

Still referring to FIG. 2, machine-learning module 200 may be configured to perform a lazy-learning process 220 and/or protocol, which may alternatively be referred to as a “lazy loading” or “call-when-needed” process and/or protocol, may be a process whereby machine learning is conducted upon receipt of an input to be converted to an output, by combining the input and training set to derive the algorithm to be used to produce the output on demand. For instance, an initial set of simulations may be performed to cover an initial heuristic and/or “first guess” at an output and/or relationship. As a non-limiting example, an initial heuristic may include a ranking of associations between inputs and elements of training data 204. Heuristic may include selecting some number of highest-ranking associations and/or training data 204 elements. Lazy learning may implement any suitable lazy learning algorithm, including without limitation a K-nearest neighbors algorithm, a lazy naïve Bayes algorithm, or the like; persons skilled in the art, upon reviewing the entirety of this disclosure, will be aware of various lazy-learning algorithms that may be applied to generate outputs as described in this disclosure, including without limitation lazy learning applications of machine-learning algorithms as described in further detail below.

Alternatively or additionally, and with continued reference to FIG. 2, machine-learning processes as described in this disclosure may be used to generate machine-learning models 224. A “machine-learning model,” as used in this disclosure, is a mathematical and/or algorithmic representation of a relationship between inputs and outputs, as generated using any machine-learning process including without limitation any process as described above, and stored in memory; an input is submitted to a machine-learning model 224 once created, which generates an output based on the relationship that was derived. For instance, and without limitation, a linear regression model, generated using a linear regression algorithm, may compute a linear combination of input data using coefficients derived during machine-learning processes to calculate an output datum. As a further non-limiting example, a machine-learning model 224 may be generated by creating an artificial neural network, such as a convolutional neural network comprising an input layer of nodes, one or more intermediate layers, and an output layer of nodes. Connections between nodes may be created via the process of “training” the network, in which elements from a training data 204 set are applied to the input nodes, a suitable training algorithm (such as Levenberg-Marquardt, conjugate gradient, simulated annealing, or other algorithms) is then used to adjust the connections and weights between nodes in adjacent layers of the neural network to produce the desired values at the output nodes. This process is sometimes referred to as deep learning.

Still referring to FIG. 2, machine-learning algorithms may include at least a supervised machine-learning process 228. At least a supervised machine-learning process 228, as defined herein, include algorithms that receive a training set relating a number of inputs to a number of outputs, and seek to find one or more mathematical relations relating inputs to outputs, where each of the one or more mathematical relations is optimal according to some criterion specified to the algorithm using some scoring function. For instance, a supervised learning algorithm may include inputs and outputs as described above in this disclosure, and a scoring function representing a desired form of relationship to be detected between inputs and outputs; scoring function may, for instance, seek to maximize the probability that a given input and/or combination of elements inputs is associated with a given output to minimize the probability that a given input is not associated with a given output. Scoring function may be expressed as a risk function representing an “expected loss” of an algorithm relating inputs to outputs, where loss is computed as an error function representing a degree to which a prediction generated by the relation is incorrect when compared to a given input-output pair provided in training data 204. Persons skilled in the art, upon reviewing the entirety of this disclosure, will be aware of various possible variations of at least a supervised machine-learning process 228 that may be used to determine relation between inputs and outputs. Supervised machine-learning processes may include classification algorithms as defined above.

Further referring to FIG. 2, machine learning processes may include at least an unsupervised machine-learning processes 232. An unsupervised machine-learning process, as used herein, is a process that derives inferences in datasets without regard to labels; as a result, an unsupervised machine-learning process may be free to discover any structure, relationship, and/or correlation provided in the data. Unsupervised processes may not require a response variable; unsupervised processes may be used to find interesting patterns and/or inferences between variables, to determine a degree of correlation between two or more variables, or the like.

Still referring to FIG. 2, machine-learning module 200 may be designed and configured to create a machine-learning model 224 using techniques for development of linear regression models. Linear regression models may include ordinary least squares regression, which aims to minimize the square of the difference between predicted outcomes and actual outcomes according to an appropriate norm for measuring such a difference (e.g. a vector-space distance norm); coefficients of the resulting linear equation may be modified to improve minimization. Linear regression models may include ridge regression methods, where the function to be minimized includes the least-squares function plus term multiplying the square of each coefficient by a scalar amount to penalize large coefficients. Linear regression models may include least absolute shrinkage and selection operator (LASSO) models, in which ridge regression is combined with multiplying the least-squares term by a factor of 1 divided by double the number of samples. Linear regression models may include a multi-task lasso model wherein the norm applied in the least-squares term of the lasso model is the Frobenius norm amounting to the square root of the sum of squares of all terms. Linear regression models may include the elastic net model, a multi-task elastic net model, a least angle regression model, a LARS lasso model, an orthogonal matching pursuit model, a Bayesian regression model, a logistic regression model, a stochastic gradient descent model, a perceptron model, a passive aggressive algorithm, a robustness regression model, a Huber regression model, or any other suitable model that may occur to persons skilled in the art upon reviewing the entirety of this disclosure. Linear regression models may be generalized in an embodiment to polynomial regression models, whereby a polynomial equation (e.g. a quadratic, cubic or higher-order equation) providing a best predicted output/actual output fit is sought; similar methods to those described above may be applied to minimize error functions, as will be apparent to persons skilled in the art upon reviewing the entirety of this disclosure.

Continuing to refer to FIG. 2, machine-learning algorithms may include, without limitation, linear discriminant analysis. Machine-learning algorithm may include quadratic discriminate analysis. Machine-learning algorithms may include kernel ridge regression. Machine-learning algorithms may include support vector machines, including without limitation support vector classification-based regression processes. Machine-learning algorithms may include stochastic gradient descent algorithms, including classification and regression algorithms based on stochastic gradient descent. Machine-learning algorithms may include nearest neighbors algorithms. Machine-learning algorithms may include various forms of latent space regularization such as variational regularization. Machine-learning algorithms may include Gaussian processes such as Gaussian Process Regression. Machine-learning algorithms may include cross-decomposition algorithms, including partial least squares and/or canonical correlation analysis. Machine-learning algorithms may include naïve Bayes methods. Machine-learning algorithms may include algorithms based on decision trees, such as decision tree classification or regression algorithms. Machine-learning algorithms may include ensemble methods such as bagging meta-estimator, forest of randomized tress, AdaBoost, gradient tree boosting, and/or voting classifier methods. Machine-learning algorithms may include neural net algorithms, including convolutional neural net processes.

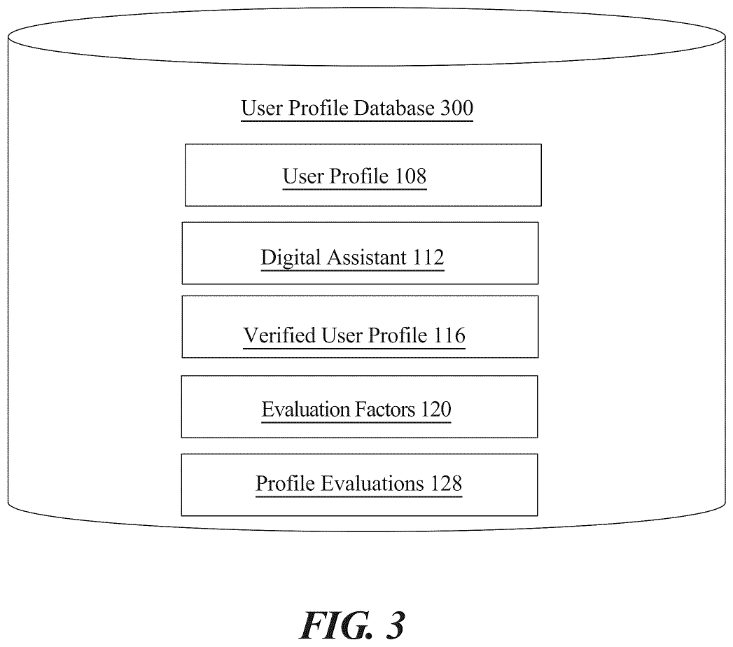

Now referring to FIG. 3, an exemplary user profile database 300 is illustrated by way of block diagram. In an embodiment, any past or present versions of data disclosed herein may be stored within user profile 108, vehicle profile, verified user profile 116, evaluation factors 120, profile evaluations 128, and the like. Processor 104 may be communicatively connected with user profile database 300. For example, in some cases, database 300 may be local to processor 104. Alternatively or additionally, in some cases, database 300 may be remote to processor 104 and communicative with processor 104 by way of one or more networks. Network may include, but not limited to, a cloud network, a mesh network, or the like. By way of example, a “cloud-based” system, as that term is used herein, can refer to a system which includes software and/or data which is stored, managed, and/or processed on a network of remote servers hosted in the “cloud,” e.g., via the Internet, rather than on local severs or personal computers. A “mesh network” as used in this disclosure is a local network topology in which the infrastructure processor 104 connect directly, dynamically, and non-hierarchically to as many other computing devices as possible. A “network topology” as used in this disclosure is an arrangement of elements of a communication network. User profile database 300 may be implemented, without limitation, as a relational database, a key-value retrieval database such as a NOSQL database, or any other format or structure for use as a database that a person skilled in the art would recognize as suitable upon review of the entirety of this disclosure. User profile database 300 may alternatively or additionally be implemented using a distributed data storage protocol and/or data structure, such as a distributed hash table or the like. User profile database 300 may include a plurality of data entries and/or records as described above. Data entries in a database may be flagged with or linked to one or more additional elements of information, which may be reflected in data entry cells and/or in linked tables such as tables related by one or more indices in a relational database. Persons skilled in the art, upon reviewing the entirety of this disclosure, will be aware of various ways in which data entries in a database may store, retrieve, organize, and/or reflect data and/or records as used herein, as well as categories and/or populations of data consistently with this disclosure.

Referring now to FIG. 4, an exemplary embodiment of neural network 400 is illustrated. A neural network 400 also known as an artificial neural network, is a network of “nodes,” or data structures having one or more inputs, one or more outputs, and a function determining outputs based on inputs. Such nodes may be organized in a network, such as without limitation a convolutional neural network, including an input layer of nodes 404, one or more intermediate layers 408, and an output layer of nodes 412. Connections between nodes may be created via the process of “training” the network, in which elements from a training dataset are applied to the input nodes, a suitable training algorithm (such as Levenberg-Marquardt, conjugate gradient, simulated annealing, or other algorithms) is then used to adjust the connections and weights between nodes in adjacent layers of the neural network to produce the desired values at the output nodes. This process is sometimes referred to as deep learning. Connections may run solely from input nodes toward output nodes in a “feed-forward” network or may feed outputs of one layer back to inputs of the same or a different layer in a “recurrent network.” As a further non-limiting example, a neural network may include a convolutional neural network comprising an input layer of nodes, one or more intermediate layers, and an output layer of nodes. A “convolutional neural network,” as used in this disclosure, is a neural network in which at least one hidden layer is a convolutional layer that convolves inputs to that layer with a subset of inputs known as a “kernel,” along with one or more additional layers such as pooling layers, fully connected layers, and the like.

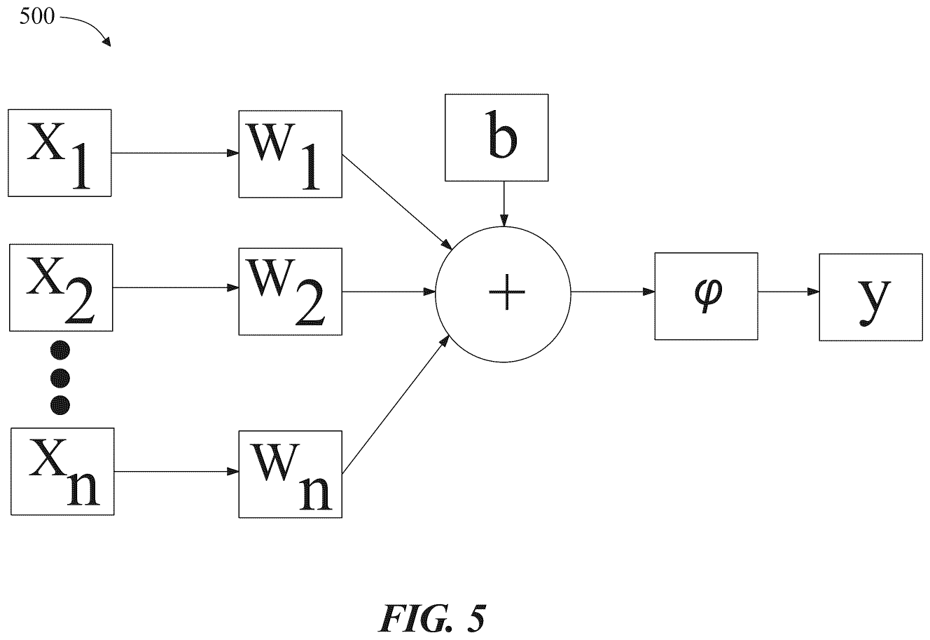

Referring now to FIG. 5, an exemplary embodiment of a node of a neural network is illustrated. A node may include, without limitation, a plurality of inputs xᵢ that may receive numerical values from inputs to a neural network containing the node and/or from other nodes. Node may perform a weighted sum of inputs using weights w′ that are multiplied by respective inputs xᵢ. Additionally or alternatively, a bias b may be added to the weighted sum of the inputs such that an offset is added to each unit in the neural network layer that is independent of the input to the layer. The weighted sum may then be input into a function φ, which may generate one or more outputs y. Weight wᵢ applied to an input xᵢ may indicate whether the input is “excitatory,” indicating that it has strong influence on the one or more outputs y, for instance by the corresponding weight having a large numerical value, and/or a “inhibitory,” indicating it has a weak effect influence on the one more inputs y, for instance by the corresponding weight having a small numerical value. The values of weights wᵢ may be determined by training a neural network using training data, which may be performed using any suitable process as described above.

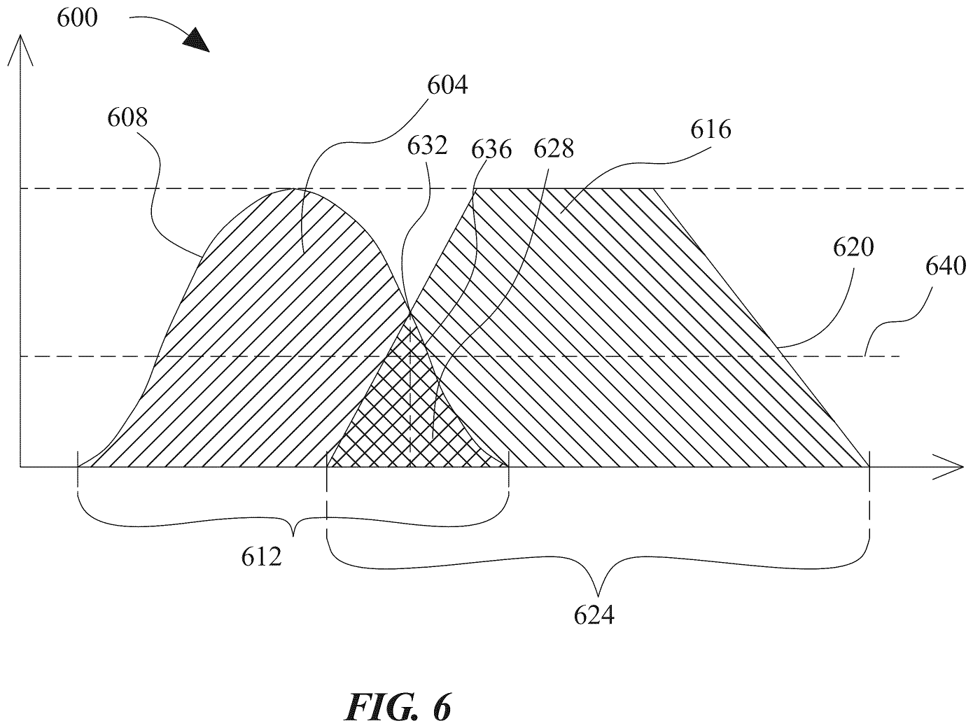

Now referring to FIG. 6, an exemplary embodiment of fuzzy set comparison 600 is illustrated. In a non-limiting embodiment, the fuzzy set comparison. In a non-limiting embodiment, fuzzy set comparison 600 may be consistent with fuzzy set comparison in FIG. 1. In another non-limiting the fuzzy set comparison 600 may be consistent with the name/version matching as described herein. For example and without limitation, the parameters, weights, and/or coefficients of the membership functions may be tuned using any machine-learning methods for the name/version matching as described herein. In another non-limiting embodiment, the fuzzy set may represent verified user profile 116 and an example of an evaluation factor 120 from FIG. 1.

Alternatively or additionally, and still referring to FIG. 6, fuzzy set comparison 600 may be generated as a function of determining data compatibility threshold. The compatibility threshold may be determined by a computing device. In some embodiments, a computing device may use a logic comparison program, such as, but not limited to, a fuzzy logic model to determine the compatibility threshold and/or version authenticator. Each such compatibility threshold may be represented as a value for a posting variable representing the compatibility threshold, or in other words a fuzzy set as described above that corresponds to a degree of compatibility and/or allowability as calculated using any statistical, machine-learning, or other method that may occur to a person skilled in the art upon reviewing the entirety of this disclosure. In some embodiments, determining the compatibility threshold and/or version authenticator may include using a linear regression model. A linear regression model may include a machine learning model. A linear regression model may map statistics such as, but not limited to, frequency of the same range of version numbers, and the like, to the compatibility threshold and/or version authenticator. In some embodiments, determining the compatibility threshold of any posting may include using a classification model. A classification model may be configured to input collected data and cluster data to a centroid based on, but not limited to, frequency of appearance of the range of versioning numbers, linguistic indicators of compatibility and/or allowability, and the like. Centroids may include scores assigned to them such that the compatibility threshold may each be assigned a score. In some embodiments, a classification model may include a K-means clustering model. In some embodiments, a classification model may include a particle swarm optimization model. In some embodiments, determining a compatibility threshold may include using a fuzzy inference engine. A fuzzy inference engine may be configured to map one or more compatibility threshold using fuzzy logic. In some embodiments, a plurality of computing devices may be arranged by a logic comparison program into compatibility arrangements. A “compatibility arrangement” as used in this disclosure is any grouping of objects and/or data based on skill level and/or output score. Membership function coefficients and/or constants as described above may be tuned according to classification and/or clustering algorithms. For instance, and without limitation, a clustering algorithm may determine a Gaussian or other distribution of questions about a centroid corresponding to a given compatibility threshold and/or version authenticator, and an iterative or other method may be used to find a membership function, for any membership function type as described above, that minimizes an average error from the statistically determined distribution, such that, for instance, a triangular or Gaussian membership function about a centroid representing a center of the distribution that most closely matches the distribution. Error functions to be minimized, and/or methods of minimization, may be performed without limitation according to any error function and/or error function minimization process and/or method as described in this disclosure.

Still referring to FIG. 6, inference engine may be implemented according to input verified user profile 116 and an example of an evaluation factor 120. For instance, an acceptance variable may represent a first measurable value pertaining to the classification of a verified user profile 116 to an example of an evaluation factor 120. Continuing the example, an output variable may represent an evaluation factor 120 tailored to the user profile 108. In an embodiment, verified user profile 116 and/or an example of an evaluation factor 120 may be represented by their own fuzzy set. In other embodiments, an evaluation factor may be represented as a function of the intersection two fuzzy sets as shown in FIG. 6, An inference engine may combine rules, such as any semantic versioning, semantic language, version ranges, and the like thereof. The degree to which a given input function membership matches a given rule may be determined by a triangular norm or “T-norm” of the rule or output function with the input function, such as min (a, b), product of a and b, drastic product of a and b, Hamacher product of a and b, or the like, satisfying the rules of commutativity (T(a, b)=T(b, a)), monotonicity: (T(a, b)≤T(c, d) if a≤c and b≤d), (associativity: T(a, T(b, c))=T(T(a, b), c)), and the requirement that the number 1 acts as an identity element. Combinations of rules (“and” or “or” combination of rule membership determinations) may be performed using any T-conorm, as represented by an inverted T symbol or “⊥,” such as max (a, b), probabilistic sum of a and b (a+b−a*b), bounded sum, and/or drastic T-conorm; any T-conorm may be used that satisfies the properties of commutativity: ⊥(a, b)=⊥(b, a), monotonicity: ⊥(a, b)≤⊥(c, d) if a≤c and b≤d, associativity: ⊥(a, ⊥(b, c))=⊥(⊥(a, b), c), and identity element of 0. Alternatively or additionally T-conorm may be approximated by sum, as in a “product-sum” inference engine in which T-norm is product and T-conorm is sum. A final output score or other fuzzy inference output may be determined from an output membership function as described above using any suitable defuzzification process, including without limitation Mean of Max defuzzification, Centroid of Area/Center of Gravity defuzzification, Center Average defuzzification, Bisector of Area defuzzification, or the like. Alternatively or additionally, output rules may be replaced with functions according to the Takagi-Sugeno-King (TSK) fuzzy model.

A first fuzzy set 604 may be represented, without limitation, according to a first membership function 608 representing a probability that an input falling on a first range of values 612 is a member of the first fuzzy set 604, where the first membership function 608 has values on a range of probabilities such as without limitation the interval [0,1], and an area beneath the first membership function 608 may represent a set of values within first fuzzy set 604. Although first range of values 612 is illustrated for clarity in this exemplary depiction as a range on a single number line or axis, first range of values 612 may be defined on two or more dimensions, representing, for instance, a Cartesian product between a plurality of ranges, curves, axes, spaces, dimensions, or the like. First membership function 608 may include any suitable function mapping first range 612 to a probability interval, including without limitation a triangular function defined by two linear elements such as line segments or planes that intersect at or below the top of the probability interval. As a non-limiting example, triangular membership function may be defined as:

$$( x , a , b , c ) = \{ 0 , for x > c and x < a \frac{x - a}{b - a} , for a \leq x < b \frac{c - x}{c - b} , if b < x \leq c$$

a trapezoidal membership function may be defined as:

$$y ( x , a , b , c , d ) = max ( min ( \frac{x - a}{b - a} , 1 , \frac{d - x}{d - c} ) , 0 )$$

a sigmoidal function may be defined as:

$$y ( x , a , c ) = \frac{1}{1 - {e}^{- a ( x - c )}}$$

a Gaussian membership function may be defined as:

$$y ( x , c , σ ) = {e}^{- \frac{1}{2} {( \frac{x - c}{σ} )}^{2}}$$

and a bell membership function may be defined as:

$$y ( x , a , b , c , ) = {[ 1 + {\vert \frac{x - c}{a} \vert}^{2 b} ]}^{- 1}$$

Persons skilled in the art, upon reviewing the entirety of this disclosure, will be aware of various alternative or additional membership functions that may be used consistently with this disclosure.

First fuzzy set 604 may represent any value or combination of values as described above, including any verified user profile 116 and an example of an evaluation factor 120. A second fuzzy set 616, which may represent any value which may be represented by first fuzzy set 604, may be defined by a second membership function 620 on a second range 624; second range 624 may be identical and/or overlap with first range 612 and/or may be combined with first range via Cartesian product or the like to generate a mapping permitting evaluation overlap of first fuzzy set 604 and second fuzzy set 616. Where first fuzzy set 604 and second fuzzy set 616 have a region 636 that overlaps, first membership function 608 and second membership function 620 may intersect at a point 632 representing a probability, as defined on probability interval, of a match between first fuzzy set 604 and second fuzzy set 616. Alternatively or additionally, a single value of first and/or second fuzzy set may be located at a locus 636 on first range 612 and/or second range 624, where a probability of membership may be taken by evaluation of first membership function 608 and/or second membership function 620 at that range point. A probability at 628 and/or 632 may be compared to a threshold 640 to determine whether a positive match is indicated. Threshold 640 may, in a non-limiting example, represent a degree of match between first fuzzy set 604 and second fuzzy set 616, and/or single values therein with each other or with either set, which is sufficient for purposes of the matching process; for instance, an evaluation factor 120 may indicate a sufficient degree of overlap with fuzzy set representing verified user profile 116 and an example of an evaluation factor 120 for combination to occur as described above. Each threshold may be established by one or more user inputs. Alternatively or additionally, each threshold may be tuned by a machine-learning and/or statistical process, for instance and without limitation as described in further detail below.

In an embodiment, a degree of match between fuzzy sets may be used to rank one resource against another. For instance, if both verified user profile 116 and an example of an evaluation factor 120 have fuzzy sets, an evaluation factor 120 may be generated by having a degree of overlap exceeding a predictive threshold, processor 104 may further rank the two resources by ranking a resource having a higher degree of match more highly than a resource having a lower degree of match. Where multiple fuzzy matches are performed, degrees of match for each respective fuzzy set may be computed and aggregated through, for instance, addition, averaging, or the like, to determine an overall degree of match, which may be used to rank resources; selection between two or more matching resources may be performed by selection of a highest-ranking resource, and/or multiple notifications may be presented to a user in order of ranking.

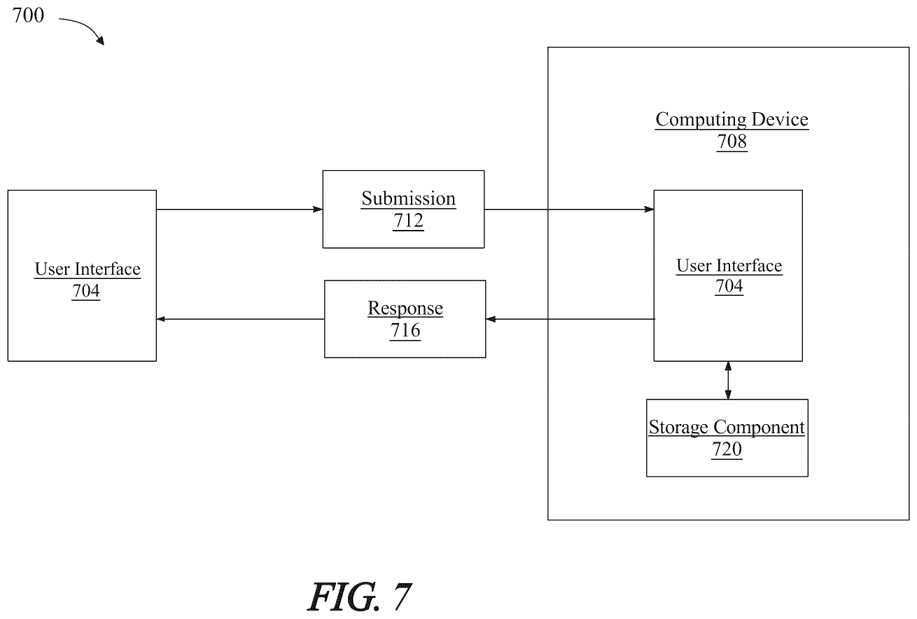

Referring to FIG. 7, a chatbot system 700 is schematically illustrated. According to some embodiments, a user interface 704 may be communicative with a computing device 708 that is configured to operate a chatbot. In some cases, user interface 704 may be local to computing device 708. Alternatively or additionally, in some cases, user interface 704 may remote to computing device 708 and communicative with the computing device 708, by way of one or more networks, such as without limitation the internet. Alternatively or additionally, user interface 704 may communicate with user device 708 using telephonic devices and networks, such as without limitation fax machines, short message service (SMS), or multimedia message service (MMS). Commonly, user interface 704 communicates with computing device 708 using text-based communication, for example without limitation using a character encoding protocol, such as American Standard for Information Interchange (ASCII). Typically, a user interface 704 conversationally interfaces a chatbot, by way of at least a submission 712, from the user interface 708 to the chatbot, and a response 716, from the chatbot to the user interface 704. In many cases, one or both of submission 712 and response 716 are text-based communication. Alternatively or additionally, in some cases, one or both of submission 712 and response 716 are audio-based communication.

Continuing in reference to FIG. 7, a submission 712 once received by computing device 708 operating a chatbot, may be processed by a processor. In some embodiments, processor processes a submission 7112 using one or more of keyword recognition, pattern matching, and natural language processing. In some embodiments, processor employs real-time learning with evolutionary algorithms. In some cases, processor may retrieve a pre-prepared response from at least a storage component 720, based upon submission 712. Alternatively or additionally, in some embodiments, processor communicates a response 716 without first receiving a submission 712, thereby initiating conversation. In some cases, processor communicates an inquiry to user interface 704; and the processor is configured to process an answer to the inquiry in a following submission 712 from the user interface 704. In some cases, an answer to an inquiry present within a submission 712 from a user device 704 may be used by computing device 708 as an input to another function.

With continued reference to FIG. 7, A chatbot may be configured to provide a user with a plurality of options as an input into the chatbot. Chatbot entries may include multiple choice, short answer response, true or false responses, and the like. A user may decide on what type of chatbot entries are appropriate. In some embodiments, the chatbot may be configured to allow the user to input a freeform response into the chatbot. The chatbot may then use a decision tree, data base, or other data structure to respond to the users entry into the chatbot as a function of a chatbot input. As used in the current disclosure, “Chatbot input” is any response that a candidate or employer inputs in to a chatbot as a response to a prompt or question.

With continuing reference to FIG. 7, computing device 708 may be configured to the respond to a chatbot input using a decision tree. A “decision tree,” as used in this disclosure, is a data structure that represents and combines one or more determinations or other computations based on and/or concerning data provided thereto, as well as earlier such determinations or calculations, as nodes of a tree data structure where inputs of some nodes are connected to outputs of others. Decision tree may have at least a root node, or node that receives data input to the decision tree, corresponding to at least a candidate input into a chatbot. Decision tree has at least a terminal node, which may alternatively or additionally be referred to herein as a “leaf node,” corresponding to at least an exit indication; in other words, decision and/or determinations produced by decision tree may be output at the at least a terminal node. Decision tree may include one or more internal nodes, defined as nodes connecting outputs of root nodes to inputs of terminal nodes. Computing device 708 may generate two or more decision trees, which may overlap; for instance, a root node of one tree may connect to and/or receive output from one or more terminal nodes of another tree, intermediate nodes of one tree may be shared with another tree, or the like.

Still referring to FIG. 7, computing device 708 may build decision tree by following relational identification; for example, relational indication may specify that a first rule module receives an input from at least a second rule module and generates an output to at least a third rule module, and so forth, which may indicate to computing device 708 an in which such rule modules will be placed in decision tree. Building decision tree may include recursively performing mapping of execution results output by one tree and/or subtree to root nodes of another tree and/or subtree, for instance by using such execution results as execution parameters of a subtree. In this manner, computing device 708 may generate connections and/or combinations of one or more trees to one another to define overlaps and/or combinations into larger trees and/or combinations thereof. Such connections and/or combinations may be displayed by visual interface to user, for instance in a single user view, to enable viewing, editing, selection, and/or deletion by user; connections and/or combinations generated thereby may be highlighted, for instance using a different color, a label, and/or other form of emphasis aiding in identification by a user. In some embodiments, subtrees, previously constructed trees, and/or entire data structures may be represented and/or converted to rule modules, with graphical models representing them, and which may then be used in further iterations or steps of generation of decision tree and/or data structure. Alternatively or additionally subtrees, previously constructed trees, and/or entire data structures may be converted to APIs to interface with further iterations or steps of methods as described in this disclosure. As a further example, such subtrees, previously constructed trees, and/or entire data structures may become remote resources to which further iterations or steps of data structures and/or decision trees may transmit data and from which further iterations or steps of generation of data structure receive data, for instance as part of a decision in a given decision tree node.

Continuing to refer to FIG. 7, decision tree may incorporate one or more manually entered or otherwise provided decision criteria. Decision tree may incorporate one or more decision criteria using an application programmer interface (API). Decision tree may establish a link to a remote decision module, device, system, or the like. Decision tree may perform one or more database lookups and/or look-up table lookups. Decision tree may include at least a decision calculation module, which may be imported via an API, by incorporation of a program module in source code, executable, or other form, and/or linked to a given node by establishing a communication interface with one or more exterior processes, programs, systems, remote devices, or the like; for instance, where a user operating system has a previously existent calculation and/or decision engine configured to make a decision corresponding to a given node, for instance and without limitation using one or more elements of domain knowledge, by receiving an input and producing an output representing a decision, a node may be configured to provide data to the input and receive the output representing the decision, based upon which the node may perform its decision.

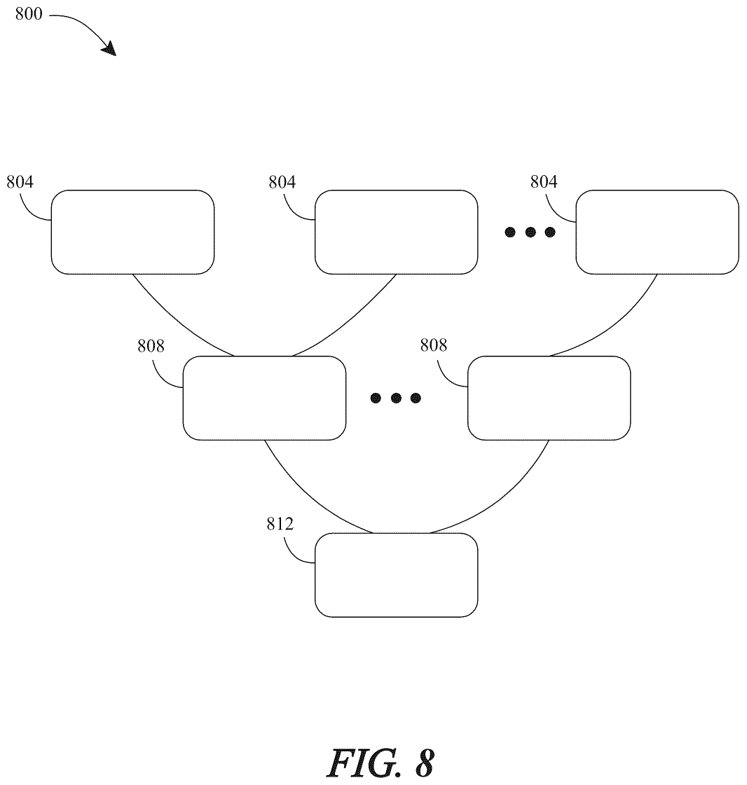

Referring now to FIG. 8 an exemplary embodiment of a cryptographic accumulator 800 is illustrated. A “cryptographic accumulator,” as used in this disclosure, is a data structure created by relating a commitment, which may be smaller amount of data that may be referred to as an “accumulator” and/or “root,” to a set of elements, such as lots of data and/or collection of data, together with short membership and/or non-membership proofs for any element in the set. In an embodiment, these proofs may be publicly verifiable against the commitment. An accumulator may be said to be “dynamic” if the commitment and membership proofs can be updated efficiently as elements are added or removed from the set, at unit cost independent of the number of accumulated elements; an accumulator for which this is not the case may be referred to as “static.” A membership proof may be referred to as a as a “witness” whereby an element existing in the larger amount of data can be shown to be included in the root, while an element not existing in the larger amount of data can be shown not to be included in the root, where “inclusion” indicates that the included element was a part of the process of generating the root, and therefore was included in the original larger data set. Cryptographic accumulator 800 has a plurality of accumulated elements 804, each accumulated element 804 generated from a lot of the plurality of data lots. Accumulated elements 804 are create using an encryption process, defined for this purpose as a process that renders the lots of data unintelligible from the accumulated elements 804; this may be a one-way process such as a cryptographic hashing process and/or a reversible process such as encryption. Cryptographic accumulator 800 further includes structures and/or processes for conversion of accumulated elements 804 to root 812 element. For instance, and as illustrated for exemplary purposes in FIG. 8 cryptographic accumulator 800 may be implemented as a Merkle tree and/or hash tree, in which each accumulated element 804 created by cryptographically hashing a lot of data. Two or more accumulated elements 804 may be hashed together in a further cryptographic hashing process to produce a node 808 element; a plurality of node 808 elements may be hashed together to form parent nodes 808, and ultimately a set of nodes 808 may be combined and cryptographically hashed to form root 812. Contents of root 812 may thus be determined by contents of nodes 808 used to generate root 812, and consequently by contents of accumulated elements 804, which are determined by contents of lots used to generate accumulated elements 804. As a result of collision resistance and avalanche effects of hashing algorithms, any change in any lot, accumulated element 804, and/or node 808 is virtually certain to cause a change in root 812; thus, it may be computationally infeasible to modify any element of Merkle and/or hash tree without the modification being detectable as generating a different root 812. In an embodiment, any accumulated element 804 and/or all intervening nodes 808 between accumulated element 804 and root 812 may be made available without revealing anything about a lot of data used to generate accumulated element 804; lot of data may be kept secret and/or demonstrated with a secure proof as described below, preventing any unauthorized party from acquiring data in lot.

Alternatively or additionally, and still referring to FIG. 8 cryptographic accumulator 800 may include a “vector commitment” which may act as an accumulator in which an order of elements in set is preserved in its root 812 and/or commitment. In an embodiment, a vector commitment may be a position binding commitment and can be opened at any position to a unique value with a short proof (sublinear in the length of the vector). A Merkle tree may be seen as a vector commitment with logarithmic size openings. Sub-vector commitments may include vector commitments where a subset of the vector positions can be opened in a single short proof (sublinear in the size of the subset). Persons skilled in the art, upon reviewing the entirety of this disclosure, will be aware of various alternative or additional cryptographic accumulators 800 that may be used as described herein. In addition to Merkle trees, accumulators may include without limitation RSA accumulators, class group accumulators, and/or bi-linear pairing-based accumulators. Any accumulator may operate using one-way functions that are easy to verify but infeasible to reverse, i.e. given an input it is easy to produce an output of the one-way function, but given an output it is computationally infeasible and/or impossible to generate the input that produces the output via the one-way function. For instance, and by way of illustration, a Merkle tree may be based on a hash function as described above. Data elements may be hashed and grouped together. Then, the hashes of those groups may be hashed again and grouped together with the hashes of other groups; this hashing and grouping may continue until only a single hash remains. As a further non-limiting example, RSA and class group accumulators may be based on the fact that it is infeasible to compute an arbitrary root of an element in a cyclic group of unknown order, whereas arbitrary powers of elements are easy to compute. A data element may be added to the accumulator by hashing the data element successively until the hash is a prime number and then taking the accumulator to the power of that prime number. The witness may be the accumulator prior to exponentiation. Bi-linear paring-based accumulators may be based on the infeasibility found in elliptic curve cryptography, namely that finding a number k such that adding P to itself k times results in Q is impractical, whereas confirming that, given 4 points P, Q, R, S, the point, P needs to be added as many times to itself to result in Q as R needs to be added as many times to itself to result in S, can be computed efficiently for certain elliptic curves.

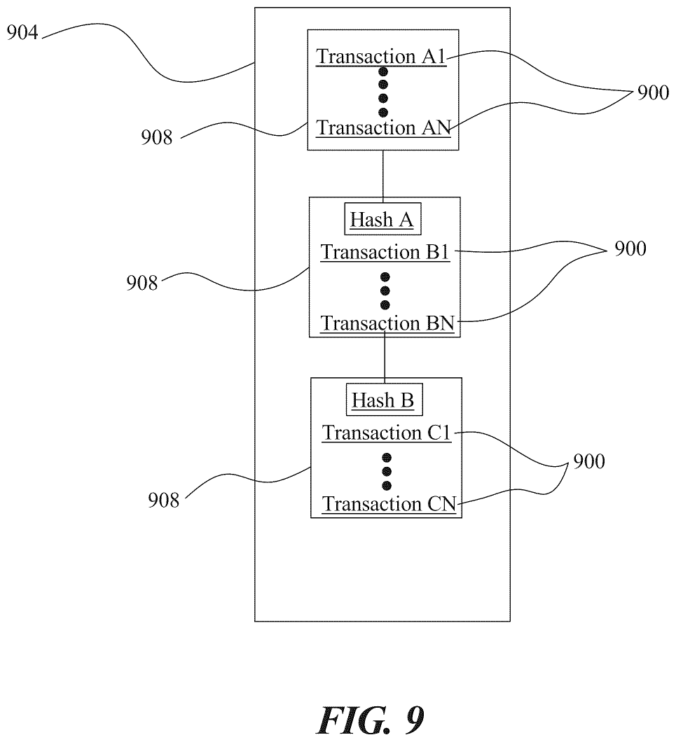

Referring now to FIG. 9, an exemplary embodiment of an immutable sequential listing is illustrated. An “immutable sequential listing,” as used in this disclosure, is a data structure that places data entries in a fixed sequential arrangement, such as a temporal sequence of entries and/or blocks thereof, where the sequential arrangement, once established, cannot be altered, or reordered. An immutable sequential listing may be, include and/or implement an immutable ledger, where data entries that have been posted to the immutable sequential listing cannot be altered. Data elements are listing in immutable sequential listing; data elements may include any form of data, including textual data, image data, encrypted data, cryptographically hashed data, and the like. Data elements may include, without limitation, one or more at least a digitally signed assertions. In one embodiment, a digitally signed assertion 904 is a collection of textual data signed using a secure proof as described in further detail below; secure proof may include, without limitation, a digital signature as described above. Collection of textual data may contain any textual data, including without limitation American Standard Code for Information Interchange (ASCII), Unicode, or similar computer-encoded textual data, any alphanumeric data, punctuation, diacritical mark, or any character or other marking used in any writing system to convey information, in any form, including any plaintext or cyphertext data; in an embodiment, collection of textual data may be encrypted, or may be a hash of other data, such as a root or node of a Merkle tree or hash tree, or a hash of any other information desired to be recorded in some fashion using a digitally signed assertion 904. In an embodiment, collection of textual data states that the owner of a certain transferable item represented in a digitally signed assertion 904 register is transferring that item to the owner of an address. A digitally signed assertion 904 may be signed by a digital signature created using the private key associated with the owner's public key, as described above.

Still referring to FIG. 9, a digitally signed assertion 904 may describe a transfer of virtual currency, such as crypto-currency as described below. The virtual currency may be a digital currency. Item of value may be a transfer of trust, for instance represented by a statement vouching for the identity or trustworthiness of the first user. Item of value may be an interest in a fungible negotiable financial instrument representing ownership in a public or private corporation, a creditor relationship with a governmental body or a corporation, rights to ownership represented by an option, derivative financial instrument, commodity, debt-backed security such as a bond or debenture or other security as described in further detail below. A resource may be a physical machine e.g. a ride share vehicle or any other asset. A digitally signed assertion 904 may describe the transfer of a physical good; for instance, a digitally signed assertion 904 may describe the sale of a product. In some embodiments, a transfer nominally of one item may be used to represent a transfer of another item; for instance, a transfer of virtual currency may be interpreted as representing a transfer of an access right; conversely, where the item nominally transferred is something other than virtual currency, the transfer itself may still be treated as a transfer of virtual currency, having value that depends on many potential factors including the value of the item nominally transferred and the monetary value attendant to having the output of the transfer moved into a particular user's control. The item of value may be associated with a digitally signed assertion 904 by means of an exterior protocol, such as the COLORED COINS created according to protocols developed by The Colored Coins Foundation, the MASTERCOIN protocol developed by the Mastercoin Foundation, or the ETHEREUM platform offered by the Stiftung Ethereum Foundation of Baar, Switzerland, the Thunder protocol developed by Thunder Consensus, or any other protocol.

Still referring to FIG. 9, in one embodiment, an address is a textual datum identifying the recipient of virtual currency or another item of value in a digitally signed assertion 904. In some embodiments, address is linked to a public key, the corresponding private key of which is owned by the recipient of a digitally signed assertion 904. For instance, address may be the public key. Address may be a representation, such as a hash, of the public key. Address may be linked to the public key in memory of a computing device, for instance via a “wallet shortener” protocol. Where address is linked to a public key, a transferee in a digitally signed assertion 904 may record a subsequent a digitally signed assertion 904 transferring some or all of the value transferred in the first a digitally signed assertion 904 to a new address in the same manner. A digitally signed assertion 904 may contain textual information that is not a transfer of some item of value in addition to, or as an alternative to, such a transfer. For instance, as described in further detail below, a digitally signed assertion 904 may indicate a confidence level associated with a distributed storage node as described in further detail below.

In an embodiment, and still referring to FIG. 9 immutable sequential listing records a series of at least a posted content in a way that preserves the order in which the at least a posted content took place. Temporally sequential listing may be accessible at any of various security settings; for instance, and without limitation, temporally sequential listing may be readable and modifiable publicly, may be publicly readable but writable only by entities and/or devices having access privileges established by password protection, confidence level, or any device authentication procedure or facilities described herein, or may be readable and/or writable only by entities and/or devices having such access privileges. Access privileges may exist in more than one level, including, without limitation, a first access level or community of permitted entities and/or devices having ability to read, and a second access level or community of permitted entities and/or devices having ability to write; first and second community may be overlapping or non-overlapping. In an embodiment, posted content and/or immutable sequential listing may be stored as one or more zero knowledge sets (ZKS), Private Information Retrieval (PIR) structure, or any other structure that allows checking of membership in a set by querying with specific properties. Such database may incorporate protective measures to ensure that malicious actors may not query the database repeatedly in an effort to narrow the members of a set to reveal uniquely identifying information of a given posted content.

Still referring to FIG. 9, immutable sequential listing may preserve the order in which the at least a posted content took place by listing them in chronological order; alternatively or additionally, immutable sequential listing may organize digitally signed assertions 904 into sub-listings 908 such as “blocks” in a blockchain, which may be themselves collected in a temporally sequential order; digitally signed assertions 904 within a sub-listing 908 may or may not be temporally sequential. The ledger may preserve the order in which at least a posted content took place by listing it in sub-listings 908 and placing the sub-listings 908 in chronological order. The immutable sequential listing may be a distributed, consensus-based ledger, such as those operated according to the protocols promulgated by Ripple Labs, Inc., of San Francisco, Calif., or the Stellar Development Foundation, of San Francisco, Calif, or of Thunder Consensus. In some embodiments, the ledger is a secured ledger; in one embodiment, a secured ledger is a ledger having safeguards against alteration by unauthorized parties. The ledger may be maintained by a proprietor, such as a system administrator on a server, that controls access to the ledger; for instance, the user account controls may allow contributors to the ledger to add at least a posted content to the ledger but may not allow any users to alter at least a posted content that have been added to the ledger. In some embodiments, ledger is cryptographically secured; in one embodiment, a ledger is cryptographically secured where each link in the chain contains encrypted or hashed information that makes it practically infeasible to alter the ledger without betraying that alteration has taken place, for instance by requiring that an administrator or other party sign new additions to the chain with a digital signature. Immutable sequential listing may be incorporated in, stored in, or incorporate, any suitable data structure, including without limitation any database, datastore, file structure, distributed hash table, directed acyclic graph or the like. In some embodiments, the timestamp of an entry is cryptographically secured and validated via trusted time, either directly on the chain or indirectly by utilizing a separate chain. In one embodiment the validity of timestamp is provided using a time stamping authority as described in the RFC 3161 standard for trusted timestamps, or in the ANSI ASC x9.95 standard. In another embodiment, the trusted time ordering is provided by a group of entities collectively acting as the time stamping authority with a requirement that a threshold number of the group of authorities sign the timestamp.

In some embodiments, and with continued reference to FIG. 9, immutable sequential listing, once formed, may be inalterable by any party, no matter what access rights that party possesses. For instance, immutable sequential listing may include a hash chain, in which data is added during a successive hashing process to ensure non-repudiation. Immutable sequential listing may include a block chain. In one embodiment, a block chain is immutable sequential listing that records one or more new at least a posted content in a data item known as a sub-listing 908 or “block.” An example of a block chain is the BITCOIN block chain used to record BITCOIN transactions and values. Sub-listings 908 may be created in a way that places the sub-listings 908 in chronological order and link each sub-listing 908 to a previous sub-listing 908 in the chronological order so that any computing device may traverse the sub-listings 908 in reverse chronological order to verify any at least a posted content listed in the block chain. Each new sub-listing 908 may be required to contain a cryptographic hash describing the previous sub-listing 908. In some embodiments, the block chain contains a single first sub-listing 908 sometimes known as a “genesis block.”

Still referring to FIG. 9, the creation of a new sub-listing 908 may be computationally expensive; for instance, the creation of a new sub-listing 908 may be designed by a “proof of work” protocol accepted by all participants in forming the immutable sequential listing to take a powerful set of computing devices a certain period of time to produce. Where one sub-listing 908 takes less time for a given set of computing devices to produce the sub-listing 908 protocol may adjust the algorithm to produce the next sub-listing 908 so that it will require more steps; where one sub-listing 908 takes more time for a given set of computing devices to produce the sub-listing 908 protocol may adjust the algorithm to produce the next sub-listing 908 so that it will require fewer steps. As an example, protocol may require a new sub-listing 908 to contain a cryptographic hash describing its contents; the cryptographic hash may be required to satisfy a mathematical condition, achieved by having the sub-listing 908 contain a number, called a nonce, whose value is determined after the fact by the discovery of the hash that satisfies the mathematical condition. Continuing the example, the protocol may be able to adjust the mathematical condition so that the discovery of the hash describing a sub-listing 908 and satisfying the mathematical condition requires more or less steps, depending on the outcome of the previous hashing attempt. Mathematical condition, as an example, might be that the hash contains a certain number of leading zeros and a hashing algorithm that requires more steps to find a hash containing a greater number of leading zeros, and fewer steps to find a hash containing a lesser number of leading zeros. In some embodiments, production of a new sub-listing 908 according to the protocol is known as “mining.” The creation of a new sub-listing 908 may be designed by a “proof of stake” protocol as will be apparent to those skilled in the art upon reviewing the entirety of this disclosure.

Continuing to refer to FIG. 9, in some embodiments, protocol also creates an incentive to mine new sub-listings 908. The incentive may be financial; for instance, successfully mining a new sub-listing 908 may result in the person or user that mines the sub-listing 908 receiving a predetermined amount of currency. The currency may be fiat currency. Currency may be cryptocurrency as defined below. In other embodiments, incentive may be redeemed for particular products or services; the incentive may be a gift certificate with a particular business, for instance. In some embodiments, incentive is sufficiently attractive to cause participants to compete for the incentive by trying to race each other to the creation of sub-listings 908 Each sub-listing 908 created in immutable sequential listing may contain a record or at least a posted content describing one or more addresses that receive an incentive, such as virtual currency, as the result of successfully mining the sub-listing 908.

With continued reference to FIG. 9, where two entities simultaneously create new sub-listings 908, immutable sequential listing may develop a fork; protocol may determine which of the two alternate branches in the fork is the valid new portion of the immutable sequential listing by evaluating, after a certain amount of time has passed, which branch is longer. “Length” may be measured according to the number of sub-listings 908 in the branch. Length may be measured according to the total computational cost of producing the branch. Protocol may treat only at least a posted content contained the valid branch as valid at least a posted content. When a branch is found invalid according to this protocol, at least a posted content registered in that branch may be recreated in a new sub-listing 908 in the valid branch; the protocol may reject “double spending” at least a posted content that transfer the same virtual currency that another at least a posted content in the valid branch has already transferred. As a result, in some embodiments the creation of fraudulent at least a posted content requires the creation of a longer immutable sequential listing branch by the user attempting the fraudulent at least a posted content than the branch being produced by the rest of the participants; as long as the user creating the fraudulent at least a posted content is likely the only one with the incentive to create the branch containing the fraudulent at least a posted content, the computational cost of the creation of that branch may be practically infeasible, guaranteeing the validity of all at least a posted content in the immutable sequential listing.

Still referring to FIG. 9, additional data linked to at least a posted content may be incorporated in sub-listings 908 in the immutable sequential listing; for instance, data may be incorporated in one or more fields recognized by block chain protocols that permit a person or computer forming a at least a posted content to insert additional data in the immutable sequential listing. In some embodiments, additional data is incorporated in an unspendable at least a posted content field. For instance, the data may be incorporated in an OP_RETURN within the BITCOIN block chain. In other embodiments, additional data is incorporated in one signature of a multi-signature at least a posted content. In an embodiment, a multi-signature at least a posted content is at least a posted content to two or more addresses. In some embodiments, the two or more addresses are hashed together to form a single address, which is signed in the digital signature of the at least a posted content. In other embodiments, the two or more addresses are concatenated. In some embodiments, two or more addresses may be combined by a more complicated process, such as the creation of a Merkle tree or the like. In some embodiments, one or more addresses incorporated in the multi-signature at least a posted content are typical crypto-currency addresses, such as addresses linked to public keys as described above, while one or more additional addresses in the multi-signature at least a posted content contain additional data related to the at least a posted content; for instance, the additional data may indicate the purpose of the at least a posted content, aside from an exchange of virtual currency, such as the item for which the virtual currency was exchanged. In some embodiments, additional information may include network statistics for a given node of network, such as a distributed storage node, e.g. the latencies to nearest neighbors in a network graph, the identities or identifying information of neighboring nodes in the network graph, the trust level and/or mechanisms of trust (e.g. certificates of physical encryption keys, certificates of software encryption keys, (in non-limiting example certificates of software encryption may indicate the firmware version, manufacturer, hardware version and the like), certificates from a trusted third party, certificates from a decentralized anonymous authentication procedure, and other information quantifying the trusted status of the distributed storage node) of neighboring nodes in the network graph, IP addresses, GPS coordinates, and other information informing location of the node and/or neighboring nodes, geographically and/or within the network graph. In some embodiments, additional information may include history and/or statistics of neighboring nodes with which the node has interacted. In some embodiments, this additional information may be encoded directly, via a hash, hash tree or other encoding.

With continued reference to FIG. 9, in some embodiments, virtual currency is traded as a crypto-currency. In one embodiment, a crypto-currency is a digital, currency such as Bitcoins, Peercoins, Namecoins, and Litecoins. Crypto-currency may be a clone of another crypto-currency. The crypto-currency may be an “alt-coin.” Crypto-currency may be decentralized, with no particular user controlling it; the integrity of the crypto-currency may be maintained by adherence by its participants to established protocols for exchange and for production of new currency, which may be enforced by software implementing the crypto-currency. Crypto-currency may be centralized, with its protocols enforced or hosted by a particular user. For instance, crypto-currency may be maintained in a centralized ledger, as in the case of the XRP currency of Ripple Labs, Inc., of San Francisco, Calif. In lieu of a centrally controlling authority, such as a national bank, to manage currency values, the number of units of a particular crypto-currency may be limited; the rate at which units of crypto-currency enter the market may be managed by a mutually agreed-upon process, such as creating new units of currency when mathematical puzzles are solved, the degree of difficulty of the puzzles being adjustable to control the rate at which new units enter the market. Mathematical puzzles may be the same as the algorithms used to make productions of sub-listings 908 in a block chain computationally challenging; the incentive for producing sub-listings 908 may include the grant of new crypto-currency to the miners. Quantities of crypto-currency may be exchanged using at least a posted content as described above.

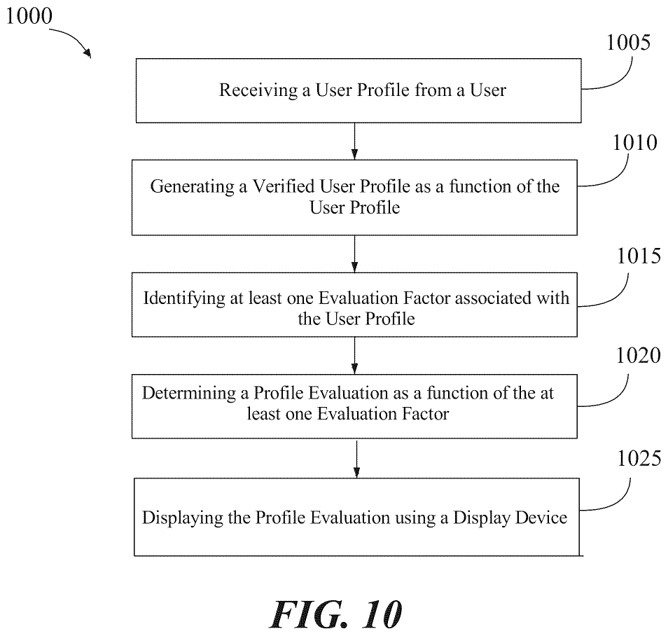

Referring now to FIG. 10, a flow diagram of an exemplary method 1000 for automatically generating a profile evaluation is illustrated. At step 1005, method 1000 includes extracting, using at least a processor, a user profile from a user. This may be implemented as described and with reference to FIGS. 1-10. In some embodiments, extracting the user profile may comprise extracting the user profile using a digital assistant. A digital assistant may include comprises a chatbot and/or a language model. The user profile may additionally comprise a vehicle profile.

Still referring to FIG. 10, At step 1010, method 1000 includes generating, using the at least a processor, a verified user profile as a function of the user profile. This may be implemented as described and with reference to FIGS. 1-10. In some embodiments, generating the verified user profile may comprise generating the generating the verified user profile using a web crawler.

Still referring to FIG. 10, At step 1015, method 1000 includes identifying, using the at least a processor, at least one evaluation factor associated with the verified user profile. This may be implemented as described and with reference to FIGS. 1-10. In some embodiments, an evaluation factor may be reflected using a score. In some embodiments, identifying the at least one evaluation factor may comprise identifying the at least one evaluation factor using a factor machine learning model. Identifying the at least one evaluation factor using the factor machine learning model comprises training the factor machine learning model using factor training data, wherein the factor training data contains a plurality of data entries containing the user profile as inputs correlated to the at least one evaluation factor as outputs and determine the profile evaluation as a function of the at least one evaluation factor using the factor machine learning model. An evaluation factor may include the driving record of the user.

Still referring to FIG. 10, At step 1020, method 1000 includes determining, using the at least a processor, a profile evaluation as a function of the at least one evaluation factors. This may be implemented as described and with reference to FIGS. 1-10.

Still referring to FIG. 10, At step 1025, method 1000 includes displaying, using the at least a processor, the profile evaluation using a display device. This may be implemented as described and with reference to FIGS. 1-10.

It is to be noted that any one or more of the aspects and embodiments described herein may be conveniently implemented using one or more machines (e.g., one or more computing devices that are utilized as a user computing device for an electronic document, one or more server devices, such as a document server, etc.) programmed according to the teachings of the present specification, as will be apparent to those of ordinary skill in the computer art. Appropriate software coding can readily be prepared by skilled programmers based on the teachings of the present disclosure, as will be apparent to those of ordinary skill in the software art. Aspects and implementations discussed above employing software and/or software modules may also include appropriate hardware for assisting in the implementation of the machine executable instructions of the software and/or software module.

Such software may be a computer program product that employs a machine-readable storage medium. A machine-readable storage medium may be any medium that is capable of storing and/or encoding a sequence of instructions for execution by a machine (e.g., a computing device) and that causes the machine to perform any one of the methodologies and/or embodiments described herein. Examples of a machine-readable storage medium include, but are not limited to, a magnetic disk, an optical disc (e.g., CD, CD-R, DVD, DVD-R, etc.), a magneto-optical disk, a read-only memory “ROM” device, a random access memory “RAM” device, a magnetic card, an optical card, a solid-state memory device, an EPROM, an EEPROM, and any combinations thereof. A machine-readable medium, as used herein, is intended to include a single medium as well as a collection of physically separate media, such as, for example, a collection of compact discs or one or more hard disk drives in combination with a computer memory. As used herein, a machine-readable storage medium does not include transitory forms of signal transmission.

Such software may also include information (e.g., data) carried as a data signal on a data carrier, such as a carrier wave. For example, machine-executable information may be included as a data-carrying signal embodied in a data carrier in which the signal encodes a sequence of instruction, or portion thereof, for execution by a machine (e.g., a computing device) and any related information (e.g., data structures and data) that causes the machine to perform any one of the methodologies and/or embodiments described herein.

Examples of a computing device include, but are not limited to, an electronic book reading device, a computer workstation, a terminal computer, a server computer, a handheld device (e.g., a tablet computer, a smartphone, etc.), a web appliance, a network router, a network switch, a network bridge, any machine capable of executing a sequence of instructions that specify an action to be taken by that machine, and any combinations thereof. In one example, a computing device may include and/or be included in a kiosk.

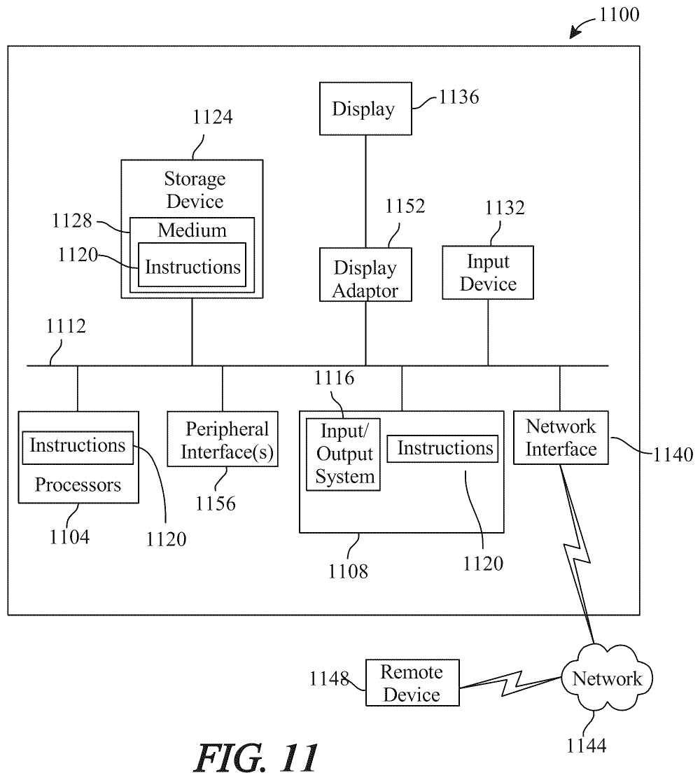

FIG. 11 shows a diagrammatic representation of one embodiment of a computing device in the exemplary form of a computer system 1100 within which a set of instructions for causing a control system to perform any one or more of the aspects and/or methodologies of the present disclosure may be executed. It is also contemplated that multiple computing devices may be utilized to implement a specially configured set of instructions for causing one or more of the devices to perform any one or more of the aspects and/or methodologies of the present disclosure. Computer system 1100 includes a processor 1104 and a memory 1108 that communicate with each other, and with other components, via a bus 1112. Bus 1112 may include any of several types of bus structures including, but not limited to, a memory bus, a memory controller, a peripheral bus, a local bus, and any combinations thereof, using any of a variety of bus architectures.

Processor 1104 may include any suitable processor, such as without limitation a processor incorporating logical circuitry for performing arithmetic and logical operations, such as an arithmetic and logic unit (ALU), which may be regulated with a state machine and directed by operational inputs from memory and/or sensors; processor 1104 may be organized according to Von Neumann and/or Harvard architecture as a non-limiting example. Processor 1104 may include, incorporate, and/or be incorporated in, without limitation, a microcontroller, microprocessor, digital signal processor (DSP), Field Programmable Gate Array (FPGA), Complex Programmable Logic Device (CPLD), Graphical Processing Unit (GPU), general purpose GPU, Tensor Processing Unit (TPU), analog or mixed signal processor, Trusted Platform Module (TPM), a floating point unit (FPU), and/or system on a chip (SoC).

Memory 1108 may include various components (e.g., machine-readable media) including, but not limited to, a random-access memory component, a read only component, and any combinations thereof. In one example, a basic input/output system 1116 (BIOS), including basic routines that help to transfer information between elements within computer system 1100, such as during start-up, may be stored in memory 1108. Memory 1108 may also include (e.g., stored on one or more machine-readable media) instructions (e.g., software) 1120 embodying any one or more of the aspects and/or methodologies of the present disclosure. In another example, memory 1108 may further include any number of program modules including, but not limited to, an operating system, one or more application programs, other program modules, program data, and any combinations thereof.

Computer system 1100 may also include a storage device 1124. Examples of a storage device (e.g., storage device 1124) include, but are not limited to, a hard disk drive, a magnetic disk drive, an optical disc drive in combination with an optical medium, a solid-state memory device, and any combinations thereof. Storage device 1124 may be connected to bus 1112 by an appropriate interface (not shown). Example interfaces include, but are not limited to, SCSI, advanced technology attachment (ATA), serial ATA, universal serial bus (USB), IEEE 13114 (FIREWIRE), and any combinations thereof. In one example, storage device 1124 (or one or more components thereof) may be removably interfaced with computer system 1100 (e.g., via an external port connector (not shown)). Particularly, storage device 1124 and an associated machine-readable medium 1128 may provide nonvolatile and/or volatile storage of machine-readable instructions, data structures, program modules, and/or other data for computer system 1100. In one example, software 1120 may reside, completely or partially, within machine-readable medium 1128. In another example, software 1120 may reside, completely or partially, within processor 1104.

Computer system 1100 may also include an input device 1132. In one example, a user of computer system 1100 may enter commands and/or other information into computer system 1100 via input device 1132. Examples of an input device 1132 include, but are not limited to, an alpha-numeric input device (e.g., a keyboard), a pointing device, a joystick, a gamepad, an audio input device (e.g., a microphone, a voice response system, etc.), a cursor control device (e.g., a mouse), a touchpad, an optical scanner, a video capture device (e.g., a still camera, a video camera), a touchscreen, and any combinations thereof. Input device 1132 may be interfaced to bus 1112 via any of a variety of interfaces (not shown) including, but not limited to, a serial interface, a parallel interface, a game port, a USB interface, a FIREWIRE interface, a direct interface to bus 1112, and any combinations thereof. Input device 1132 may include a touch screen interface that may be a part of or separate from display 1136, discussed further below. Input device 1132 may be utilized as a user selection device for selecting one or more graphical representations in a graphical interface as described above.

A user may also input commands and/or other information to computer system 1100 via storage device 1124 (e.g., a removable disk drive, a flash drive, etc.) and/or network interface device 1140. A network interface device, such as network interface device 1140, may be utilized for connecting computer system 1100 to one or more of a variety of networks, such as network 1144, and one or more remote devices 1148 connected thereto. Examples of a network interface device include, but are not limited to, a network interface card (e.g., a mobile network interface card, a LAN card), a modem, and any combination thereof. Examples of a network include, but are not limited to, a wide area network (e.g., the Internet, an enterprise network), a local area network (e.g., a network associated with an office, a building, a campus or other relatively small geographic space), a telephone network, a data network associated with a telephone/voice provider (e.g., a mobile communications provider data and/or voice network), a direct connection between two computing devices, and any combinations thereof. A network, such as network 1144, may employ a wired and/or a wireless mode of communication. In general, any network topology may be used. Information (e.g., data, software 1120, etc.) may be communicated to and/or from computer system 1100 via network interface device 1140.

Computer system 1100 may further include a video display adapter 1152 for communicating a displayable image to a display device, such as display device 1136. Examples of a display device include, but are not limited to, a liquid crystal display (LCD), a cathode ray tube (CRT), a plasma display, a light emitting diode (LED) display, and any combinations thereof. Display adapter 1152 and display device 1136 may be utilized in combination with processor 1104 to provide graphical representations of aspects of the present disclosure. In addition to a display device, computer system 1100 may include one or more other peripheral output devices including, but not limited to, an audio speaker, a printer, and any combinations thereof. Such peripheral output devices may be connected to bus 1112 via a peripheral interface 1156. Examples of a peripheral interface include, but are not limited to, a serial port, a USB connection, a FIREWIRE connection, a parallel connection, and any combinations thereof.

The foregoing has been a detailed description of illustrative embodiments of the invention. Various modifications and additions can be made without departing from the spirit and scope of this invention. Features of each of the various embodiments described above may be combined with features of other described embodiments as appropriate in order to provide a multiplicity of feature combinations in associated new embodiments. Furthermore, while the foregoing describes a number of separate embodiments, what has been described herein is merely illustrative of the application of the principles of the present invention. Additionally, although particular methods herein may be illustrated and/or described as being performed in a specific order, the ordering is highly variable within ordinary skill to achieve methods, systems, and software according to the present disclosure. Accordingly, this description is meant to be taken only by way of example, and not to otherwise limit the scope of this invention.

Exemplary embodiments have been disclosed above and illustrated in the accompanying drawings. It will be understood by those skilled in the art that various changes, omissions and additions may be made to that which is specifically disclosed herein without departing from the spirit and scope of the present invention.

1. An apparatus for automatically generating a profile evaluation, wherein the apparatus comprises:
at least a processor; and
a memory communicatively connected to the at least a processor, wherein the memory containing instructions configuring the at least a processor to:
receive a user profile from one or more sources, wherein the user profile is part of a single user view for a user;
generate verification training data, wherein the verification training data correlates information associated with the user profile and one or more secondary sources;
generate a verified user profile as a function of the verification training data, wherein generating the verified user profile further comprises:
training a verification machine learning model using the verification training data;
generating the verified user profile as a function of the user profile using the trained verification machine learning model; and
updating the verification training data iteratively on a feedback loop as a function of the user profile as an input and the verified user profile as an output of the trained verification machine learning model;
generating a trustworthiness score comprising an estimate of a degree to which a response in the verified user profile is fraudulent, wherein the trustworthiness score is evaluated on a numerical scale;
identify at least one evaluation factor associated with the verified user profile and the trustworthiness score, using a factor machine-learning model, wherein the factor machine-learning model is trained with factor content training data that correlates a plurality of verified user profiles to examples of evaluation factors;
generate a profile evaluation as a function of the at least one evaluation factor, wherein generating the profile evaluation comprises generating the profile evaluation as a function of weighted values for each of the at least one evaluation factor; and
display the profile evaluation using a display device.

2. The apparatus of claim 1, wherein receiving the user profile further comprises extracting the user profile using a digital assistant.

3. The apparatus of claim 2, wherein the digital assistant comprises a conversational interface.

4. The apparatus of claim 2, wherein the digital assistant comprises a language model.

5. The apparatus of claim 1, wherein the user profile comprises a vehicle profile.

6. The apparatus of claim 1, wherein the at least one evaluation factor is reflected using a score.

7. The apparatus of claim 1, wherein generating the profile evaluation comprises assigning a numerical risk range to the user profile based on the single user view.

8. The apparatus of claim 1, wherein the user profile is stored on an immutable sequential listing.

9. (canceled)

10. The apparatus of claim 1, wherein the at least one evaluation factor comprises at least one of a driving record of the user, user demographic information, criminal record, financial information, and insurance information.

11. A method for automatically generating a profile evaluation, wherein the method comprises:
receiving, using at least a processor, a user profile from one or more sources, wherein the user profile is part of a single user view for a user;
generating, using the at least a processor, verification training data as a function of the user profile;
generating, using the at least a processor, a verified user profile as a function of the verification training data, wherein generating the verified user profile further comprises:
training a verification machine learning model using the verification training data;
generating the verified user profile as a function of the user profile using the trained verification machine learning model; and
updating the verification training data iteratively on a feedback loop as a function of the user profile as an input and the verified user profile as an output of the trained verification machine learning model;
generating a trustworthiness score comprising an estimate of a degree to which a response in the verified user profile is fraudulent, wherein the trustworthiness score is evaluated on a numerical scale;
identifying, using the at least a processor, at least one evaluation factor associated with the verified user profile and the trustworthiness score, using a factor machine-learning model, wherein the factor machine-learning model is trained with factor content training data that correlates a plurality of verified user profiles to examples of evaluation factors;
generating, using the at least a processor, a profile evaluation as a function of the at least one evaluation factor, wherein generating the profile evaluation comprises generating the profile evaluation as a function of weighted values for each of the at least one evaluation factor; and
displaying the profile evaluation using a display device.

12. The method of claim 11, wherein receiving the user profile further comprises extracting the user profile using a digital assistant.

13. The method of claim 12, wherein the digital assistant comprises a conversational interface.

14. The method of claim 12, wherein the digital assistant comprises a language model.

15. The method of claim 11, wherein the user profile comprises a vehicle profile.

16. The method of claim 11, wherein the at least one evaluation factor is reflected using a score.

17. The method of claim 11, wherein generating the profile evaluation comprises assigning a numerical risk range to the user based on the single user view.

18. The method of claim 11, wherein the user profile is stored on an immutable sequential listing.

19. (canceled)

20. The method of claim 11, wherein the at least one evaluation factor comprises at least one of a driving record of the user, user demographic information, user criminal record, and insurance information.
